(19) United States
(12) Patent Application Publication
(10) Pub. No.: US 2009/0278798 A1
(43) Pub. Date: Nov. 12, 2009

(54) Active Fingertip-Mounted Object Digitizer

(75) Inventors: Young-Seok Kim, Tonawanda, NY (US); Thenkurussi Kesavadas, Clarence Center, NY (US)

Correspondence Address: HODGSON RUSS LLP;THE GUARANTY BUILDING, 140 PEARL STREET, SUITE 100, BUFFALO, NY, 14202-4040, US

(73) Assignee: The Research Foundation of the State University of New York, Amherst, NY (US)

(21) Appl. No.: 11/828,463

(22) Filed: Jul. 26, 2007

Related U.S. Application Data
(60) Provisional application No. 60/833,329, filed on Jul. 26, 2006.

(51) Int. Cl. G06F 3/033

(52) U.S. Cl. 345/158; 178/18.01

(57) ABSTRACT

A finger-mounted implement including a kinesthetic sensor, at least one tactile sensor, and means for securing the kinesthetic sensor and the at least one tactile sensor to a fingertip. The tactile sensor may be a thin-film force transducer, a piezoelectric accelerometer, or a combination thereof. An artificial fingernail may be connected to the accelerometer. The kinesthetic sensor may include a magnetic transducer and may sense an X-Y-Z position and an angular orientation of a fingertip to which the kinesthetic sensor is secured. The securing means may include at least one means selected from the group consisting of adhesive tape, an elastically deformable cover, and detachable adhesive. The implement can be further connected to a computer processing system for, amongst other things, the virtual representation of sensed objects. The implement can also be used as part of a method of haptic sensing of objects.

### CROSS-REFERENCE TO RELATED APPLICATIONS

This application claims benefit under 35 U.S.C. § 119(e) of U.S. Provisional Application No. 60/833,329 filed Jul. 26, 2006, which provisional application is incorporated herein by reference.

### FIELD OF THE INVENTION

The present invention relates generally to the field of haptic sensing.

### BACKGROUND OF THE INVENTION

Unlike the visual sense, touch is volatile and has a very short life in our memory. Though momentary, however, touch develops a close and intimate relationship with an object. It is also important in determining material properties, which is not possible though other senses.

In many areas, touch has great potential. In fact, it is involved in a wide range of scholarly work. Philosophically speaking, touch is motivated by a desire for knowledge about the surrounding world. Once motivated, there occurs various motor control and coordinating activities inside the human body, which are of interest to psychologists and physiologists including targeting an object, moving the arm, moving the fingers, and getting the brain ready to interpret the response. For convenience, these complicated tactual activities are often classified into two categories of touch pattern: passive and active touch. Passive touch refers to the stimuli sensing that is imposed on the subject's finger. It is mostly involved with cutaneous sensing for collecting local information. On the contrary, active touch refers to the stimulation sensing by a subject actively controlling the fingers. It is mostly related to kinesthetic sensing, which is essential to spatial references. These two aspects of touch are strongly interrelated in the human's exploratory touch, which is called haptic sensing. Haptic sensing is the combination of tactile sensing and kinesthetic sensing.

The field of fingertip digitizing refers to haptic sensing with the human fingertip as a contact probe. The ultimate goal of fingertip digitizing is to achieve an environment where both man and machine perfectly share the haptic stimuli, so that overall work performance can be enhanced by two valuable sources: machine's digital power, and human's instinctive exploratory capability (see FIG. 1).

However, for the contact probe, which is the key of the digitizer, the human fingertip is a very difficult material to handle. It has complex characteristics of compliance, impedance, and viscoelastic behavior. Previous studies on passive touch may be helpful for treatment of such difficulty—the characteristics of fingertip tissue have been investigated for accurate control and effective stimulation of a haptic device. However, the passive touch paradigm sees the fingertip as an intermediate material, not an active probe. It doesn't deal with the fingertip's unique characteristics in active touch. Consequently, user's tactual activities had to be ultimately restricted in previous methodologies. Also, digitizing results could not avoid inherent lower accuracy. The paradigm of passive touch is not sufficient for human's active, dynamic touch patterns for exploratory tasks.

The difference between active and passive touch has been proven in various coordination works, such as prehension, dexterous manipulation, and brain reaction. Despite these findings in physiological and psychological research, the active touch paradigm has rarely been adopted in fingertip input systems. Many human perception studies put emphasis on the role of active touch in manual tasks. However, the main advantage of active touch is its role in exploratory tasks. James J. Gibson's (1963) explanation helps understand the difference between the two types of touch: “Active touch, referred to as ‘touching’, is an exploratory sense in which the impression on the skin is brought about by the perceiver himself. That is, variations in stimulation of the skin are caused by variations of an individual's motor activity, as when he runs his fingers over an object or surface. This is distinguished from passive touch in which stimulation is caused by movement of the external object or surface against or relative to a stationary tactual receptor surface. Tactual sense organs have frequently been conceived as passive receptors (receptor mosaic), but they also serve as active ‘tentacles’ for sensory adjustment and sensory exploration. Such active, exploratory touching movements of the fingers have been termed tactile scanning (Gibson, 1962). These exploratory movements can be de-scribed by such terms as feeling, grasping, rubbing, groping, palpating, wielding, and hefting.” Here, Gibson emphasized the observer's ability to actively seek the information in the stimulus, which is most important for him/her. For a clearer definition, it is necessary to understand physiological models of touch.

The simplest model of touch sense consists of two opposite flows of neural information: efferent and afferent paths.

Efferent: Intention→Brain→Linkage (joints/muscles)→Contact.

Afferent: Contact→Linkage (nerve system)→Brain→Recognition.

A further well-established physiologic touch models can be found in Loomis & Lederman (1984). As shown in Table 1, significant factors for distinction are efferent kinesthesis and active (or voluntary) linkage control.

TABLE 1
Components of passive and active touch (Loomis & Lederman, 1984).

| Touch Types | Broad meaning | Narrow meaning |
|---|---|---|
| Passive touch | Cutaneous information | Cutaneous information |
| | “Tactile perception” | Afferent kinesthesis |
| | | “Passive haptic perception” |
| Active touch | Cutaneous information | Cutaneous information |
| | Afferent kinesthesis | Afferent kinesthesis |
| | Efferent kinesthesis | Efferent kinesthesis |
| | Active control | Active control |
| | “Active haptic perception” | “Active haptic perception” |

As an example, in robotics, efferent kinesthesis (position and posture of the end-effector) is known information; it is actively generated by path planning and implemented by linkage control. In a human-machine interface, however, a user's intention for motor control is unknown and hard to acquire. For this, motion tracking or exoskeleton (attachment of machine linkage to human arm/hand/fingers) technologies are used. Generally, to acquire user's kinesthetic intention, a recognizing process is needed; the machine has to capture hand/finger posture, realize its time history, and predict intention. Relevant technology can be found in Whole Hand Input (Sturman, 1992), and typical applications include CyberGlove™, CyberGrasp™ (Immersion, 2001), and Flock Of Bird™ (Ascension, 2004).

However, the role of efferent kinesthesis has been minimized in the past fingertip digitizing studies. Researchers used a motion tracker for acquiring positions on a surface (Smalley, 2004), and its variance in deformation (Mayrose, 2000). In these cases, a user's finger must lie on the surface at any given point of time because the sensing mechanism was based on passive touch; measurement was activated only by the contact. Consequently, there was considerable restriction in hand/finger movement, which is not appropriate for exploratory tasks. With the active touch paradigm the restriction of contact can be overcome, because it concerns the whole process of finger-object interaction.

Many haptic applications today adopt machines with a stylus-based interface, such as MicroScribe™ (Immersion, 2005), PHANToM™, and FreeForm™ (SensAble, 2005). However, manipulating tasks with the stylus or grasp tool can cause a loss of haptic sensation, and thus lower work performance. This can be explained by the active touch model suggested by Loomis & Lederman (1984), as shown in FIG. 2. In this figure, “implement” of the linkage part refers to the interfaces that need to be handled, like grasp tools. For this handling, another loop is added to the end-effector itself, often leading to performance degradation. The additional implement causes lower “transparency” that refers to the reliability of sensation transmission. This significance is especially apparent in telepresence. In fingertip digitizing, direct touch interface contributes to enhancing such transparency. The superiority of direct finger touch over stylus scribing can also be found in the experiment implemented by West and Cutkosky (1997). Their experimental setup was a sub-millimeter-scale scribing device that provided various sinusoidal surface profiles. They found that actual finger tip tracing performance exceeded both actual and virtual tracing with the stylus interface. The importance of the surface-to-finger tip interaction is well-addressed in the replication of tactile sensation.

Since the advent of the powerful microprocessor and its popularity, virtual reality (“VR”) has been regarded as a useful performance leveraging means (Wickens & Hollands, 2000). Virtual reality refers to a medium that allows us to have a simulated experience approaching that of physical reality. Three functionalities are essential in VR: imagination, immersion, and interaction. In addition to the advances in immersive visual display, recent studies are widely adopting a haptic interface to simulate real-world experience. Other sensory stimulation of different modalities are also available. For a fingertip digitizing interface, we can expect these benefits by introducing such functionalities to VR.

First of all, VR can provide spatial reference, which is a weakness of tactile sensation. Miller (1978) pointed the limitation of short-term tactile memory, and the role of verbal references as a supplement: “ . . . memory for tactual shapes, like short-term motor memory, deteriorates with delay rather than with attentional demands, unless inputs are coded verbally or in terms of spatial references . . . . The tactual shapes are not initially coded in spatial terms, either as global configurations or by spatial features.”

That is, because touch sensation hardly offers spatial cues, and its impression is momentary, we usually transform such experience to words for retrievable record. Touch sensation should scan the entire area, along with spatial reference, as in visual sensation. Therefore, in a touch sensing system, one of the important roles of VR is spatial mapping. Effectiveness of real-time mapping is evident when exploring unknown object (see FIG. 3).

Secondly, the flexibility of VR can provide sensory substitution of other modalities. That is, a virtual space can accommodate not only a spatially marked geometry, but also a user's experience on that particular spot. This is especially useful for exploration or guiding. For example, a user's motor control can be assisted by vibrotactile or kinesthetic stimuli. Moreover, the sensory substitution is not necessary to reproduce real-world stimuli. A virtual environment can have scalability where a subject's weak or partially-impaired sensation is enhanced. For instance, in an elaborated work condition of sub-millimeter profile, a microscope-like visual-tactile interface could be devised for better visuomotor control (Indovina, 2001).

Lastly, the fingertip sensing can contribute to building a more reliable virtual environment. That is, a user's actual sensation or behavior can be referred to build a more reliable haptic interface. For example, many studies on physically-based models are built with commercial haptic interface, such as PHANToM™, GHOST™ SDK, and OpenHaptics™. In using these device interfaces, force measurement from torque calculation doesn't include the hand/finger posture or grip condition. Consequently, verification of tactile stimulation mostly depends on the user's subjective impression. As a more objective means of verification, a fingertip input system can be used with the mapping capability of haptic stimuli (see FIG. 4).

A true fingertip input system should provide an exploratory environment where man and machine perfectly share the haptic stimuli. That is, machine sensing should be paralleled with the subject's touch sensation, so that overall work performance can be enhanced by two valuable sources: machine's digital power, and the human's instinctive exploratory capability. For machine's acquisition of the haptic stimuli, two approaches are possible: one is an invasive solution that biases the electric voltage change from the nerve cord inside the body, the other is placing a tactile sensor between the surfaces of the fingertip and an object. Due to the risk of invasive approaches, the sensor attachment to the fingertip has been regarded as the only way for tactile sensing. However, this simple and handy solution causes many adverse effects to both man and machine in practice.

First of all, the tactile sensor's physical contact on skin creates an adverse effect. That is, to a user, the sensor considerably degrades his or her tactile sensation. The solution to this problem mostly depends on the sensor's physical dimension and material property, such as thickness and flexibility. The active studies in micro-electronics or nanotechnology are expected to produce much more convenient sensors in the future. In fact, researchers are developing non-invasive and indirect contact sensors for tactile sensing. For example, Asada and Mascaro (2001) developed an optical fingernail sensor that captures the redness of the fingernail for interpreting the fingertip's forces and posture (Mascaro & Asada, 2001; 2004). As long as non-invasive sensors are recommended, indirect tactile sensing technology that captures the phenomena near the contact point is promising for preserving a subject's own tactile sensation.

Secondly, wearing attachments, such as gloves, causes considerable encumbrance. That is, it usually envelops most of or the entire part of hand, so that intuitive exploratory activity cannot be expected with such an interface. Also, the fit of the glove can cause large variations in actual implementation of measurement.

Lastly, the mechanical properties of the human fingertip system affect the overall accuracy. In previous studies, the fingertip system was assumed to be of high-stiffness for convenience in analysis. With a flexible tactile sensor attached in between the fingertip and object, a designer should consider the complex phenomena at the fingertip. This includes the fingertip tissue's viscoelastic behavior and the finger's joint impedance. Moreover, in active touch, the fingertip tissue's viscoelastic behavior is different from that of passive touch. Therefore, appropriate description is hard to obtain by the conventional Kelvin model as described in the following section.

The behavior of human skin or joint impedance is an important issue for accurate control and effective haptic replication. To simulate the tissue behavior, such as creep and relaxation, three basic mechanical systems are considered: Maxwell, Voigt, and Kelvin body (also called Standard Linear Solid). Many fundamental studies have employed a mass-spring-damper system or a series of the Kelvin body (Pawluk, 1996; Pawluk 1997; Gulati & Srinivasan, 1997). To avoid the inconvenience of dealing with numerous bodies, Fung adopted a non-linear viscoelastic model (Fung, 1993). In a passive touch experiment with an indent probe, Pawluk and Howe (1999a) demonstrated the validity of Fung's model. Also, Jindrich et al.'s (2003) study showed that Fung's model was also well-suited for the active model of finger tapping in keyboard typing. Investigations were also conducted for finger tip interaction considering the contact area (Peine & Howe, 1998; Pawluk & Howe, 1999b), and stiffness (Chen, 1996). Other works from the 1990's studied various aspects of the fingertip, such as simulation by finite element method (FEM) (Raju, 1999; Buell, 1999, Cysyk, 1999), mechanical system modeling (Hajian & Howe, 1997, Fu & Oliver), index finger forces (Yokogawa & Hara, 2002), and hand models for power grip (Stergiopoulos et al., 2003; Sancho-Bru et al., 2003).

The main focus of the studies above was the tissue or joint response due to applied forces that served as a contact probe of passive touch. The affect of active fingertip touch was not considered. There has been minimal research on active human touch, which can be found in ergonomic studies for keyboard typing (Rempel, 1994, Serina, 1997, Dennerlein, 1999; Jindrich, 2003; Jindrich, 2004).

Contact recognition (recognition of presence or absence) has been a fundamental issue in tactile sensing (Eberman & Salisbury, 1993; Eberman, 1995; Chen et al., 1995). Various contact conditions were considered by Mouri et al. (2003). Cutkosky and Hyde (1993) investigated dynamic tactile sensing for robotic manipulation. In addition, recognition of a robot's contact with human body was investigated by Iwata et al. (2003).

Object recognition by tactile sensing has been actively studied in robotics research. In the 1990's, a dynamic skin acceleration sensor was developed for detection of slip and texture (Howe & Cutkosky, 1989; Howe & Cutkosky, 1993). Fearing & Binford (1991) devised a cylindrical sensor to simulate a robot finger. The strategy for haptic perception and exploration was also studied by many researchers in the haptics community (Howe, 1994; Chen et al., 1996; Mehrandezh & Gupta, 2002; Murakami & Hasegawa, 2003). Methodologies of haptic exploration were studied by Okamura (Okamura et al., 1997; Okamura et al., 1999; Okamura & Cutkosky, 1999). These studies have been involved in the construction of surface geometry (Liu & Hasegawa, 2001; Moll & Erdmann, 2002). Haptic sensing devices have also been developed for specific needs, such as wireless texture sensing (Pai & Rizun, 2003), and tactile imaging of breast masses (Wellman & Howe, 1999).

A common form of touch digitizing is using a touch pad. For example, Westerman (2001) demonstrated an advantage of dynamic touch against the sensing pad called Multi-touch. This application used a “smart” touch pad that recognized the dynamic touch patterns for the shortcuts to keyboard typing (FingerWorks, 2005). For the purpose of object shape digitizing, such as in the reverse engineering industry, rigid-probe tactile digitizing systems are used. For instance, Immersion's MicroScribe™ is a linkage-based geometry construction system where the user traces the contour of the object with a rigid stylus (Immersion, 2004).

There has been minimal research for the use of the fingertip as a contact probe. Mayrose (2000) utilized a FlexiForce™ force transducer and a MiniBird™ position tracker for developing palpation models for various sites of the human abdomen. The same sensor configuration was used for surface modeling (Kamerkar, 2004) and subsurface modeling (Smalley, 2004). However, there are many issues in this type of interface. Accurate, free-hand, exploratory fingertip digitizing is difficult to achieve because of the finger's complex characteristics and difficulties in sensor installation. Mehta (2005) also used similar fingertip sensors for a reverse engineering application. In this research, however, the active or passive touch characteristics were not studied. To our knowledge, there is no fingertip digitizing research for active, dynamic, and viscoelastic touch.

The fundamental idea of a hand input system can be found in Sturman's work (Whole Hand Input: Sturman, 1992). The need of the end-effector's motion tracking or kinesthetic sensing motivated the development of virtual gloves. Issues on finger and/or hand gesture interfaces can be found in a couple of reviews (Sturman & Zeltzer, 1994; Hinckley, et al., 1994). There are several types of data input gloves: DataGlove (VPL, 1987), Spacesuit Glove (Tan, 1988), PowerGlove (Burdea, 1993; Popescu, 1999), DidjiGlove (Anon, 1998), PinchGlove (McDowall et al., 2000), 5DT DataGlove (FifthDimension, 2000), and CyberGlove (Immersion, 2001). Interested readers can refer to the review of this technology by Burdea and Coiffet (2003).

The main measurements of the examples above are the finger's posture and/or its kinesthetic force (not the tactile force). The SensoryGlove (Mayrose, 2001) and ModelGlove (Kamerkar, 2004) captured both the finger position and tactile force. Other types of virtual gloves were more concentrated on the dynamic characteristics of the hand/fingers. A set of accelerometers were also used for some basic research in character recognition, or sign language interpretation (Acceleration Sensing Glove, Hollar, 1999; AcceleGlove, Hernandez-Rebollar et al., 2002a; Hernandez-Rebollar et al., 2002b, 2004).

### SUMMARY OF THE INVENTION

The purpose of the present invention is to add a new perspective to tactile digitizing methodology by introducing dynamic, active, and viscoelastic characteristics of human touch, which is referred to herein as the “active touch paradigm.” The importance of this approach is demonstrated with a series of device developments described herein. The present invention may be a foundation of active touch applications, so that any project for a free-hand touch interface may refer to the instant specification.

The invention broadly comprises a finger-mounted implement including a kinesthetic sensor, at least one tactile sensor, and means for securing the kinesthetic sensor and the at least one tactile sensor to a fingertip. The at least one tactile sensor may include a thin-film force transducer. The at least one tactile sensor may include a piezoelectric accelerometer, wherein an artificial fingernail may be connected to the accelerometer. The at least one tactile sensor may include both the thin-film force transducer and the piezoelectric accelerometer. The kinesthetic sensor may include a magnetic transducer. The kinesthetic sensor preferably senses an X-Y-Z position and an angular orientation of a fingertip to which the kinesthetic sensor is secured. The securing means may include at least one means selected from the group consisting of adhesive tape, an elastically deformable cover, and detachable adhesive.

The invention also broadly comprises a haptic sensing system including a human fingertip, a kinesthetic sensor mounted on the fingertip for providing kinesthetic signal information indicating a position of the fingertip in space, at least one tactile sensor mounted on the fingertip for providing tactile signal information indicating at least one of acceleration at the fingertip and contact force applied at the fingertip, and signal processing circuitry receiving the kinesthetic signal information and the tactile signal information and generating a digital data set describing active movement of the fingertip over time, whereby the fingertip may be used as a digitizing probe or digital input device. The signal processing circuitry preferably generates the digital data set in real time. The signal processing circuitry may be embodied in a plurality of electronics units and a computer connected to the plurality of electronics units. The system may further include a display connected to the computer, wherein the computer is programmed to provide a virtual reality representation on the display based on the digital data set.

The invention further broadly comprises a method of haptic sensing including the steps of: mounting a plurality of sensors on a fingertip of a human, the plurality of sensors providing tactile signal information associated with the fingertip and kinesthetic signal information associated with the fingertip; actively moving the fingertip to touch an object; and processing the tactile signal information and the kinesthetic signal information provided during the active movement of the fingertip. The tactile signal information may indicate at least one of acceleration at the fingertip and contact force applied at the fingertip. The kinesthetic signal information may indicate at least one of position of the fingertip in space and angular orientation of the fingertip in space. The step of actively moving the fingertip may include moving the fingertip while the fingertip is in contact with the object and moving the fingertip while the fingertip is out of contact with the object. The step of actively moving the fingertip may include performing a tactual task selected from the group of tactual tasks consisting of rubbing the object, palpating the object, tapping the object, and scratching the object. The tactile signal information and the kinesthetic signal information may be processed to determine properties of the object. The method may further include the step of digitally modeling the object based on the determined properties of the object. The tactile signal information and the kinesthetic signal information may be processed to determine characteristics of the active movement of the fingertip.

It is a general objective of the invention to provide an apparatus, system and method for haptic sensing of an object. It is a further object to provide an apparatus for sensing material and structural characteristics of the object.

It is also a general objective to digitally represent the sensed object though data sets and visual models.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic illustration of a haptic sensing system;

FIG. 2 is a flow chart of the active touch model by Loomis and Lederman (1984);

FIG. 3 is a diagram of an advantage of visual mapping in tactile sensing;

FIG. 4 is a diagram illustrating the verification of the tactile input system and the replication system;

FIG. 5 is a schematic diagram broadly showing the present invention;

FIG. 6 is a schematic diagram illustrating the concept of tactile sensing;

FIG. 7 is a schematic illustration of finger-object interaction;

FIG. 8 is a series of plots showing sensor signals as a function of time to illustrate the expansion of measurement in the spatial and time domains;

FIG. 9 is a series of plots showing sensor signals as a function of time for a range test of finger tapping;

FIG. 10 is view showing a fingertip digitizer implement formed in accordance with an embodiment of the present invention;

FIG. 11 is a cross-sectional view of a touch tester used in calibrating and practicing the present invention;

FIG. 12 is a schematic diagram showing components of the MiniBird™ motion tracker;

FIG. 13 is a graph showing temperature sensitivity of the piezoelectric accelerometer;

FIG. 14 is a graph showing the accelerometer's calibration by the manufacturer;

FIG. 15 is a graph representing voltage vs. force for the piezoelectric force sensor;

FIG. 16 is a graph representing force vs. voltage for the piezoelectric force sensor;

FIG. 17 is a graph showing a response behavior of the tactile sensor;

FIG. 18 is a graph showing the repeatability and break force of the tactile sensor;

FIG. 19 is a graph representing voltage vs. force for a finger-pad tactile sensor;

FIG. 20 is a graph representing force vs. voltage for the finger-pad tactile sensor;

FIG. 21 is a graph showing force response of the finger-pad tactile sensor before calibration;

FIG. 22 is a graph showing force response of the finger-pad tactile sensor after calibration;

FIG. 23 is an illustration showing contact conditions associated with the tactile sensor;

FIG. 24 is a graph representing voltage vs. force for a finger-nail tactile sensor;

FIG. 25 is a graph representing force vs. voltage for the finger-nail tactile sensor;

FIG. 26 is a graph showing force response of the finger-nail tactile sensor before calibration;

FIG. 27 is a graph showing force response of the finger-nail tactile sensor after calibration;

FIG. 28 is a schematic diagram showing system architecture of an embodiment of the present invention;

FIG. 29 is a block diagram showing a multi-rate data acquisition scheme in LabVIEW;

FIG. 30 is a diagram showing various coordinate systems used in practicing an embodiment of the present invention;

FIG. 31 is a diagram showing four types of touch for recognizing object properties;

FIG. 32 is a diagram showing tissue behavior in response to ramp indentation by Pawluk & Howe;

FIG. 33 is a diagram of Hajian & Howe's model of finger impedance in extension and abduction;

FIG. 34 is a graph of tissue indentation represented by force vs. indentation;

FIG. 35 is a graph of tissue indentation represented by indentation vs. force;

FIG. 36 is an illustration of an experimental setup for a rubbing test;

FIG. 37 is a perspective view of an actual rubbing test for plane recognition;

FIG. 38 is a series of graphs showing measurement signals during a fingertip rubbing experiment;

FIG. 39 is a graph representing plane recognition by fingertip rubbing;

FIG. 40 is a schematic diagram of Fung's quasi-linear visoelastic tissue model;

FIG. 41 is a graph of tissue indentation simulation of a sinusoidal input;

FIG. 42 is a graph of tissue indentation simulation of the sinusoidal response;

FIG. 43 is a schematic diagram of a dynamic palpation model on a soft object modeled as a Voigt body;

FIG. 44 is a graph representing a kinesthetic (spatial) sensor's response in the dynamic palpation model simulation;

FIG. 45 is a graph representing a tactile force sensor's response in the dynamic palpation model simulation;

FIG. 46 is an illustration of an experimental setup for a palpation test;

FIG. 47 is a perspective view of an actual palpation test for recognizing heterogeneity;

FIGS. 48A-C are a series of graphs showing measurement signals during palpation on a soft object;

FIG. 49 is a graph of fingertip trajectory for recognizing heterogeneity by palpation;

FIG. 50 is a graph of fingertip trajectory for recognition of heterogeneity by palpation;

FIG. 51 is a graph of force versus time showing an active touch response;

FIG. 52 is an illustration of an experimental setup for a tapping test;

FIG. 53 is a diagram showing various coordinate systems used in practicing an embodiment of the present invention for fingertip posture definition;

FIG. 54 is a schematic diagram representing the compound model for active tapping;

FIG. 55 is a graph of force versus time for a simulation of light tapping on stiff surfaces;

FIG. 56 is a graph of force versus time illustrating the effect of additional mass and higher impact speed on active tapping;

FIG. 57 is a series of graphs representing measurement signals for a typical active tapping trial;

FIG. 58 is a graph showing a result of an optimized tapping model fit;

FIG. 59 is a graph showing fingertip impact force responses associated with contacting various materials;

FIG. 60 is a graph showing fingertip impact acceleration responses associated with contacting various materials;

FIG. 61 is a graph providing an elasticity comparison of the different materials represented in FIGS. 59 and 60;

FIG. 62 is a graph showing fitting error of the different materials;

FIG. 63 is a graph of force versus time showing a fingertip response during the tapping of a soft object;

FIG. 64 is a graph illustrating the effect of an object's elasticity on force response;

FIG. 65 is an illustration of an experimental setup for nail-scratching;

FIG. 66 is a series of graphs representing contact force, acceleration, and stroke position during nail-scratching;

FIG. 67 is a graph of a plane-fit result of a vibratory acceleration response;

FIG. 68 is a graph of a plane-fit result for various surface roughness conditions;

FIG. 69 is a schematic diagram of a Touch Painter application in accordance with a further embodiment of the present invention;

FIG. 70 is a screenshot of a random spot generation created by the Touch Painter;

FIG. 71 is a screenshot of a random spot generation in Touch Painter per-vertex pixel in 3D space;

FIG. 72 is a rendering of a natural ink painting produced by the attributes of the fingertip, such as applied force and acceleration;

FIG. 73 is a rendering of an oriental calligraphy produced by the attributes of the fingertip, such as applied force and acceleration;

FIG. 74 is a schematic diagram of a Tactile Tracer application in accordance with a further embodiment of the present invention;

FIG. 75 is a screenshot of a console of a data receiver of the Tactile Tracer;

FIG. 76 is a flow chart representing a process of NURBS surface generation for real-time visualization;

FIG. 77 is shows an example of NURBS surface generation by the fast filtering method;

FIG. 78 is a perspective view showing an experimental setup for a human participant test for object digitizing and 3D visualization using the fingertip digitizer and the Tactile Tracer;

FIG. 79 is a perspective view of a wooden block to be digitized in accordance with the digitizing test;

FIG. 80 is a 3D digital representation of the wooden block;

FIG. 81 is a perspective view of a computer mouse to be digitized in accordance with the digitizing test;

FIG. 82 is a 3D digital representation of the computer mouse;

FIG. 83 is a perspective view of a soft gel with hard core to be digitized in accordance with the digitizing test;

FIG. 84 is a 3D digital representation of the soft gel with hard core;

FIG. 85 is a graph and table showing completion times for various participants in the 3D digitizing test;

FIG. 86 is a 3D digital representation of a human hand produced using a fingertip digitizer and methods of the present invention;

FIG. 87 is a graph and table showing assessments of sensor attachment comfort provided by various participants in the 3D digitizing test;

FIG. 88 is a graph and table showing assessments of fingertip digitizer transparency (how well the sensor attachment preserved the user's own tactile sensation) provided by various participants in the 3D digitizing test;

FIG. 89 is a graph and table showing assessments of fingertip digitizing ease provided by various participants in the 3D digitizing test;

FIG. 90 is a graph and table showing assessments effectiveness of multimodal presentation associated with fingertip digitizing provided by various participants in the 3D digitizing test;

FIG. 91 is a schematic diagram of a fingertip digitizing verification process in accordance with the present invention;

FIG. 92 is a flowchart illustrating a procedure of geometric model construction in accordance with the present invention;

FIG. 93 is screenshot from a Rhino™ 3D CAD modeler used in implementing the procedure of FIG. 92;

FIG. 94 is a screenshot showing a model of the virtual object created by fingertip digitization;

FIG. 95 shows a first virtual object created by touch on the real object, and a second geometric model created by touch on the virtual object using PHANToM; and

FIG. 96 is a series of graphs showing force and acceleration response signals for the real and virtual objects.

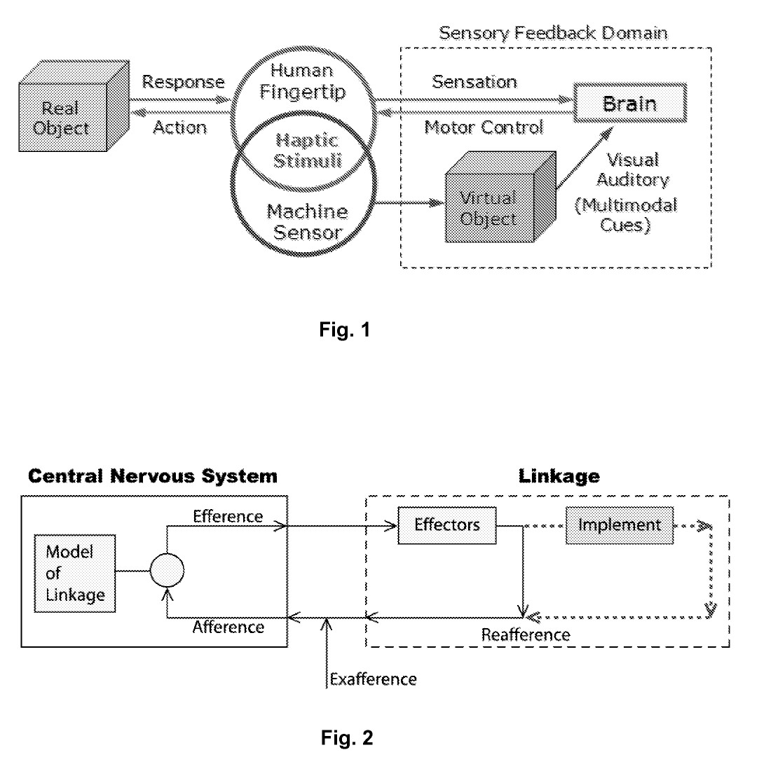

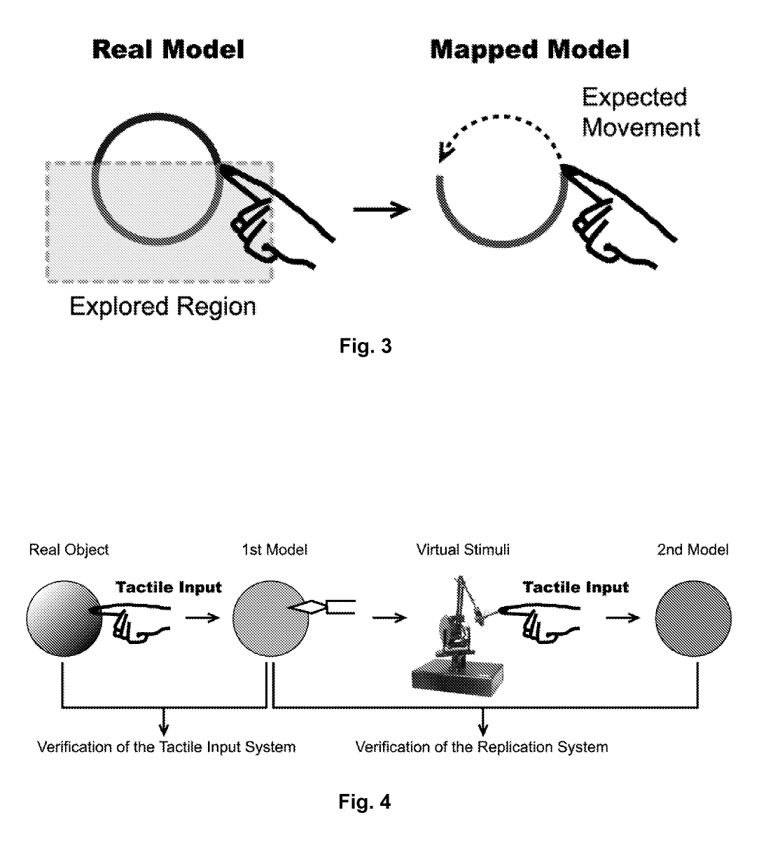

### DETAILED DESCRIPTION OF THE INVENTION

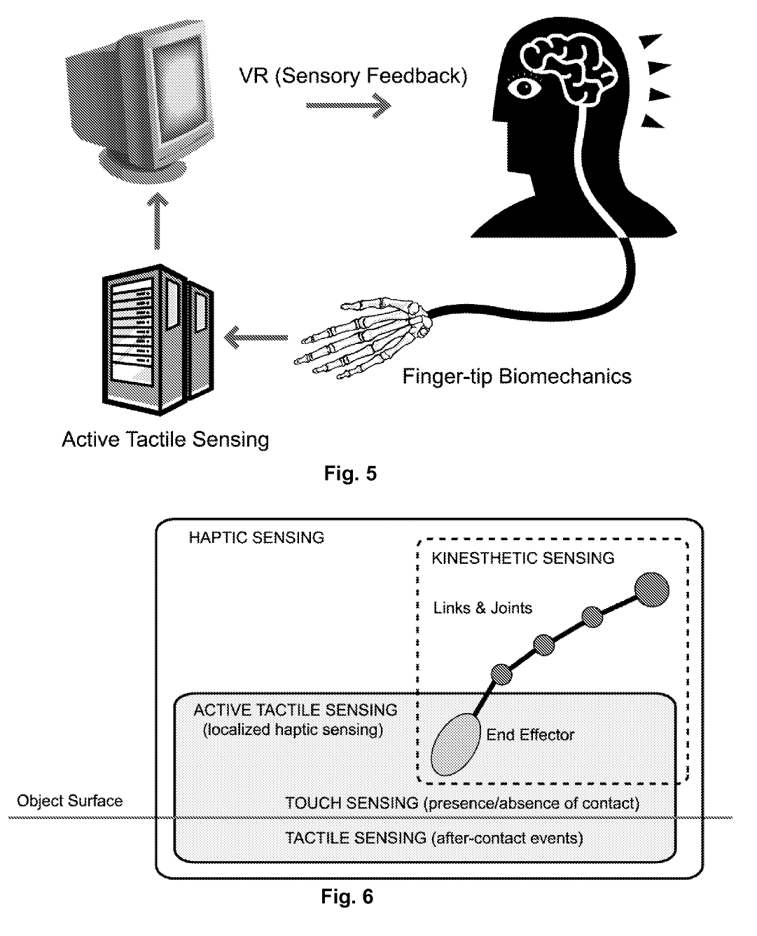

As suggested previously, the present invention involves many issues of human interaction studies. In particular, the invention involves three specific engineering fields in methodology. They are tactile sensing (with the active touch paradigm), biomechanical study (kinesthetic sensing), and virtual reality implementation (see FIG. 5).

Firstly, the invention embodies the active touch paradigm to conventional passive methods of tactile sensing. In the previous studies (Mayrose, 2000; Kamerkar, 2004; Smalley, 2004; Mehta, 2005), the sensing methodology entirely depended on the contact condition. That is, in passive touch, the contact is the prerequisite for all sensing activities; nothing happens to machine until the onset of contact. On the contrary, for the active touch paradigm of the present invention, the machine always keeps track of fingertip activities. Here, the interaction between the finger and object is the most important—the system needs to watch and recognize both the input and the corresponding response. Therefore, conceptually, active tactile sensing can also be explained as localized haptic sensing (see FIG. 6).

There are many advantages of the active touch paradigm. For behavioral studies, a better understanding about finger-object interaction can be achieved from this full coverage of measurement. For an object digitizer, it should be capable of recognizing not only the geometrical shape of the surface, but also internal properties of the object. For instance, the doctor's diagnosing hammer or people knocking on a watermelon to check its ripeness. Here, the examiner recognizes the inside-properties from the unique responses to an impact input, such as force, sound, and visual cues (see FIG. 7).

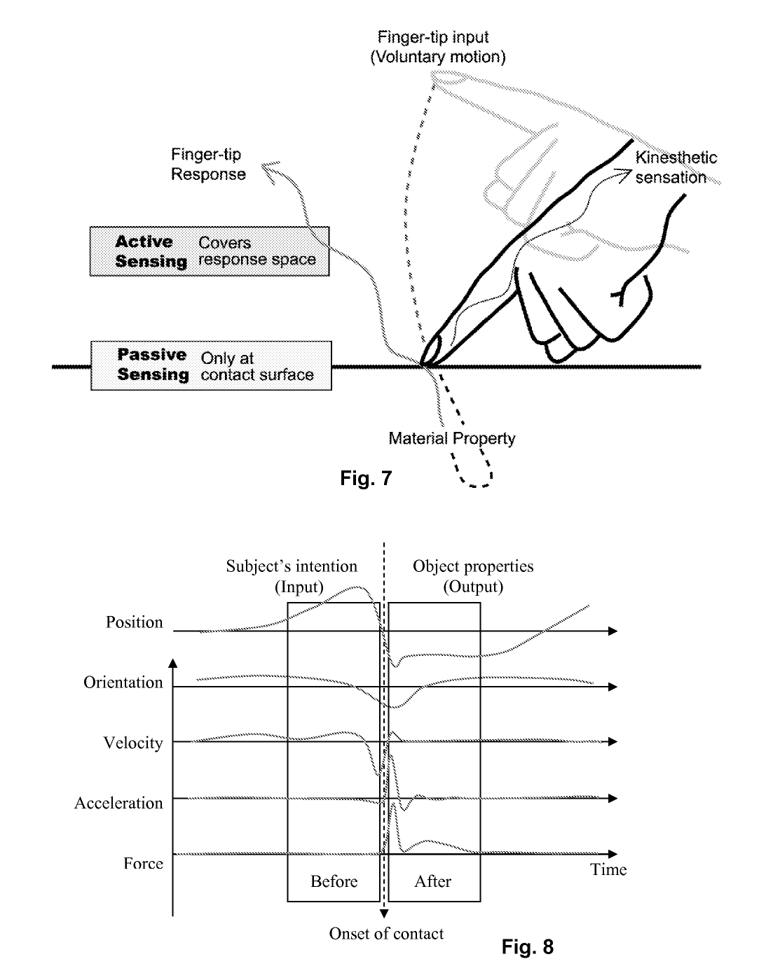

Also, for a user, a touch interface becomes considerably convenient—his or her hand doesn't always have to be in contact with the surface, which is more appropriate for exploratory tactual tasks. To accomplish active tactile sensing, the machine must expand the sensing range both in spatial and temporal domain (see FIG. 8), which is one of the important methods in the present invention. The hardware and software implementation is described below.

For the implementation of the active tactile sensing, four specific patterns of manual tasks are described as examples. They are rubbing, palpating, tapping, and nail-scratching. Finger tapping, in particular, will be treated as an important tactual pattern for determining the material property. This is because it can produce the fingertip responses that include viscoelastic components, whereby recognition is possible by comparing a user's input and the unique response form of the object being examined. Palpation is considered more suitable to check any non-homogeneity in soft material, or to evaluate the static stiffness. Rubbing is useful for the recognition of the geometrical shape of the surface. Nail-scratching is ideal for recognizing surface conditions of the object, for instance, the surface roughness. The result of this fundamental study can be applied for sensation mapping, therefore the information of tactile sensing can be captured in a three dimensional virtual environment with multimodal sensory feedback.

In fingertip digitizing, the complex characteristics of the fingertip (for instance, joint impedance and tissue's viscoelastic behavior) should always be captured in the response signal. It is important for a tactile sensing system to take this into account for an accurate recognition of object properties.

Once the tactile sensing is done, the information is mapped into a virtual environment (VE). This is not only to assist a user to overcome the short term memory of tactile sensing, but also to enhance a user's weak sensation with real-time sensory feedback. For example, visualization or auditory stimuli should instantly present fingertip motions and corresponding responses. For this, a data acquisition/processing system is developed with multi-rate sensing, so that it is not restricted to a heterogeneous hardware environment. Also, a networking system is built so that high computational components of the task are distributed into separate channels: namely data acquisition/processing, and visualization/user interface. The system will be designed for multi-device and multi-user applications. A few applications of this technology will are described below.

The dynamic fingertip digitizer is now discussed. The present invention provides a device to implement the active tactile sensing (or localized haptic sensing; see FIG. 6) which measures the whole (static and dynamic) aspect of tactile activities, and eventually achieves the active touch paradigm. This functionality overcomes many limitations of conventional tactile sensing. First, a fingertip movement itself can have a meaning without an incident of contact (before-contact events), so that the user's intention can be acknowledged by pattern recognition. Second, after the onset of contact, object properties, such as surface shape and material property, can be recognized by comparing the user's finger motion and corresponding response.

Tactile sensing refers to human's (or machine's) cutaneous sensing at a contact point of the fingertip (or the end-effector). In fingertip digitizing this can be implemented by attaching a pressure sensor to the fingertip. The role of this sensor is to measure the variation of physical phenomena at the contact point. Various measurements are possible for this. In the present invention, two measurements are dealt with for the tactile sensing, namely force and acceleration variation.

Force sensing is an important function of tactile sensing. The force sensor should recognize both the onset of contact (touch sensing) and the force variation. In the present invention, fingertip contact is assumed to be single-point contact. Another important measurement is acceleration. There can be different types of acceleration response at the fingertip; it can be due to finger movement, tissue slip, or the vibration while nail-scratching. In the present invention, acceleration is measured at the fingernail. At this location, the sensor is expected to capture the acceleration of touch motion and transmitted vibratory response. This will eventually allow the recognition of non-contact behavior, impact response, and surface texture.

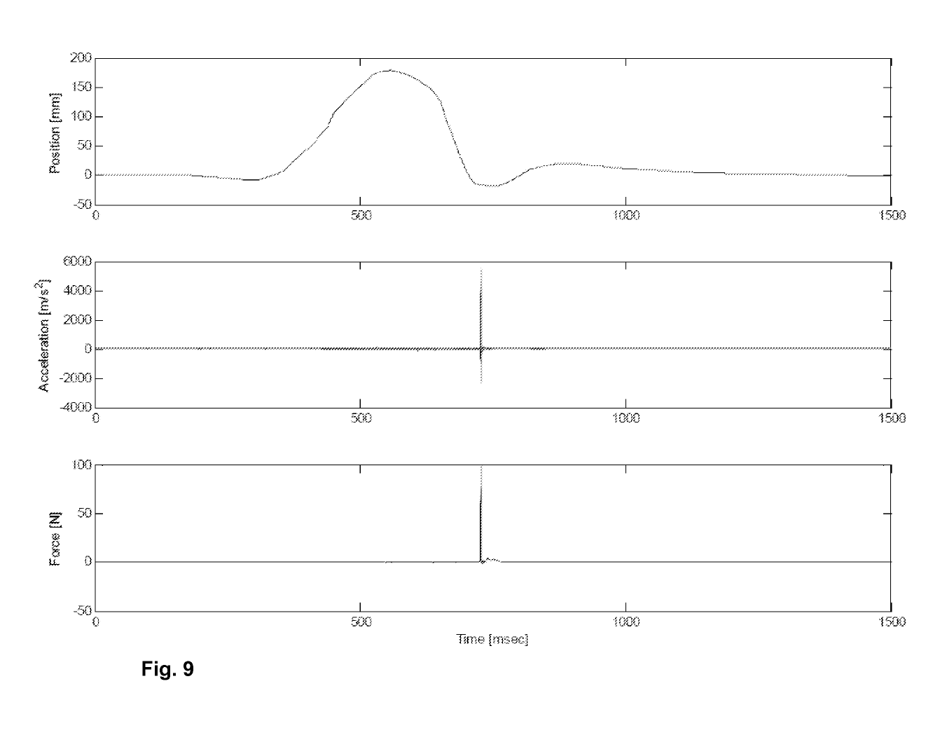

The dynamic range of tactual activity is one of the main considerations in designing a tactile sensing system. The usual dynamic ranges are 0˜20 N of contact force (at palpation), and ±500 m/s2 of acceleration (at light tapping). However, the compliance and energy-absorbing capability of the finger can raise the measurement range up to 100 N and 5000 m/s2 during strong tapping (FIG. 9). Kinesthesis refers to the human sensation of the muscles and joints (linkage and end-effector in machine's case), and works for recognizing position of the stimuli. This sensation is necessary for integrating fragments of tactile sensation into a whole picture of the examining object. In the present invention, kinesthetic sensing includes the position and orientation of the index finger's distal phalange. Regarding the finger-pad's deformation range of 0˜5 mm (it varies depending on individual), the sub-millimeter accuracy is usually required for the position/orientation sensor.

To achieve haptic sensing, the two (tactile and kinesthetic) senses mentioned above must be collected and integrated. In design and implementation, there often exists hardware or software incompatibility between the sensors and transducers. For example, the hardware's sampling rates may be fixed or limited for some devices, thus it can be a constraint for the entire system design. In the present research, it is desirable to have more than a 10 kHz sampling rate to measure dynamic and impulsive input and response of finger tapping.

To achieve an effective tactile task, it is recommended that the user's hand and fingers be minimally enveloped by sensors and attachments. Gloves usually cause sweat, numbness at the skin, resulting in restricted hand and finger motion. The user's performance can also be affected by the fitting condition, such as snug and tight fit.

All devices and materials used should be non-toxic, non-invasive, and of minimal risk to the user.

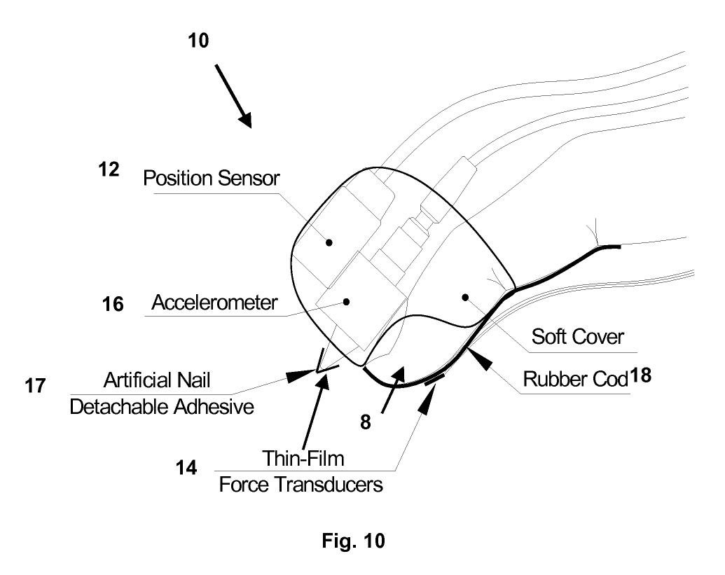

A fingertip digitizer formed in accordance with an embodiment of the present invention is shown in FIG. 10 and designated generally by reference numeral 10. Fingertip digitizer 10 generally comprises a set of miniature sensors and may include a kinesthetic sensor 12 for measuring position and orientation of the fingertip, and tactile sensors including a flexible thin-film force sensors 14, and an accelerometer 16. The subject's fingertip was protected by safe materials, such as a soft rubber cod 18 and detachable adhesives 20 which also secure the sensors to a fingertip 8.

The sensors may be securely glued on the finger pad and nail with detachable adhesive. An artificial fingernail 17 may be coupled to accelerometer 16 to provide tactile sensing structure for nail-scratching applications. Force sensors 14 may be attached to the finger pad, finger tip and the fingernail (natural or artificial nail 17). Sensor outputs may be acquired at 10 kHz, using a computer data acquisition (DAQ) board (PCI-6024E) and software (LabVIEW, National Instruments, Austin, Tex.). The signals may be filtered using a 20th order Butterworth low-pass filter.

Characteristics and calibration of sensors used in a prototype embodiment are now described.

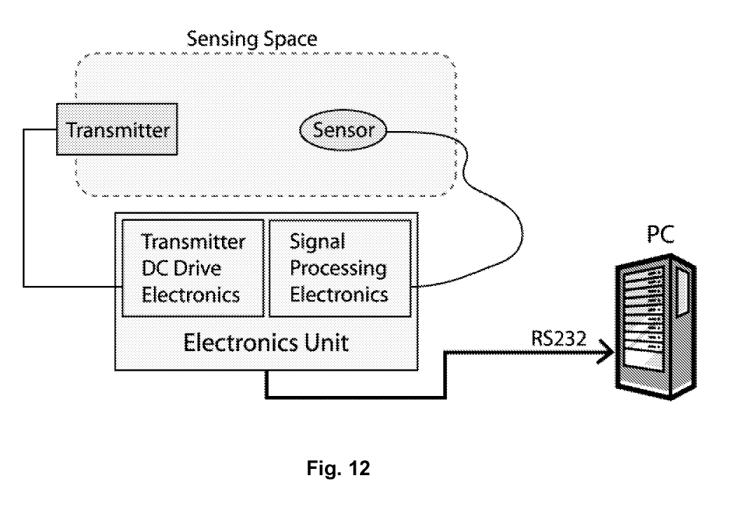

The position and orientation of the fingertip were measured by a MiniBird™ position tracker (Model 800; Ascension Technology, Burlington, Vt.), shown in FIG. 12. This miniaturized device has a magnetic transducer with a range of 6 feet.

It is recommended to have calibration carried out before use because MiniBird transduction can be affected by ferromagnetic materials, such as a CRT monitor and common steel structures. For drive and calibration purposes, a DAQ (data acquisition) console may be developed using LabVIEW's virtual instrumentation technique. Displacement and orientation may be calibrated in a cubic, three-dimensional space of 300×300×300 mm.

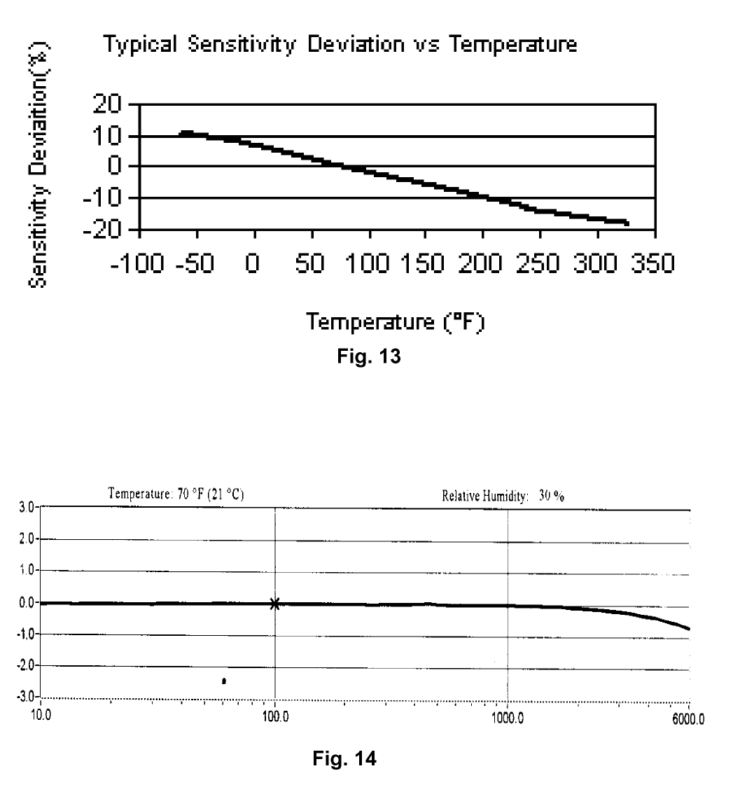

To measure the accelerations at the fingertip, a tri-axial miniature accelerometer (Miniature Tri-axial ICP™ Accelerometer, Model 356A63, PCB Piezotronics, Depew, N.Y.) may be used. For data acquisition, it is suitable to use a BNC cable connection, a three-channel signal conditioner (Model 408B21, PCB Piezotronics), and a charge amplifier (Model 5400, KISTLER, Amherst, N.Y.). There are two important roles for this sensor. One is to measure the impulsive acceleration at tapping impact, and the other is to measure the vibratory acceleration during nail-scratching. Piezoelectric accelerometers are capable of measuring very fast acceleration variations, such as machinery vibration and high frequency shock measurements. Although they can respond to slow, low-frequency phenomenon, piezoelectric sensors cannot measure truly uniform acceleration, also known as static or DC acceleration. That is, piezoelectric accelerometers cannot hold the voltage output for such uniform acceleration, and can be used only for dynamic vibration. We also adopted a ICP™ type, which refers to the built-in electronics converted to the high-impedance charge signal that is generated by the piezoelectric sensing element into a usable low-impedance voltage signal. This can be readily transmitted, over ordinary two-wire or coaxial cables, to any voltage readout device. Common piezoelectric accelerometers are sensitive to operation temperature, see FIG. 13. Thus, for accelerometer calibration, the manufacturer's report was referenced, see Table 2 and FIG. 14.

TABLE 2
Manufacturer's accelerometer calibration data.
(Source: PCB Piezotronics, Depew, NY).

| Sensitivity | 1.005 mV/(m/s²) (9.86 mV/g) | |
|---|---|---|
| Output Bias | 8.5 | VDC |
| Transverse Sensitivity | 0.1% | |
| Discharge Time Constant | 0.5 | seconds |
| Temp. Coef. at 163° C. (325° F.) | −0.14%/° C. | (−0.077%/° F.) |
| Z-axis* Sensitivity Data | Frequency (Hz) | Deviation (%) |
| at Temperature 21° C., | 10.0 | −0.4 |
| Relative Humidity 30% | 15.0 | −0.6 |
| | 30.0 | −0.3 |
| | 50.0 | −0.1 |
| | 300.0 | −0.1 |
| | 500.0 | −0.0 |
| | 1000.0 | −0.2 |
| | 3000.0 | −2.4 |
| | 5000.0 | −5.3 |
| | 6000.0 | −7.3 |

*Other axes (X and Y) had similar behavior.

To measure the contact force, a flexible, thin-film force resistive sensor (Force Sensing Resistor; FSR, Interlink Electronics, Camarillo, Calif.) may be used. For data acquisition, a charge amplifier (Model 464, Piezotronics, Depew, N.Y.) and coaxial BNC cables may be used. Force Sensing Resistors (FSR) are polymer thick film devices which exhibit a decrease in resistance with an increase in the force applied to the active surface. There are advantages with this sensor, compared to other thin-film pressure sensors. Its relatively small size is advantageous for minimized encumbrance. Also, FSRs are relatively low-cost.

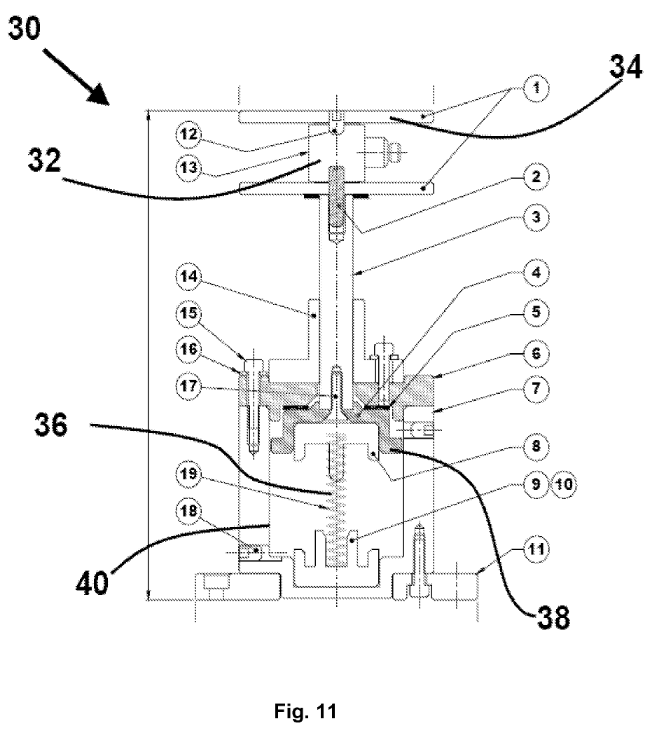

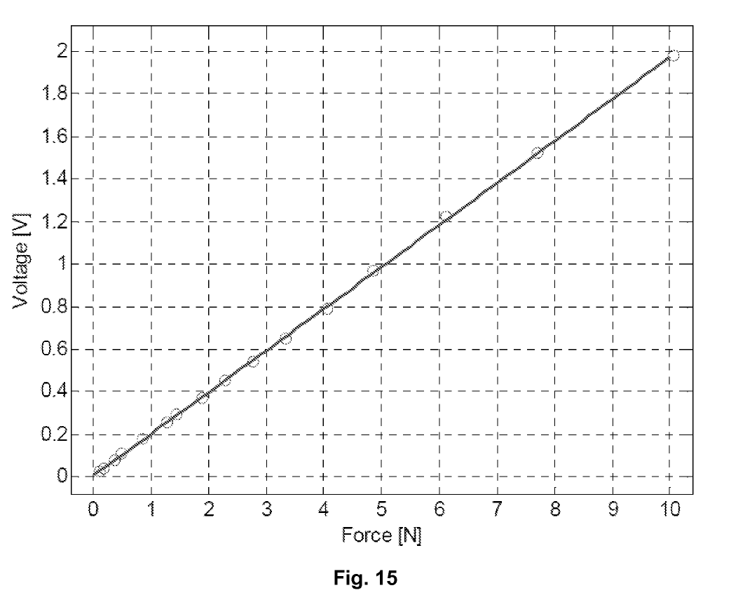

However, it should be noted that FSR was originally not intended for a precision measurement. It can be used for dynamic measurement, but only if qualitative results are obtainable. Therefore, there should be an understanding of characteristics, and careful calibration with this sensor. To assist in calibration, a touch tester 30 may be constructed as illustrated in FIG. 11. Touch tester 30 is capable of (1) measuring the contact force, and (2) providing viscoelastic response (damping and stiffness) when palpated. For contact force measurement, a dynamic force sensor 32 may be used with an end tray 34 supported thereon. For stiffness simulation, a set of precision metric springs 36 may be installed. Damping effect was designed to be caused by friction or air resistance between a piston 38 and a lining 40. The viscoelastic simulation of touch tester 30 is not effective for the response to high speed finger tapping because of the mass effect of the end tray 34 and piston system. Touch tester 30 is rather designed for low speed palpation. Dynamic force sensor 32 may be a stiff force transducer such as a Multipurpose ICP™ Force Sensor Model 208C02, available from PCB Piezotronics, Depew, N.Y. For data acquisition, coaxial cables, and a charge amplifier (Model 5499, Kistler Electronics, Amherst, N.Y.) may be used. The main purpose of dynamic force sensor 32 is to provide the reference forces for calibration of tactile sensors 14. Also, it has an important role in measuring the interaction between the fingertip and the object surface, such as compression, tension, and impact. Just as in the case of the piezoelectric accelerometer, a piezoelectric force sensor cannot hold its voltage for truly static force; it can be used only for dynamic forces. Generally, the output characteristic of piezoelectric sensors is that of an AC coupled system, where repetitive signals will decay until there is an equal area above and below the original base line. Also, it often causes sensor drift that remains static voltages to the signal. These dynamic characteristics of piezoelectric sensors should be considered in data acquisition, processing, and analysis. Piezoelectric sensors are widely used in industry because of the good quality of linearity. The piezoelectric force sensor 32 may be calibrated using a set of weights. Due to the instability of weight loading, voltage input may be acquired during unloading. The sensor behavior may be assumed to be either linear or quadratic. A least square fit may be implemented for Voltage vs. Force as shown in FIG. 15.

TABLE 3
Curve fit parameters for piezoelectric force sensor (Voltage vs. Force).

| | | |
|---|---|---|
| Fitting Type | Linear | Quadratic |
| Equation | V = P₁*F + P₂ | V = P₁*F² + P₂*F + P₃ |
| Coefficients | P₁ = 0.1967 | P₁ = 3.531e−017 |
| (with 95% | (0.1967, 0.1967) | (2.719e−017, 4.342e−017) |
| confidence bounds): | P₂ = 0.005363 | P₂ = 0.1967 |
| | (0.005363, 0.005363) | (0.1967, 0.1967) |
| | | P₃ = 0.005363 |
| | | (0.005363, 0.005363) |
| Goodness of Fit | SSE: 3.427e−029 | SSE: 9.563e−030 |
| | R-square: 1 | R-square: 1 |
| | Adjusted R-square: 1 | Adjusted R-square: 1 |
| | RMSE: 5.884e−016 | RMSE: 3.124e−016 |

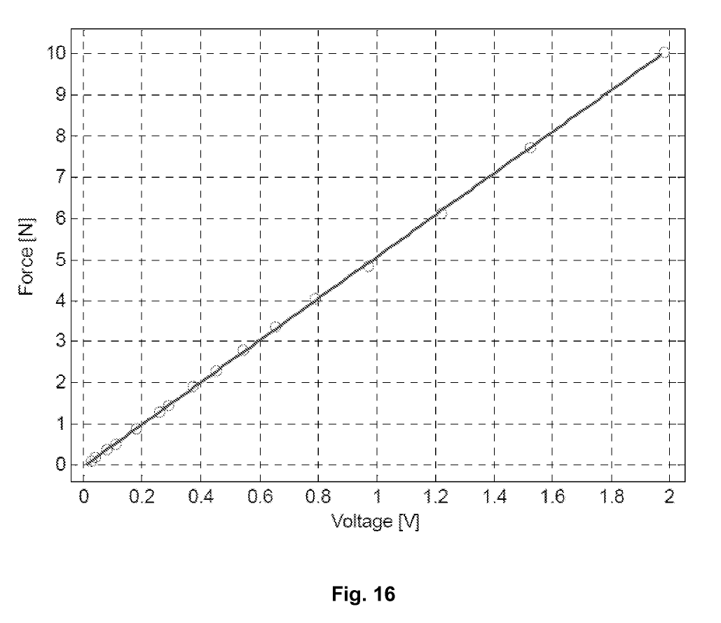

The fitting result shown above is a force→voltage equation, and cannot be directly used in practice. We usually have voltage input, which needs to be converted for the voltage→force equation. Because it is difficult to directly calculate the solution of the high order polynomial or exponential equations, another implementation of curve fitting is usually needed. Therefore, two sets of curve fitting equations are provided for convenience. The voltage→force equation is shown in FIG. 16.

TABLE 4
Curve fit parameters for piezoelectric force sensor (Force vs. Voltage).

| | | |
|---|---|---|
| Fitting Type | Linear | Quadratic |
| Equation | V = P₁*F + P₂ | V = P₁*F² + P₂*F + P₃ |
| Coefficients | P₁ = 5.085 | P₁ = 1.612e−015 |
| (with 95% | (5.085, 5.085) | (4.58e−016, 2.766e−015) |
| confidence bounds): | P₂ = −0.02727 | P₂ = 5.085 |
| | (−0.02727, −0.02727) | (5.085, 5.085) |
| | | P₃ = −0.02727 |
| | | (−0.02727, −0.02727) |
| Goodness of Fit | SSE: 2.215e−028 | SSE: 2.893e−028 |
| | R-square: 1 | R-square: 1 |
| | Adjusted R-square: 1 | Adjusted R-square: 1 |
| | RMSE: 1.496e−015 | RMSE: 1.718e−015 |

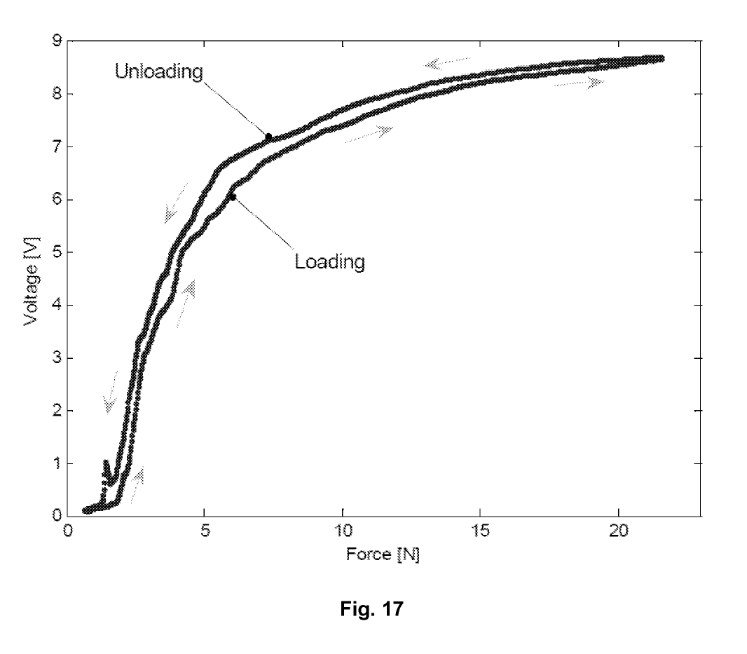

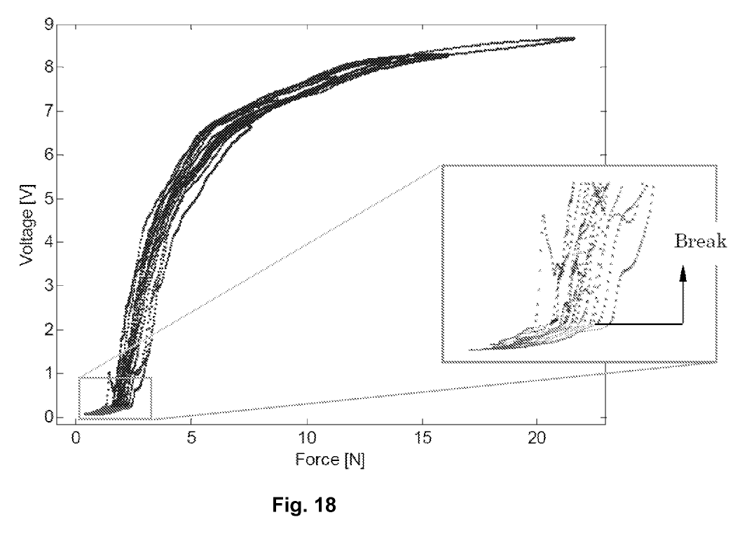

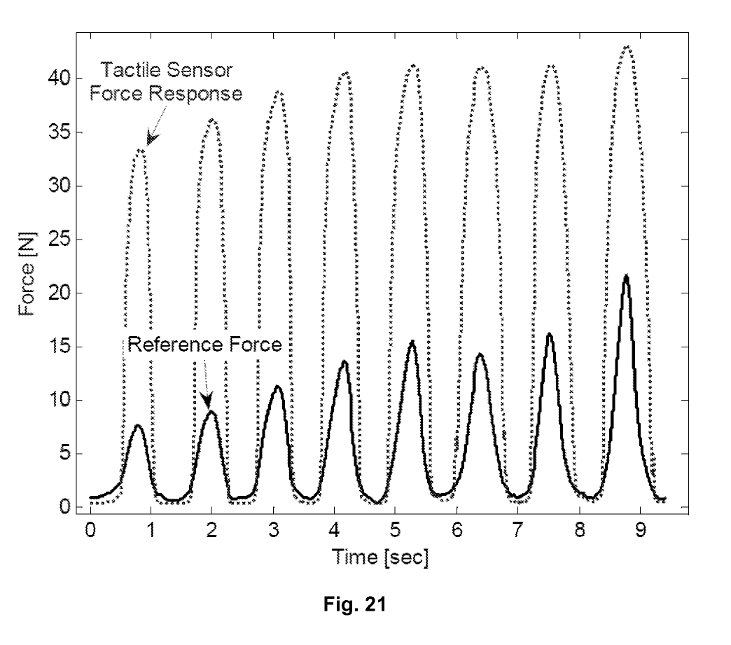

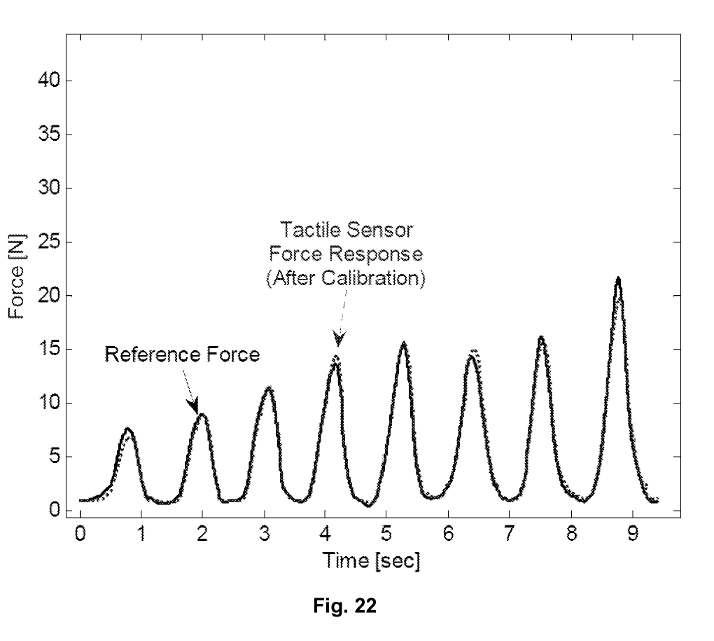

Some of the important sensor characteristics are discussed in the following section. First of all, FSRs or thin-film type sensors, have hysteresis which refers to the difference between instantaneous force measurements at a given force for an increasing load versus a decreasing load, as may be seen in FIG. 17. Secondly, FSRs are very sensitive to distribution of the applied force, and show lower linearity and repeatability compared to the piezoelectric force sensor. Generally, this precludes the use of dead weights for characterization because exact duplication of the weight distribution is rarely repeatable cycle-to-cycle. A consistent weight (force) distribution is more difficult to achieve than merely obtaining a total weight (force). As long as the distribution is the same cycle-to-cycle, then the repeatability will be maintained. This is especially true for the case of human touch, since it may be a difficult issue to handle in interpreting the response forces from the sensor. Thus, an actual fingertip palpation may be tested to simulate sinusoidal force input, see FIGS. 21-22, and corresponding responses may be obtained, see FIG. 18. Force accuracy ranged from approximately ±5% to ±25%, depending on the consistency of the measurement system and actuation system.

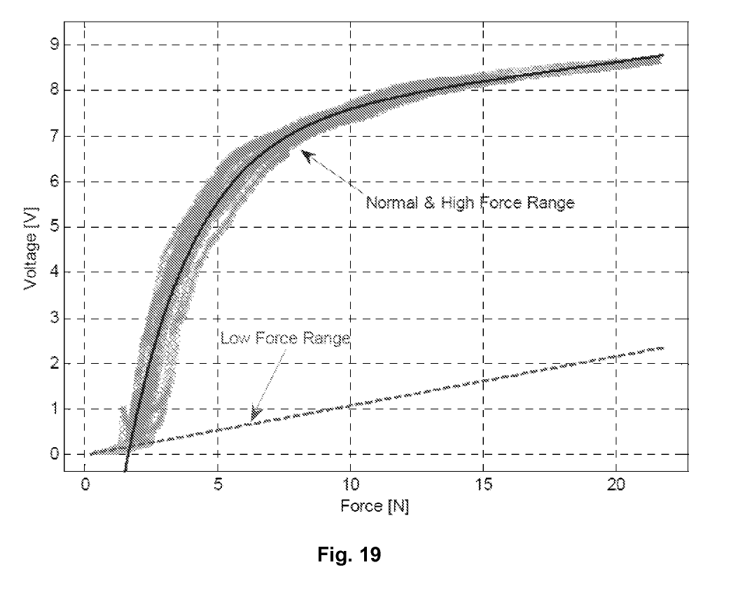

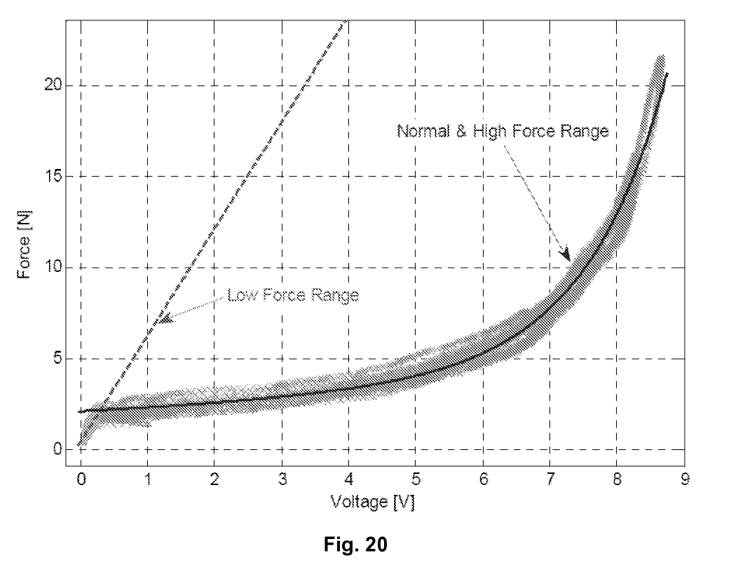

Lastly, FSRs have a break (turn-on) force that refers to a threshold for the normal sensor behavior FIG. 18. Because of this, it is difficult to explain the force-voltage relationship with a single parametric equation for sensor calibration. Thus, for purposes of the present invention, the force response may be divided into two ranges: low force range (under the break force), and normal-high force range. The sensor behavior of the low force range may be assumed to be linear, and that of the normal-high force range to be an exponential function. A least square fit was implemented for the finger-pad tactile sensor as shown in Voltage vs. Force (FIG. 19), and vice versa (FIG. 20).

TABLE 5
Curve fit parameters for the finger-pad
tactile sensor (Voltage vs. Force).

| Break Point | 0.1805 [V], 1.6840 [N] | |
|---|---|---|
| Range | Low Force Range | Normal-High Force Range |
| | (<=1.6840 [N]) | (>1.6840 [N]) |
| Fitting Type | Linear | Exponential |
| Equation | V = P₁*F + P₂ | V = A*Exp(B*F) + |
| | | C*Exp(D*F) |
| Coefficients | P₁ = 0.1083 | A = 7.175 |
| (with 95% | (0.1057, 0.1109) | (7.08, 7.269) |
| confidence bounds): | P₂ = −0.001936 | B = 0.009259 |
| | (−0.004841, | (0.008368, 0.01015) |
| | 0.0009684) | C = −13.69 |
| | | (−13.85, −13.53) |
| | | D = −0.3892 |
| | | (−0.3982, −0.3803) |
| Goodness of Fit | SSE: 3.207 | SSE: 1038 |
| | R-square: 0.6362 | R-square: 0.9684 |
| | Adjusted R-square: | Adjusted R-square: |
| | 0.6361 | 0.9684 |
| | RMSE: 0.0291 | RMSE: 0.4295 |

TABLE 6
Curve fit parameters for the finger-pad
tactile sensor (Force vs. Voltage).

| Break Point | 2.1691 [N], 0.3021 [V], | |
|---|---|---|
| Range | Low Force Range | Normal/High Force Range |
| | (<=0.3021 [V]) | (>0.3021 [V]) |
| Fitting Type | Linear | Exponential |
| Equation | F = P₁*V + P₂ | F = A*Exp(B*V) + |
| | | C*Exp(D*V) |
| Coefficients | P₁ = 5.874 | A = 2.095 |
| (with 95% | (5.733, 6.016) | (2.042, 2.147) |
| confidence bounds): | P₂ = 0.3953 | B = 0.09467 |
| | (0.378, 0.4126) | (0.08559, 0.1037) |
| | | C = 0.0106 |
| | | (0.008518, 0.01269) |
| | | D = 0.8357 |
| | | (0.8146, 0.8567) |
| Goodness of Fit | SSE: 174 | SSE: 2368 |
| | R-square: 0.6362 | R-square: 0.9804 |
| | Adjusted R-square: | Adjusted R-square: |
| | 0.6361 | 0.9804 |
| | RMSE: 0.2143 | RMSE: 0.6486 |

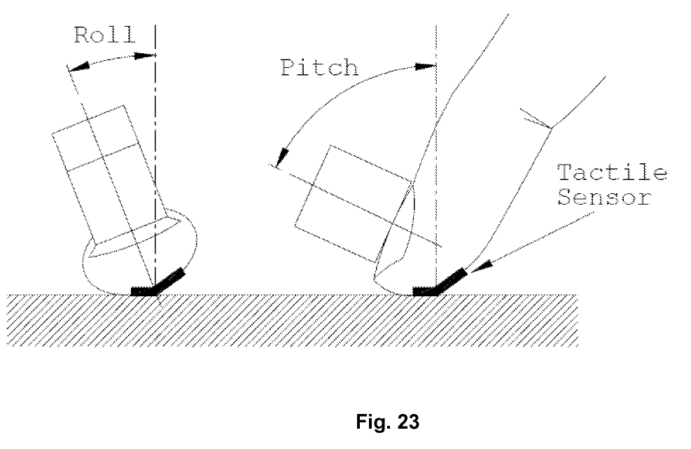

The sensor characteristics described above were for finger pad interactions, such as palpating and rubbing. One of the important concerns in these interactions is the sensor's sensitivity to contact condition. In practice, this limitation may restrict a user's hand motion. For purposes of the present invention, a valid contact condition with allowances in the fingertip's rotation angle (roll and pitch; see FIG. 23) may be defined. The same method may be used for the case of nail scratching.

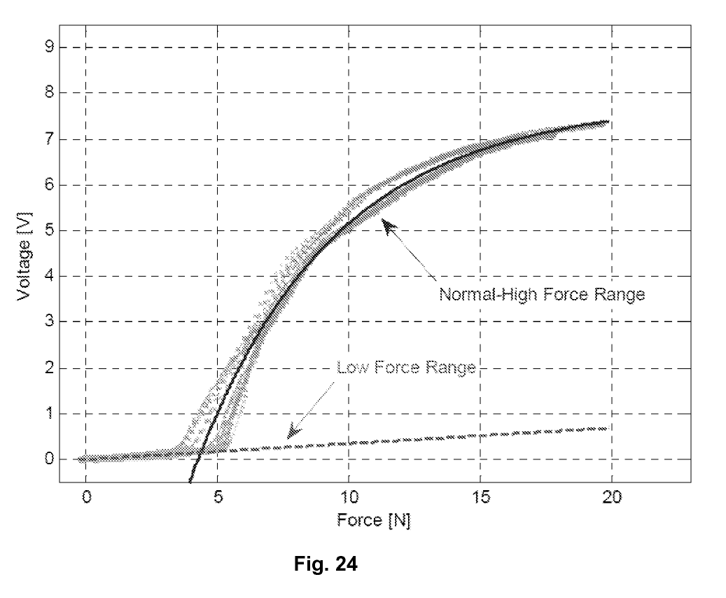

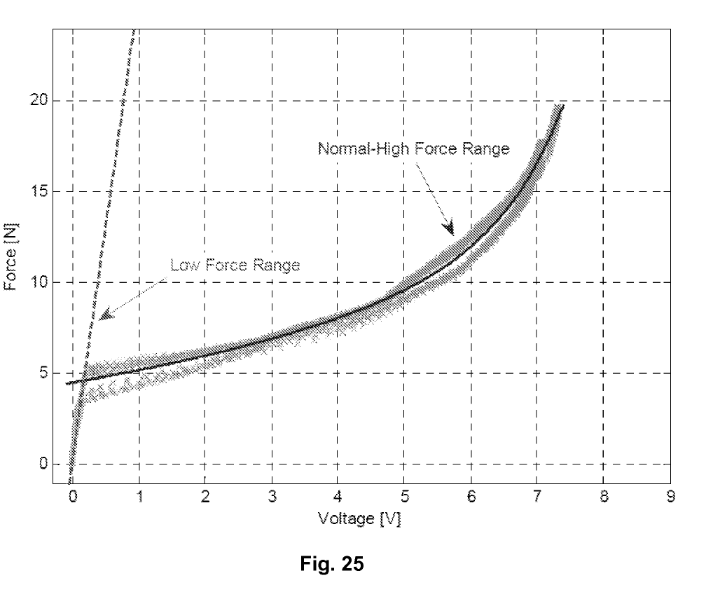

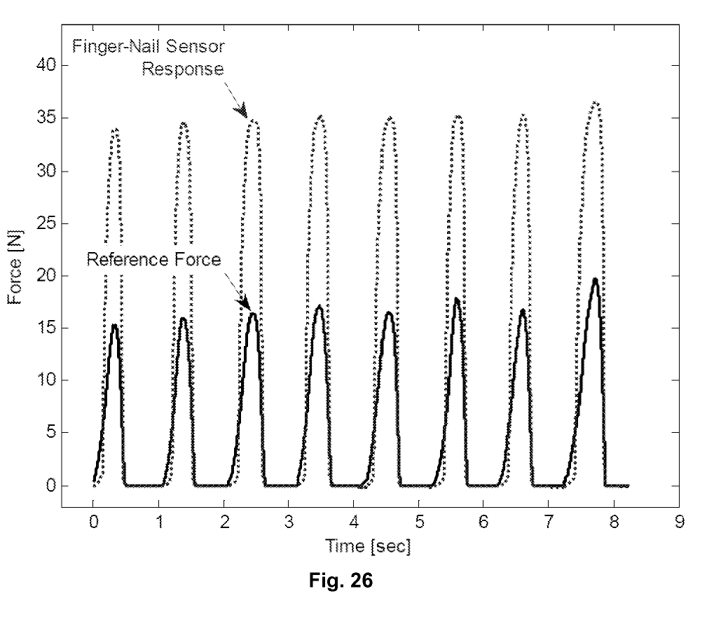

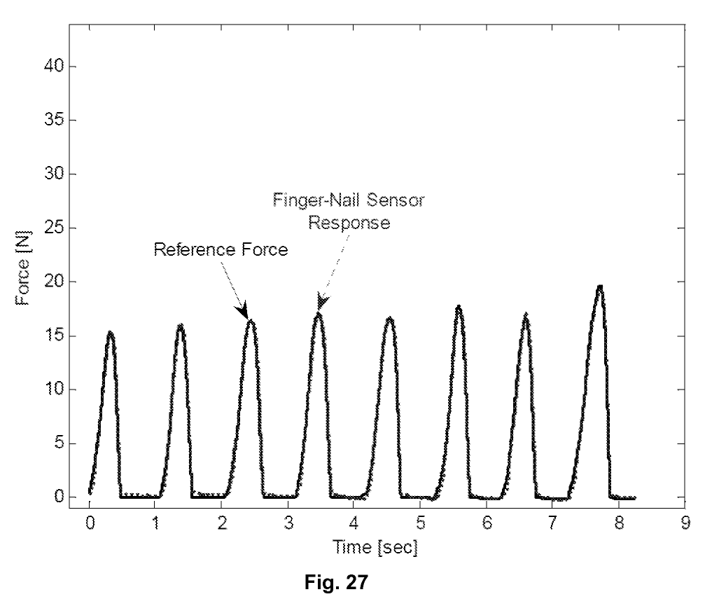

The sensor response of the fingernail tactile sensor 14 can be different from that of the finger pad tactile sensor 14. This is because a FSR is sensitive not only to the contact area, but also to sensor attachment or loading condition. Therefore, if there is a variance in device assembly, calibration has to be repeated. In our case, the artificial nail-tip attachment condition with the fixing adhesive can vary from assembly-to-assembly, resulting in different responses (FIGS. 24-27; compared with the finger-pad sensor's case in FIGS. 19-22). The fingernail tactile sensor calibration was used for the fingernail interactions, such as point-contact input, roughness or texture recognition by nail-scratching.

TABLE 7
Curve fit parameters for the finger-nail
tactile sensor (Voltage vs. Force).

| Break Point | 0.1448 [V], 4.3965 [N] | |
|---|---|---|
| Range | Low Force Range | Normal-High Force Range |
| | (<=4.3965 [N]) | (>4.3965 [N]) |
| Fitting Type | Linear | Exponential |
| Equation | V = P₁*F + P₂ | V = A*Exp(B*F) + |
| | | C*Exp(D*F) |
| Coefficients | P₁ = 0.03446 | A = 7.411 |
| (with 95% | (0.03412, 0.0348) | (6.868, 7.954) |
| confidence bounds): | P₂ = −0.006679 | B = 0.002179 |
| | (−0.00711, −0.006248) | (−0.001204, 0.005562) |
| | | C = −17.4 |
| | | (−17.68, −17.13) |
| | | D = −0.1964 |
| | | (−0.2086, −0.1843) |
| Goodness of Fit | SSE: 1.168 | SSE: 200.2 |
| | R-square: 0.8814 | R-square: 0.9803 |
| | Adjusted R-square: | Adjusted R-square: |
| | 0.8813 | 0.9803 |
| | RMSE: 0.0148 | RMSE: 0.2622 |

TABLE 8
Curve fit parameters for the finger-nail
tactile sensor (Force vs. Voltage).

| Break Point | 4.6267 [N], 0.1719 [V], | |
|---|---|---|
| Range | Low Force Range | Normal/High Force Range |
| | (<=0.1719 [V]) | (>0.1719 [V]) |
| Fitting Type | Linear | Exponential |
| Equation | F = P₁*V + P₂ | F = A*Exp(B*V) + |
| | | C*Exp(D*V) |
| Coefficients | P₁ = 25.58 | A = 4.515 |
| (with 95% | (25.33, 25.83) | (4.452, 4.577) |
| confidence bounds): | P₂ = 0.2293 | B = 0.1399 |
| | (0.2182, 0.2405) | (0.1351, 0.1446) |
| | | C = 0.001936 |
| | | (0.001015, 0.002858) |
| | | D = 1.11 |
| | | (1.049, 1.17) |
| Goodness of Fit | SSE: 867.3 | SSE: 624.2 |
| | R-square: 0.8814 | R-square: 0.987 |
| | Adjusted R-square: | Adjusted R-square: |
| | 0.8813 | 0.987 |
| | RMSE: 0.4033 | RMSE: 0.4629 |

One of the goals of fingertip digitizing is to develop a machine assisted system that allows the user's finger motion and volatile tactile sensation to be recorded and retrieved for many human-computer interface applications. To achieve seamless mapping between human tactile and machine interface, a number of important issues should be addressed.

First, mapping should work in real-time in parallel with the user's own tactual task. This is especially important for exploratory tasks. Because of the biomechanical analysis with high frequency data, the recognition technology that was discussed in the previously is a computationally expensive process. For example, the method of material property recognition by tapping needs a 10 kHz sampling rate, which puts a lot of strain on the CPU. One can solve this difficulty by implementing parallel computing with a super computer. However, an alternative solution is possible with a common desktop.

Second, data representation should provide both a spatial and temporal context. This is because replication of haptic sensation is achieved by producing equivalent spatial (kinesthetic) and temporal cues. An example of this can be found in Tactile Cueing (Kahol, Tripathi, McDaniel, & Panchanathan, 2005). This is even more significant in a remote learning or training environment, where the learning performance largely depends on the follower's tracking error with respect to a leader's original motion. For example, to share haptic sensation in a remote situation (Sympathetic Haptics; Joshi & Kesavadas, 2003), the system should provide a leader's spatial and temporal cues effectively, so that the follower can have the same haptic stimuli by minimizing the tracking error.

Finally, the mapping system should be capable of providing an option for several levels of abstraction. Usually, haptic replication requires a higher-frequency bandwidth than that offered by traditional visual feedback. Consequently, a haptic interface in a multimodal system usually results in a bottleneck of computational resources. Therefore, the system should provide levels of abstraction to allow a high-frequency update loop in multimodal user interfaces.

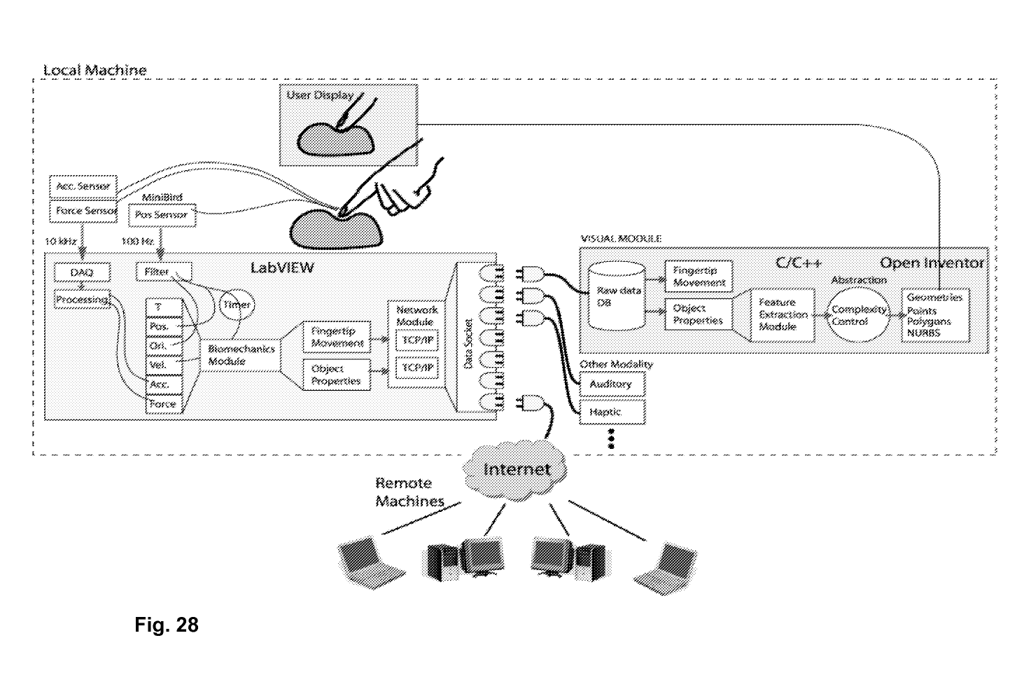

In designing the digitizing system architecture, the above factors were taken into consideration. To achieve a real-time interface, the computational resources were divided into several modules and integrated in a network environment (FIG. 28). For data acquisition, we devised a multithreaded data acquisition system using LabVIEW (NI, 2005; Necsulescu, 2002). The data stream of fingertip motion was separated from the intensive data processing required for object recognition. These two types of data use global reference time to enable the first user's actions to be played back by the second user during a training session.

The raw data (fingertip movement and object property data) were transmitted to a virtual environment module via TCP/IP networking. Since our network allows multi-connection, any additional module for other modality, such as auditory or haptic, can be easily plugged into the connection. Also, the haptic data can be broadcasted via the Internet. The data is stored in a raw signal database, and processed for an efficient user interface. For example, the raw data can be processed to form geometric features such as points, lines, polygons, and freeform representations, such as Non-Uniform Rational B-Spline (NURBS) curves or surfaces.

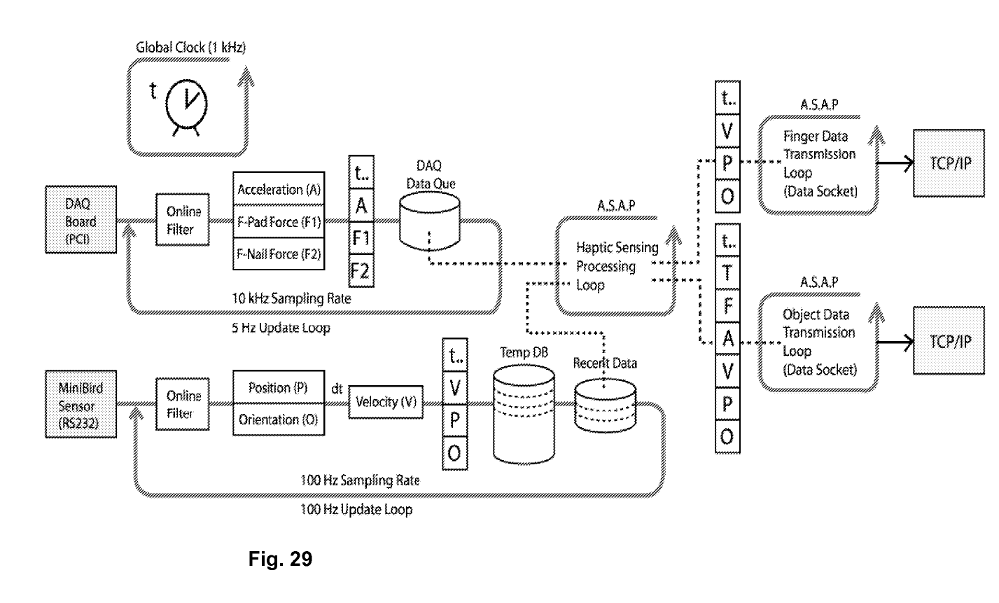

The sensors of the fingertip digitizer require data acquisition (DAQ) of different update rates. That is, the system needs a high acquisition rate for force and acceleration data (10 kHz), and lower sampling rate for the motion tracking device (100 Hz). A multi-rate DAQ was developed for this purpose. To achieve multi-rate data acquisition, six multi-threaded update loops were devised using timed-loops (LabVIEW, 2005; FIG. 29). Its data and status can be monitored in a console panel. For synchronization, a simple global clock was designed in a 1 kHz timed-loop.

Measurement of the fingertip motion is one of the important tasks for haptic sensing. A data acquisition algorithm was developed for MiniBird™. A number of algorithms, such as RS232 serial-port commands, online filters, and spatial transformation, were developed and implemented in a timed-loop with a 100 Hz update rate.

Because data acquisition of the force transducers and accelerometer is directly controlled by the timed-loops, a maximum update rate for these sensors is mostly limited to the DAQ board and CPU's processing speed. In our system, the update rate for these sensors was set to 10 kHz. This high acquisition rate was necessary for the measurement of tapping impact, which usually occurs in a very short time of 10 milliseconds. For data processing, the update frequency was set to 5 Hz (duration of 200 ms), producing 2000 samples in each loop.

For describing the present invention, four types of tactual tasks (rubbing, palpating, tapping, and nail-scratching) are recognized by monitoring responses of the tactile sensors. The process starts with the easiest task of nail-scratching. That is, if the finger nail force sensor is being pressed, it is regarded as nail-scratching. The rubbing and palpation check comes next with simple threshold-based monitoring. Decision of impact tapping is the last procedure and requires a more complex decision-making processing. For impact tapping, the impact force is the first peak value; it should not be the maximum value because a case exists where the tissue impact is less than the succeeding low frequency finger press (Jindrich, 2003). To make sure this is impact tapping, the algorithm also checks the acceleration values.

The first case in the determination procedure to be checked was nail-scratching. This was carried out by monitoring the fingernail force sensor. Since there was a 100 ms of delay to get the updated data from the MiniBird, the processing loop had to wait for this before collecting the data. The roughness recognition, which is the haptic sensing for nail-scratching, can be achieved by analyzing two types of physical data: tactile sensing data (applied force and acceleration of vibration), and spatial data (stroke velocity and position).

The next cases to be checked were rubbing and palpation. These was determined by observing the samples from the finger-pad force sensor, and checking if there was a continuous signal, but not an impulsive signal. The recognition of the surface and heterogeneity, which is the haptic sense for rubbing and palpation, respectively, can be achieved by analyzing two types of physical data: tactile sensing data (rubbing or palpation force), and spatial data (position).

The determination of material property, achieved by tapping involved analyzing two types of physical data: tactile sensing data (impact force and acceleration), and spatial data (velocity and position).

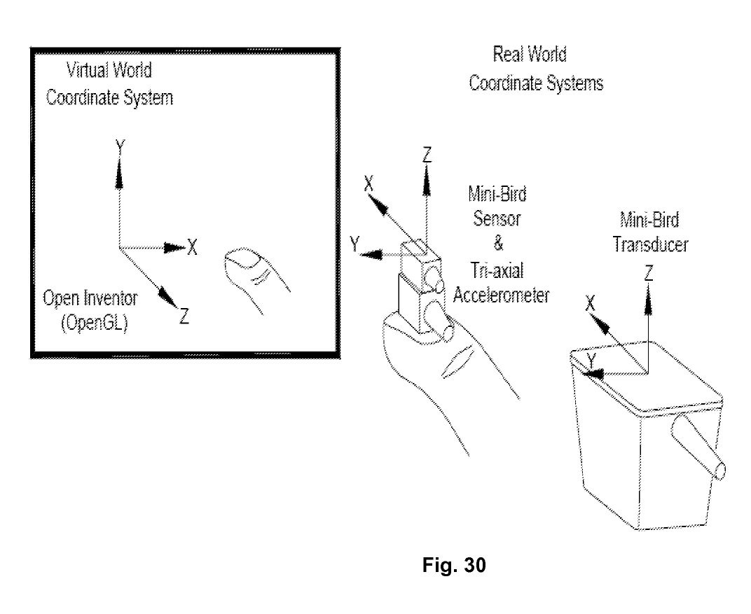

For more convenient use of the sensors, it was helpful to use several coordinate transformations. There are four coordinate systems in the fingertip digitizing system. They are motion tracker sensor, tracker transducer, tri-axial accelerometer, and virtual world coordinate systems (FIG. 30). Since the free-hand motion can produce a large rotation angle, we used quaternion matrices during the transformations (Shoemake, 1985; Akenine-Moeller, 2002).

Building a network-based system is one of the important challenges in VR and teleoperation. Networked VR provides on-line remote access, communication, and collaboration (multi-user environment). It is also beneficial to have an off-line user with distributed computational resources interfacing with each other (multi-device environment). This is especially true for a multi-modal sensory enhancement system. However, there are many difficulties in implementing such a system; work performance by a network-based system can be ultimately unstable and unreliable due to many interrupting factors, such as transmission delay, unstable network condition, and poor treatment of data processing. Many problems in devising a real-time and multimodal environment, such as visual, auditory, and haptics, had to be overcome.

For the networking of the fingertip digitizing system, a multi-threaded system may be developed using high update-frequency timed-loops and the DataSocket, which is a TCP/IP-based network interface in LabVIEW. The two types of data (fingertip motion and object property data) were designed to be transmitted separately for an efficient and convenient transmission handling. For each data type, data renewal was always checked in a 1 kHz timed-loop, and sent to the client as soon as the new data arrived in the memory queue.

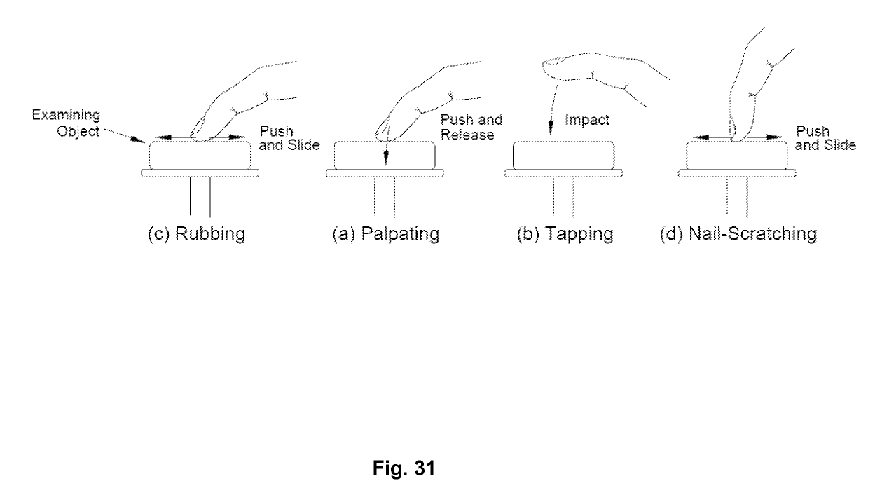

The recognition of object properties by active touch, fingertip characteristics, is now discussed. The human finger plays an important role in recognition of object properties, such as shape, size, weight, temperature, hardness, and roughness. It is an essential medium that is capable of adapting to a wide dynamic range of exploratory activities (Lederman & Klatzky, 1996). However, the versatility of the finger is actually a product of its complex structure, which also produces distorted signals in fingertip digitizing. This section presents an aspect of the invention related to recognition methodologies with the resultant signal of active tactile activities. The primary goal is to prepare the parameters of object properties that will be mapped into a three-dimensional virtual space. We will first discuss the characteristics of the fingertip, which is the main cause of the distorted signal. The rest of the sections deal with the four specific patterns of tactile activities—rubbing, palpating, tapping, and nail-scratching (FIG. 31). In particular, we will put an emphasis on the fingertip active tapping for recognition of material property, which is a novel approach to the digitization of inner-surface property.

In the present invention, the complex structure of the fingertip has been simplified to two major elements: fingertip tissue and joint impedance. Though considerably simplified, there are many issues involved in each.

Unlike industrial elastic materials, the force response of a human tissue is not linear to deformation. It is non-linear and viscoelastic, and involves creep and relaxation. To characterize such behavior, a dynamic system that consists of mechanical elements (such as mass, damper, and spring) can be devised. The three basic mechanical models for the tissue behavior are: the Maxwell body, Voigt body, and Kelvin body. However, there exist limitations with these models, and assumption and modifications are usually needed in practice. For example, a single Kelvin body is not enough to characterize the human organ or fingertip (Srinivasan, 1991), so a multiple sequence of the body is usually needed. One of the solutions to this inconvenience is Fung's quasi-linear viscoelastic tissue model (1993). This model doesn't adopt a set of mechanical elements. Instead, it consists of the two mathematical components, which are an elastic response and a relaxation function. The history of the stress response, called relaxation function is assumed to be:

Error! Objects Cannot be Created from Editing Field Codes,

(Eq. 1)

Where, G(t) is a normalized function of time called the reduced relaxation function, and Te(λ) is a function of deformation λ alone called the elastic response. Assuming that the stress response to an infinitesimal change in deformation δλ(τ), superposed on a specimen in a state of deformation λ at an instant of time τ, is, for t>τ:

$$G ( t - τ ) \frac{\partial {T}^{e} [ λ ( τ ) ]}{\partial λ} δ λ ( τ ) , \qquad ( Eq . 2 )$$

Applying superposition principle, we have the stress response:

$$T ( t ) = {\int }_{- ∞}^{t} G ( t - τ ) \frac{\partial {T}^{e} [ λ ( τ ) ]}{\partial λ} \frac{\partial λ ( τ )}{\partial τ} d τ , \qquad ( Eq . 3 )$$

With some assumptions (Fung, 1993), we have:

$$T ( t ) = {T}^{e} [ λ ( τ ) ] + {\int }_{0}^{t} {T}^{e} [ λ ( t - τ ) ] \frac{\partial G ( τ )}{\partial τ} d τ . \qquad ( Eq . 4 )$$

In practice, there can be the situation where ∂λ=0, causing Eq. 3 to be undefined. In this case, the equation can be approximated as:

$$T ( t ) = {\int }_{- ∞}^{t} G ( t - τ ) \frac{\partial {T}^{e} [ λ ( τ ) ]}{\partial τ} d τ . \qquad ( Eq . 5 )$$

The elastic response and the reduced relaxation function are modeled as simple exponential functions. For instance, for the elastic response Te, Pawluk and Howe (1999) modeled as:

$${T}^{e} ( λ ) = \frac{b}{m} [ {e}^{m \cdot λ} - 1 ] , \qquad ( Eq . 6 )$$

Where, m is the non-linear stiffness coefficient, and b is the non-linear scaling coefficient. For reduced relaxation response G(t), Jindrich et al. (2003) modeled as:

G(t)=c₀+c₁e^{-vt}. (Eq. 7)

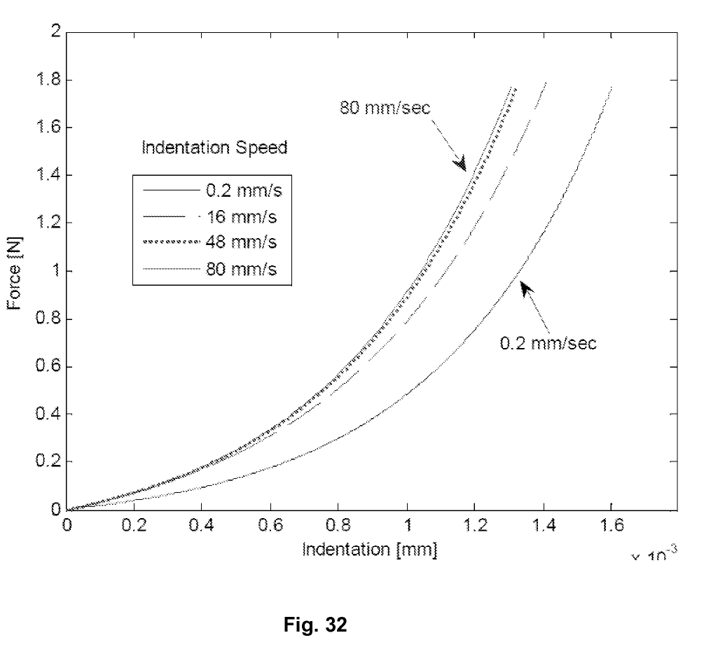

The tissue behavior to a ramp indentation is shown in FIG. 32.

It should be noted that the tissue's viscoelastic behavior discussed above varies not only across a group of population, but also within a single participant. The fingertip tissue parameters (m, b, v, c0, and c1) can also vary by grip and touch conditions. Other contributors of the variation in force response include muscle strength (Jindrich et al., 2003), and loading rate (Serina, Morte, & Rempel, 1997; Wu, Dong, Smutz, & Schopper, 2003).

The fingertip impedance is an important issue in biomechanics and haptics research since it affects accurate measurement and control. The fingertip impedance can be modeled as a lumped mass-spring-damper system (Hajian & Howe, 1997; Fu & Oliver, 2005). As a more refined model, each finger joint's dynamic behaviors have been investigated considering finger posture during tapping (Jindrich, Balakrish-nan, & Dennerlein, 2004). In the present invention, we adopted Hajian and Howe's lumped model. This is because it is not only convenient to characterize, but also useful for contact of both the extension and abduction of the finger. The model assumes the fingertip impedance to be only at the contact point, so that it can be characterized by the second-order dynamic equation:

mₑ\ddot{x}+bₑ\dot{x}+kₑx=F. (Eq. 8)

where, mₑ represents the effective point mass, be the viscous damping, kₑ the stiffness and response force F. In fact, Eq. 8 suggest that the parameters (mₑ, bₑ, and kₑ) vary according to the applied force to the fingertip. From these parameters, the damping ratio can be defined by:

$$ζ = \frac{{b}_{e}}{2 \sqrt{{m}_{e} {k}_{e}}} . \qquad ( Eq . 9 )$$

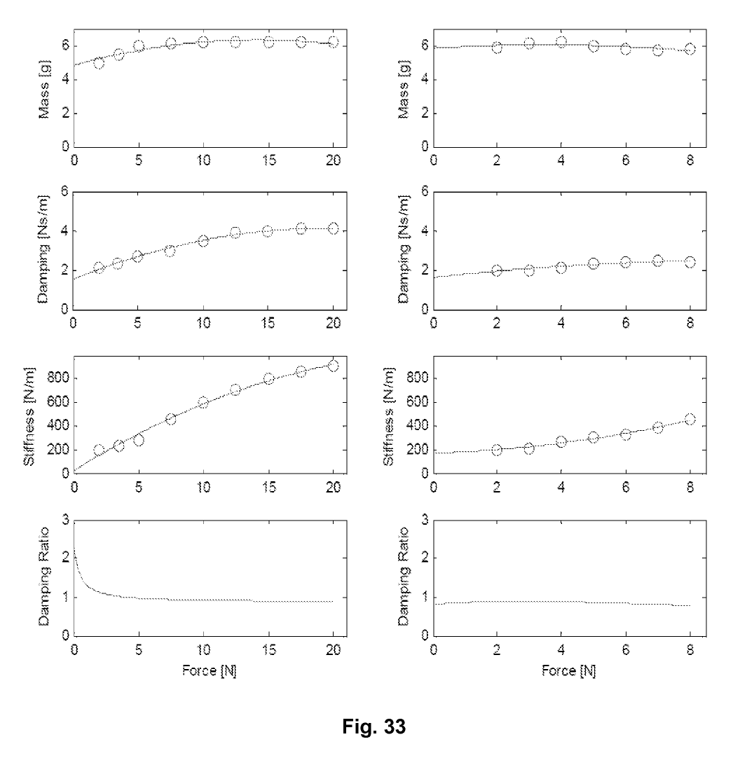

For convenience, we took the median values of Hajian and Howe's results. The sample values taken were processed to form a set of quadratic equations by least-square fit (FIG. 33 and Table 9). These equations characterizing the fingertip impedance were later used for active touch models.

TABLE 9
The least-square fit parameters for fingertip impedance.

| | Force Type | | | | | |
|---|---|---|---|---|---|---|
| | Extension | | | Abduction | | |
| | Fitting Eq. | | | | | |
| | f(x) = P₁ * x2 + | | | | | |
| | P₂ * x + P₃ | | | f(x) = P₁ * x2 + P₂ * x + P₃ | | |
| Parameter | P₁ | P₂ | P₃ | P₁ | P₂ | P₃ |
| Mass | −0.0075 | 0.2132 | 4.8000 | −0.0179 | 0.1250 | 5.8000 |
| Damping | −0.0068 | 0.2668 | 1.5127 | −0.0083 | 0.1726 | 1.6214 |
| Stiffness | −1.1438 | 67.4363 | 23.1312 | 3.3333 | 7.3810 | 170.7143 |

Surface geometry related to rubbing is now discussed. The construction of surface geometry is one of the main tasks in robotics research (Howe, 1993; Howe & Cutkosky, 1994; Okamura, Turner, & Cutkosky, 1997; Okamura, Costa, Turner, Richard, & Cutkosky, 1999; Liu & Hasegawa, 2001). In the present invention, the major role of rubbing is to get the surface geometry of an object. Having surface information is essential not only for constructing an object's overall shape, but also for the calculation of its stiffness. In fact, this type of contact was the sole interaction in the previous studies of fingertip digitizing (Mayrose, 2000; Kamerkar, 2004; Smalley, 2004; Mehta, 2005). However, finger tissue deformation was not considered, hence the interaction had inherent inaccuracy. We considered tissue deformation with Fung's non-linear viscoelastic model. In implementation, we defined rubbing as the interaction between two objects with a large difference in stiffness. This can be a situation where either an object's stiffness is very high, or a finger's pressing force is relatively light. Otherwise, if the object's deformation was considerable, it was classified as palpation.

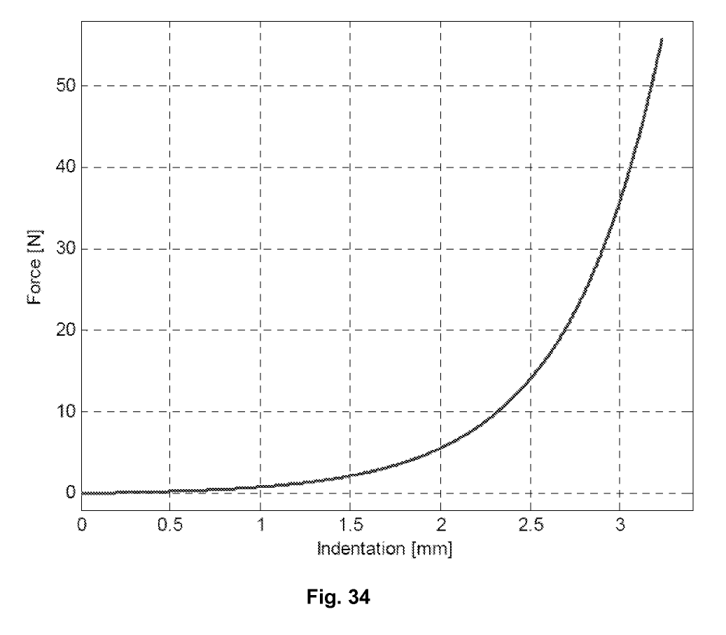

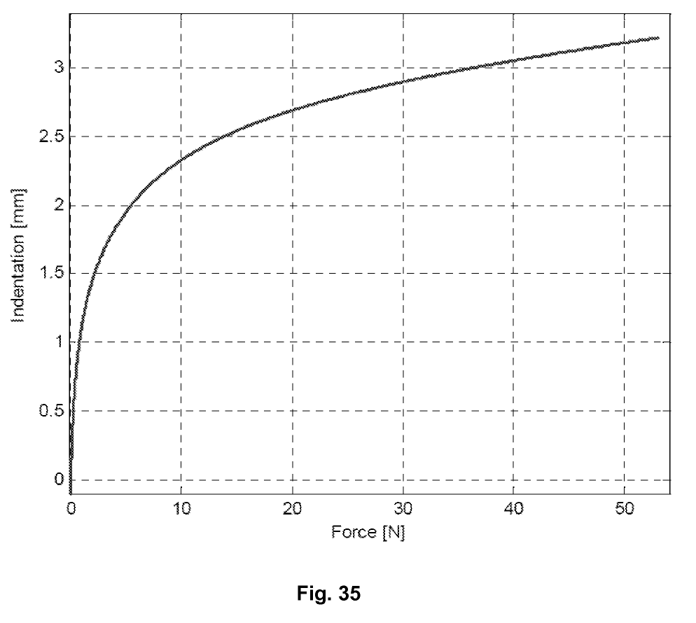

In applying Fung's tissue model, however, we didn't use his original equation directly. This is because it is a complex equation that involves integration and differentiation, so the direct application is a serious computational burden for real-time run. Furthermore, the model's independent variable (or input) is deformation, and the dependant variable (output) is response force. This is often the opposite case of tactile sensing, where the main input is response force. For this, we converted the simulated result of tissue indentation to rational equations using a least square fit (FIGS. 34-35; Tables 10-11). It should be noted that another contributor involved is indentation speed. In our experiment, it was assumed to be 16 mm/s.

TABLE 10
Curve-fit parameters for tissue indentation (Force vs. Indentation).

| | |
|---|---|
| Fitting Type | Rational |
| Equation | f(x) = (P₁*x³ + P₂*x² + P₃*x + P₄)/ |
| | (x² + Q₁*x + Q₂) |
| Coefficients | P₁ = 2.681 (2.652, 2.711) |
| (with 95% | P₂ = −1.142 (−1.21, −1.075) |
| confidence bounds) | P₃ = 7.611 (7.531, 7.691) |
| | P₄ = −0.2971 (−0.3175, −0.2767) |
| | Q₁ = −8.443 (−8.452, −8.433) |
| | Q₂ = 18.690 (18.65, 18.73) |
| Goodness of Fit | SSE: 0.0687 |
| | R-square: 1 |
| | Adjusted R-square: 1 |
| | RMSE: 0.005868 |

TABLE 11
Curve-fit parameters for tissue indentation (Indentation vs. Force).

| | |
|---|---|
| Fitting Type | Rational |
| Equation | f(x) = (P₁*x³ + P₂*x² + P₃*x + P₄)/ |
| | (x² + Q₁*x + Q₂) |
| Coefficients | P₁ = 0.008386 (0.008289, 0.008483) |
| (with 95% | P₂ = 3.044 (3.037, 3.05) |
| confidence bounds) | P₃ = 10.57 (10.4, 10.75) |
| | P₄ = 0.04899 (0.04506, 0.05293) |
| | Q₁ = 7.627 (7.537, 7.717) |
| | Q₂ = 3.596 (3.527, 3.664) |
| Goodness of Fit | SSE: 0.0379 |
| | R-square: 1 |
| | Adjusted R-square: 1 |
| | RMSE: 0.004359 |

A few notes on limitations of the rubbing interface are relevant here. First, this interface is limited by the curvature of the fingertip. It is not effective for digitizing the sharp edges or small openings. Second, the force response of the tactile sensor is sensitive to contact condition. Therefore, the user's finger posture should be as stable as possible. Lastly, the performance of the interface is often affected by surface condition, especially by friction. Both the object surface and tissue surface should help the smooth motion of the fingertip during rubbing. In particular, sweat may be a major factor if a large portion of the hand is enclosed by a protective cod or glove.

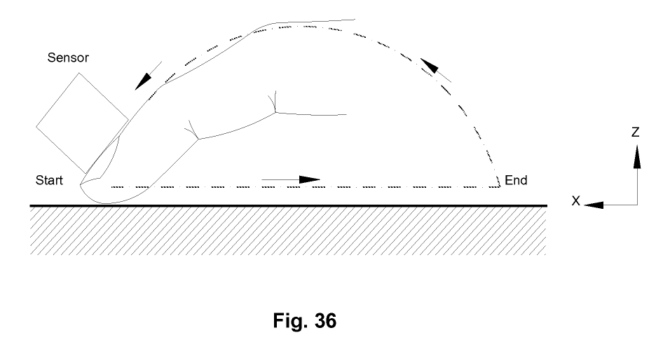

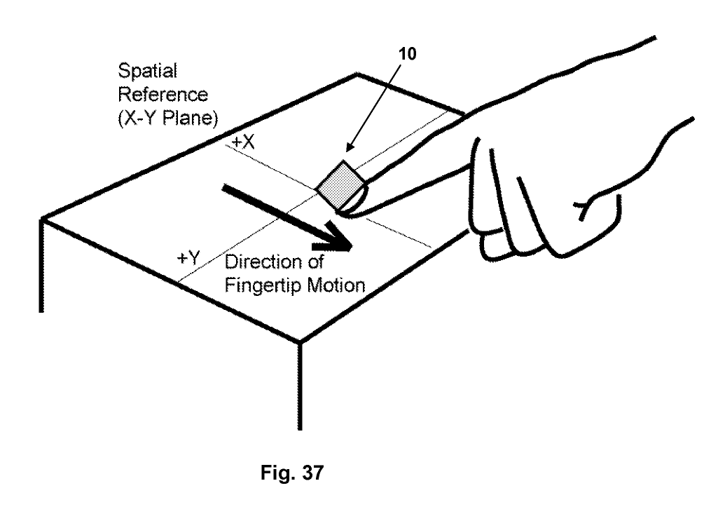

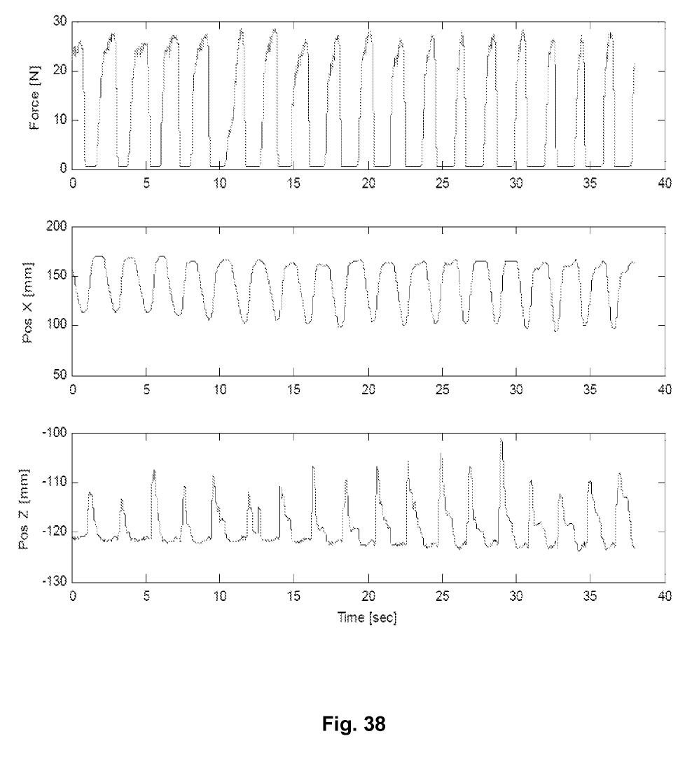

To verify the effect of tissue deformation, we carried out an experiment to recognize a plane surface. The purpose of this test was to observe the fingertip response during rubbing, and to measure the Fingertip Digitizer's 3D sensing accuracy. In this experiment, we set a path for the fingertip to follow (FIG. 36). This was to minimize the tactile sensor's contact noise and unstable loading condition. In a preliminary test, it was observed that the fingertip's pulling motion (moving negative X direction) gave more stable force response than the pushing motion which was very sensitive to friction. In practice, a line was drawn on a plane, and the participant repeated a rubbing motion along it (FIG. 37). An experienced user was selected in this experiment and the measurement is shown in FIG. 38.

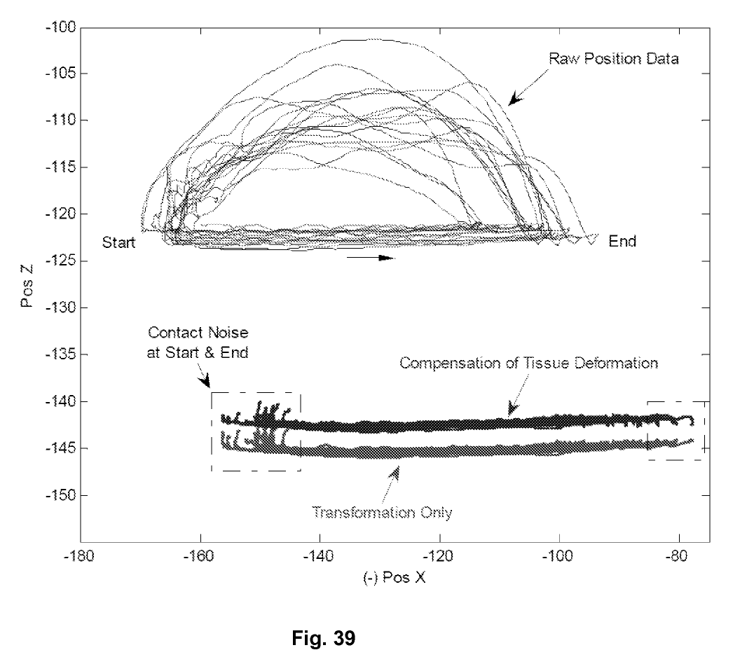

The result of the plane recognition test is shown in (FIG. 39). In our experiment, the motion tracker's position data was transformed to the actual position of the contact point because of the positional offset between them (27.0 mm). The amount of tissue deformation was calculated based on the tactile force responses, and then subtracted from the transformed data for compensation. The difference between the transformed line and the final line was 2.8 mm, both with an error range of 0.8 mm (approximate values). As shown in FIG. 39, despite the force threshold, there still were traces outside the straight line, especially near the start and end points. This is due to contact noise caused by the sensor's attachment condition and the fingertip's loading condition.

Heterogeneity related to palpation is now discussed. In a broad sense, palpation refers to any tactual activity carried out to examine an object being touched. The palpation's force response is of low speed and low frequency. For example, common palpation speed with soft objects is less than 2 Hz (Chen & Srinivasan, 1998). Palpation's main roles for tactile sensing are (1) to recognize static stiffness at a single spot, and (2) to recognize heterogeneity, e.g. a tumor or gland (Wellman & Howe, 1999). In practice, this can be implemented with a set of force and position sensors (Mayrose, 2000).

If an object is modeled as a perfect linear spring, it requires a single, or few pair, of position and force responses. The only prerequisite here is the recognition of a surface boundary to obtain the amount of deformation. For a nonlinear stiffness object, an array of force and deformation data must be recorded over time to form a whole picture of non-linear behavior. The limitation of this method is the palpation's low-speed input, thus it doesn't effectively produce a high-frequency damping response in soft materials. For both cases (either static or dynamic sensing), the tactile sensor at the finger-pad does not produce the true elastic response of an object. This is because the sensor lies in-between the fingertip and object, so that its response always includes not only the object response, but also the fingertip tissue's viscoelastic characteristics, such as creep and relaxation. The fingertip's interference not only causes difficulties in tactile sensing, but also affects low sensing accuracy. In this section, a dynamic palpation model and its simulation are presented. An experiment for determining heterogeneity is then demonstrated.

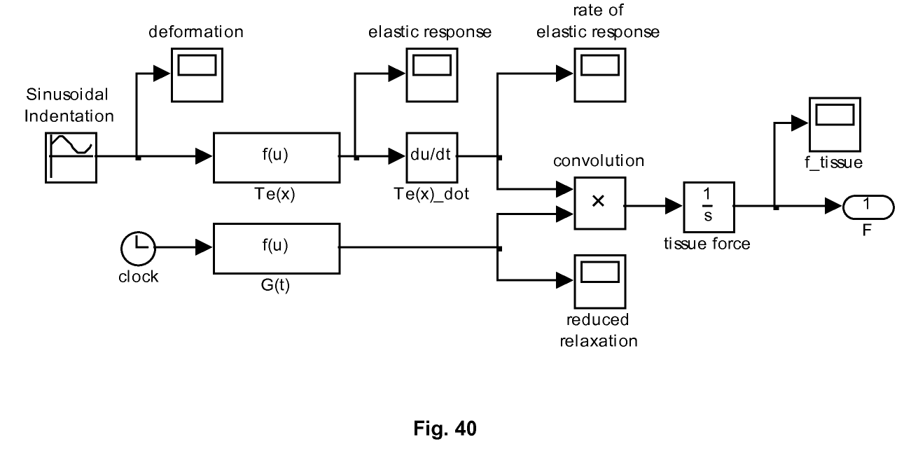

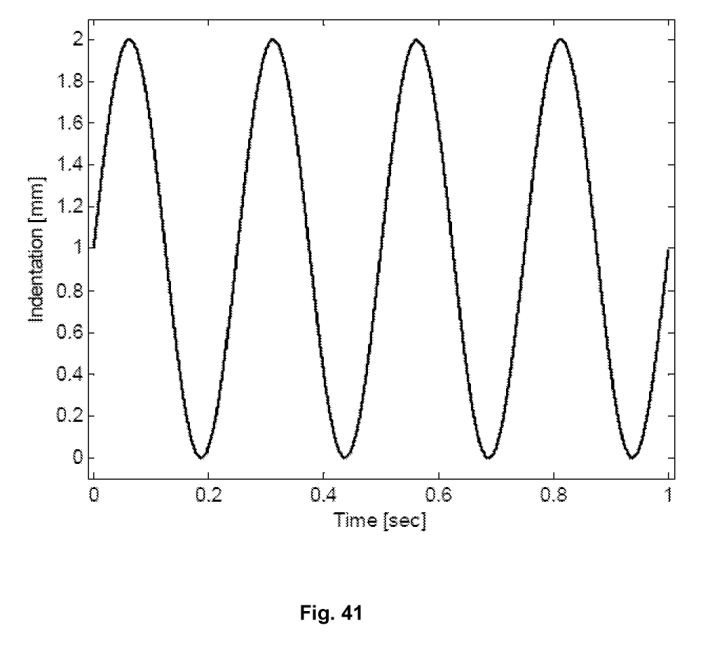

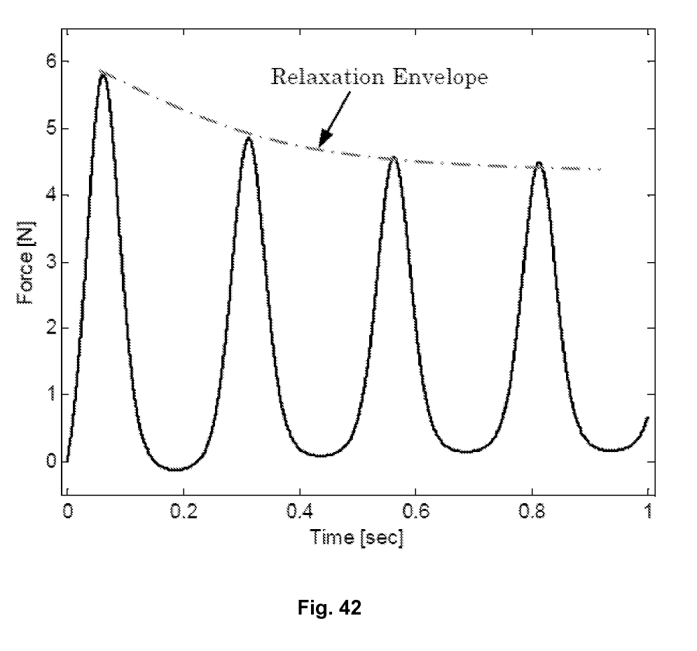

Fung's tissue model described earlier was implemented using MATLAB and Simulink (FIG. 40). With this model, we simulated an indentation (or passive touch) experiment which was previously implemented by Pawluk and Howe (FIGS. 41-42). In this simulation, parameters were set to demonstrate the tissue's viscoelastic behaviors, such as the relaxation envelope.

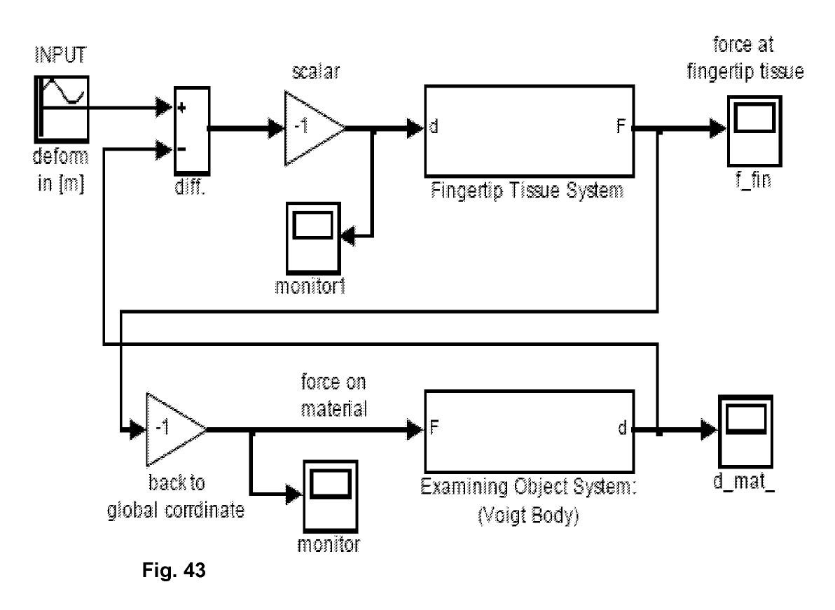

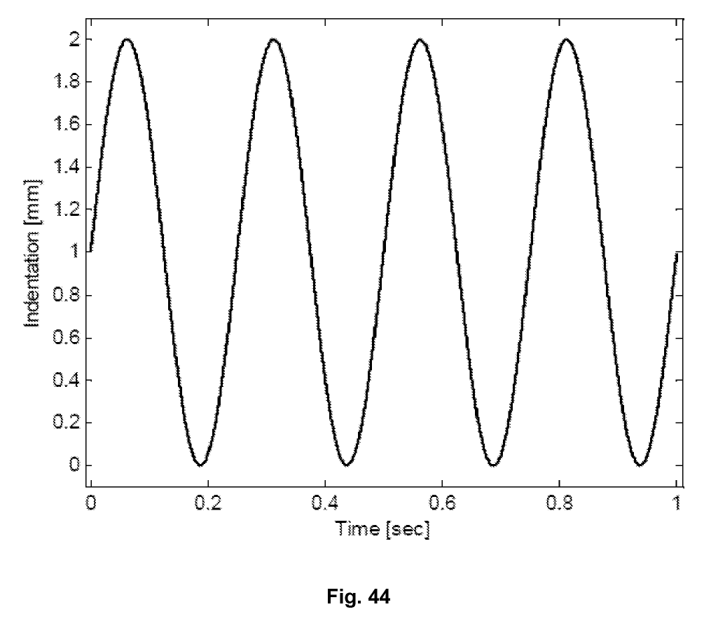

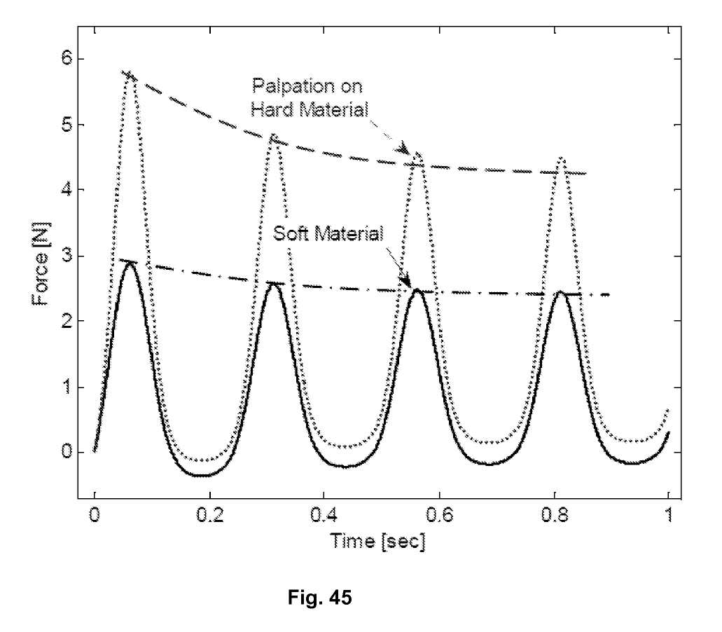

A dynamic palpation model on a soft object is shown in FIG. 43. In this model, the examining object was modeled as a Voigt body, which is a parallel arrangement of the spring and damper. For a comparison with the previous case, other simulation conditions, such as input and fingertip parameters, remain the same as the case of hard-surface palpation. The simulation result for the tactile sensor's force response is shown in FIGS. 44-45.

It was observed that the object's softness resulted in a lower range of force response. It was also observed that the relaxation envelope is not as apparent as in the case of the hard surface palpation. This is perhaps due to the overall lower force range, or possibly to the energy dissipation by the soft object's damping effect. In fact, Pawluk and Howe's (1999) fingertip indentation experiment can be considered as an active but slow touch on a stiff surface, which is the same situation as hard surface palpation. An important advantage of this case is that, in an ideal case, position measurement is not necessary for stiffness recognition because there are only two variables in the system (force and deformation), and they are assumed to be perfectly coherent (See Jindrich, 2003). However, with a soft material, both position (input) and force response (output) must be acquired to recognize unknown stiffness.

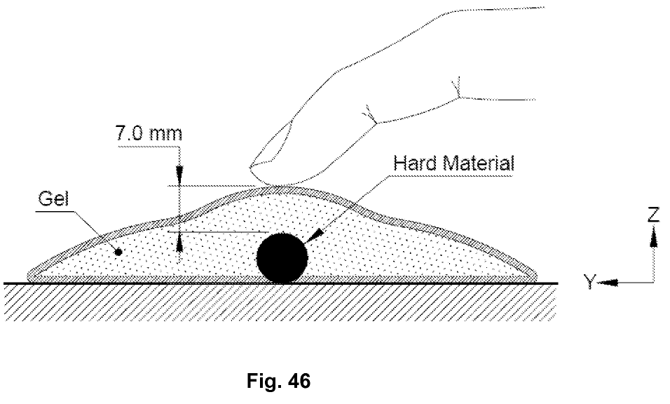

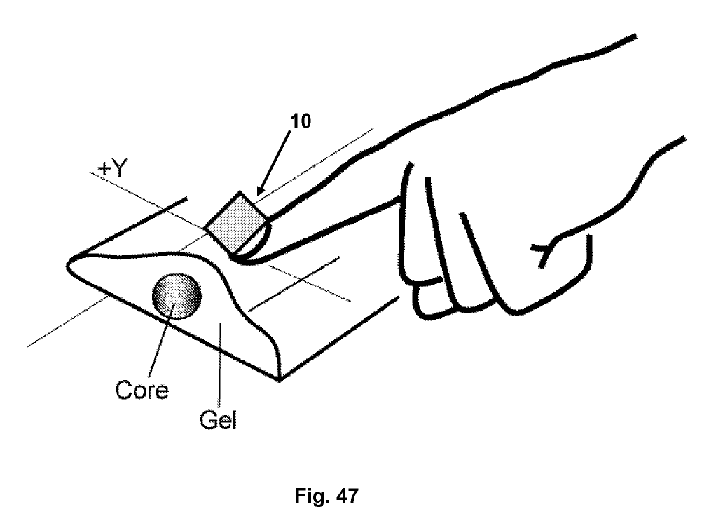

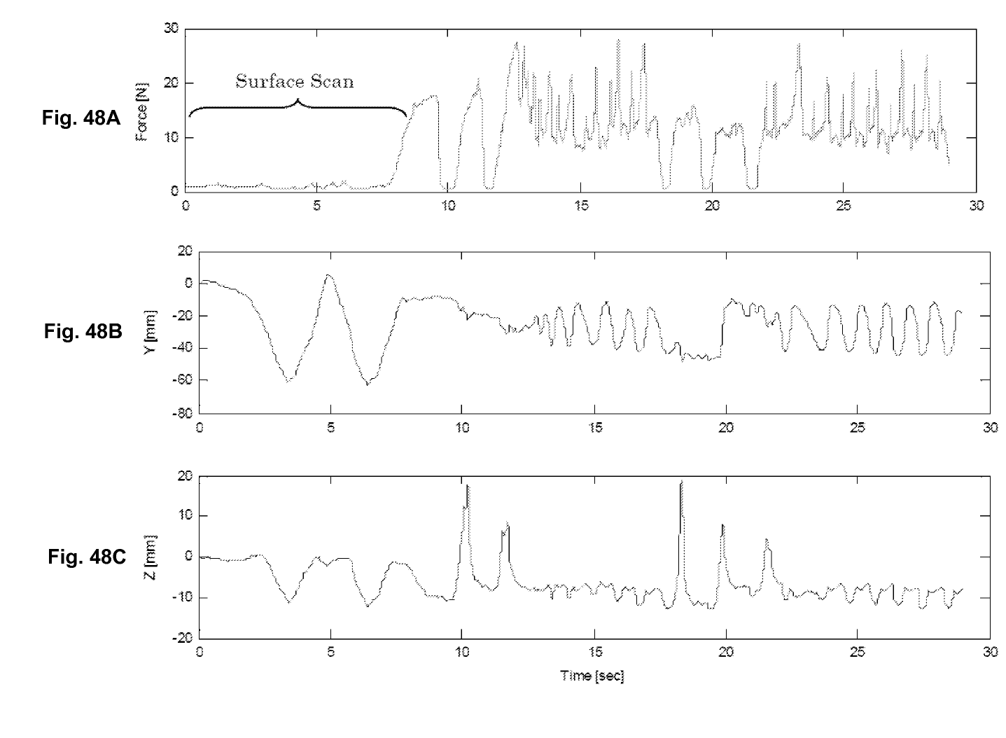

We also carried out a palpation test for haptic recognition of an embedded object (FIG. 46) using the fingertip digitizer (FIG. 47). The purpose of this test was to observe the fingertip response during palpation, and demonstrate the methodology of subsurface determination by force sorting (Smalley, 2004). An experienced user was selected in this experiment. The measurement is shown in FIGS. 48A-48C.

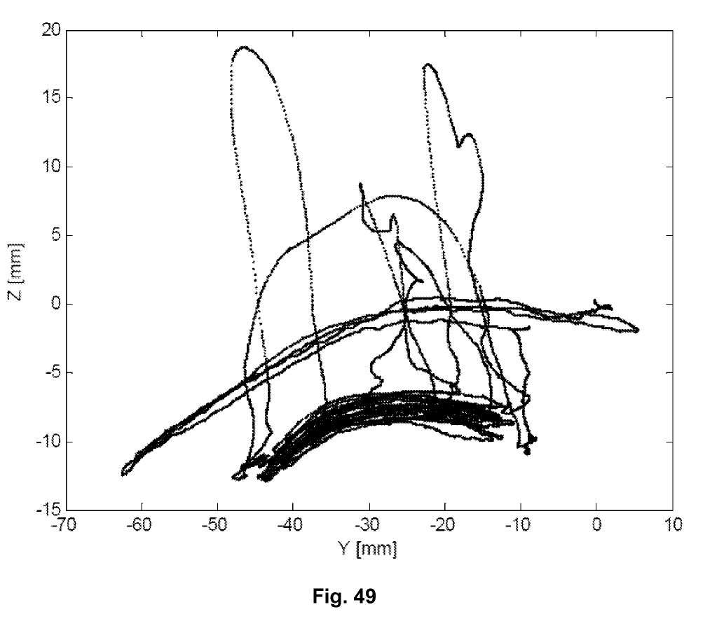

The measured surfaces—gel's outer surface and hard object's outer surface—are shown in FIG. 49-50. In this experiment, position data was filtered and classified with force threshold: 0.5 N (for soft gel) and 10 N (for hard object).

Material property related to tapping is now discussed. Direct finger-touch digitizing can provide an intuitive environment for tactile tasks. The advantage of this interface is that both man and machine share the haptic stimuli, so that overall work performance can be enhanced by two valuable resources: machine's digital power, and the human's instinctive exploratory capability. In previous studies, researchers attempted to acquire stiffness and surface geometry by palpation (Mayrose, 2000; Smalley, 2004). In the present research, we seek a new methodology for material property recognition by direct finger touch. In particular, we are interested in recognizing viscoelastic materials. Of the various patterns of tactual activities (Gibson, 1963; Lederman, Klatzky, and Pawluk, 1992), we decided tapping as an appropriate touch pattern. Due to the unique response obtained during impulsive tapping, we propose that material property recognition is possible (Okamura, Cutkosky, & Dennerlein, 1998; Okamura, Cutkosky, & Dennerlein, 2001). Tapping is often the means of diagnosis in many medical applications, such as the physician's use of a diagnostic hammer or the dermatologist's Ballistometer (Pugliese & Potts, 2002). Palpation, which is often considered a common diagnostic task, was deemed inappropriate for the purpose of material property recognition. This is because the tissue's relaxation rate is in the order of a millisecond, thus the motor control speed for finger pressure does not produce a reliable damping response. Also, fingertip tissue absorbs contact energy considerably, resulting in a weak and noisy response. Palpation is rather appropriate for examining the non-homogeneity in tissue, such as a tumor or foreign object embedded in a body. On the other hand, higher speed tapping was fast enough to produce the viscoelastic components in response: elastic factor (proportional to deformation), and damping factor (proportional to velocity).

However, as a tapping probe, the fingertip is a difficult system to handle. Attachment of a flexible tactile sensor on the fingertip inherently causes many issues in measuring accuracy; the joint impedance and viscoelastic behavior of the tissue produces distorted force response. Moreover, when the fingertip actively touches on an object, the response is different (Rempel, Dennerlein, & Morte, 1994) from that in the passive model (Gulati & Srinivasan, 1995). Consequently, these adverse effects often lead to machine's poor accuracy and the user's restricted hand motion in an exploratory task, which was the major problem in the previous studies. The aim of the present research is to develop an active, non-linear viscoelastic model to describe the whole process of active tapping on a few commonly used test materials. This model, of course, should include not only the behavior of the test material, but also that of the fingertip itself. Having such a methodology is significant for developing an intuitive and accurate fingertip digitizing interface, especially for the cases where the object being tapped is a soft or viscoelastic material, such as human skin or internal organs.

Active finger touch has been the topic of many haptics and biomechanical studies. This section discusses the issues that are important to the present research, and reviews the past studies. First of all, fingertip tissue's viscoelastic behavior—such as creep and relaxation—must be understood. In many previous studies, a series of Kelvin bodies have been used to simulate the tissue behavior. To avoid the inconvenience of dealing with such numerous bodies, Fung's non-linear viscoelastic model (Fung, 1993) can be employed. In a motorized, indent probe test, Pawluk and Howe (1999) confirmed the appropriateness of Fung's model for the fingertip tissue. Jinrich's ergonomic study also used the model in an investigation of force-deformation relationship during the light impact of keyboard strokes (Jindrich, Zhou, Becker, & Dennerlein, 2003). This study emphasized the differences between active and passive touch. Unlike the tissue behavior of the passive touch, which is the shape of an exponential function, the active touch response is more complex (FIG. 51).

Other contributors to variable tissue behavior include muscle strength (Jindrich et al., 2003), and loading rate (Serina et al., 1997; Wu et al., 2003). The finger's joint impedance also affects accurate measurement and device control. Hajian and Howe (1997) modeled a lumped mass-spring-damper system to characterize the index finger impedance at the point of contact. In supplement to their lumped model, Jindrich et al. further investigated dynamic behavior of finger joints considering the finger posture (Jindrich et al., 2004). Besides the tissue and joint system, the pattern of impact force generated is another important issue for force variation in tapping. Dennerlein et al. investigated neural control of finger force with a set of position, force, and EMG signals (Dennerlein, Morte, & Rempel, 1998). The study showed the role of extensors and flexors near the onset of contact. We considered these past studies and their results to develop an active tapping model.

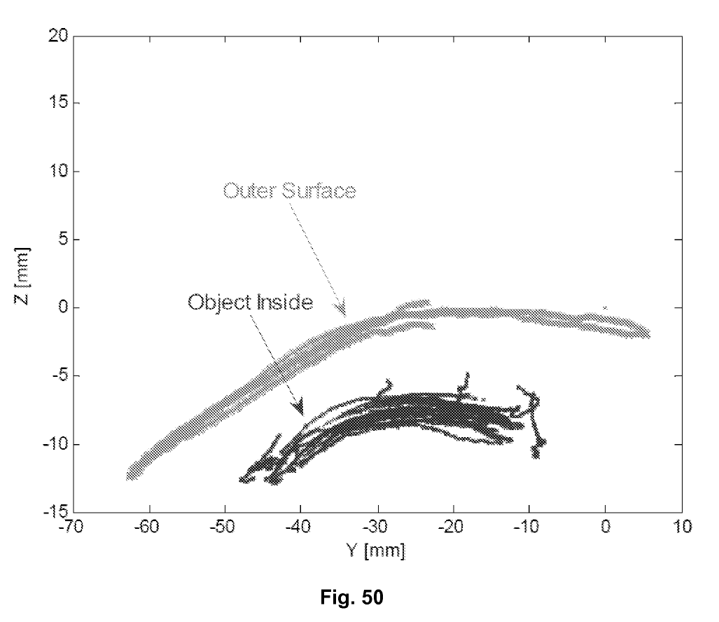

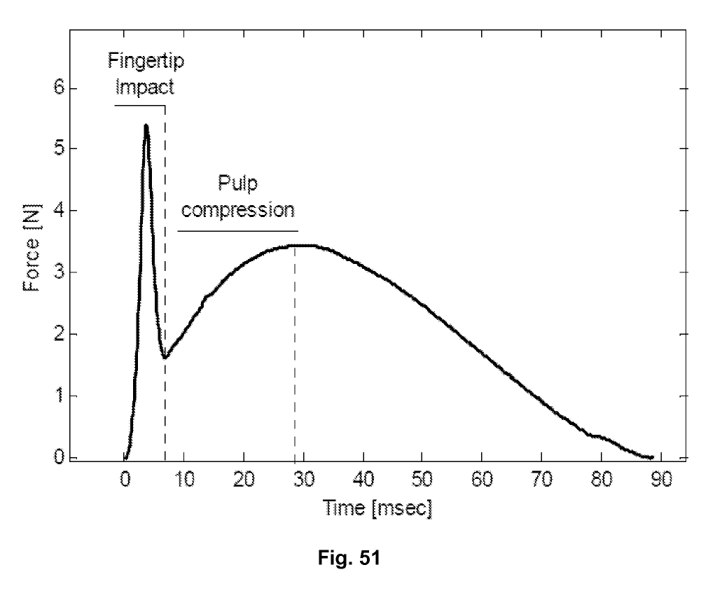

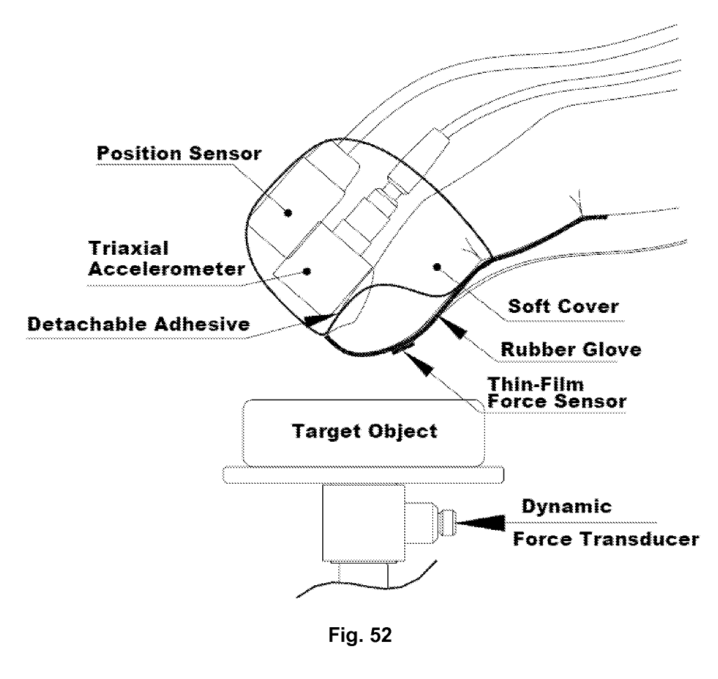

To measure the fingertip responses to impact tapping, we used the fingertip digitizer 10 and touch tester 30. The setup for the tapping test is shown in (FIG. 52).

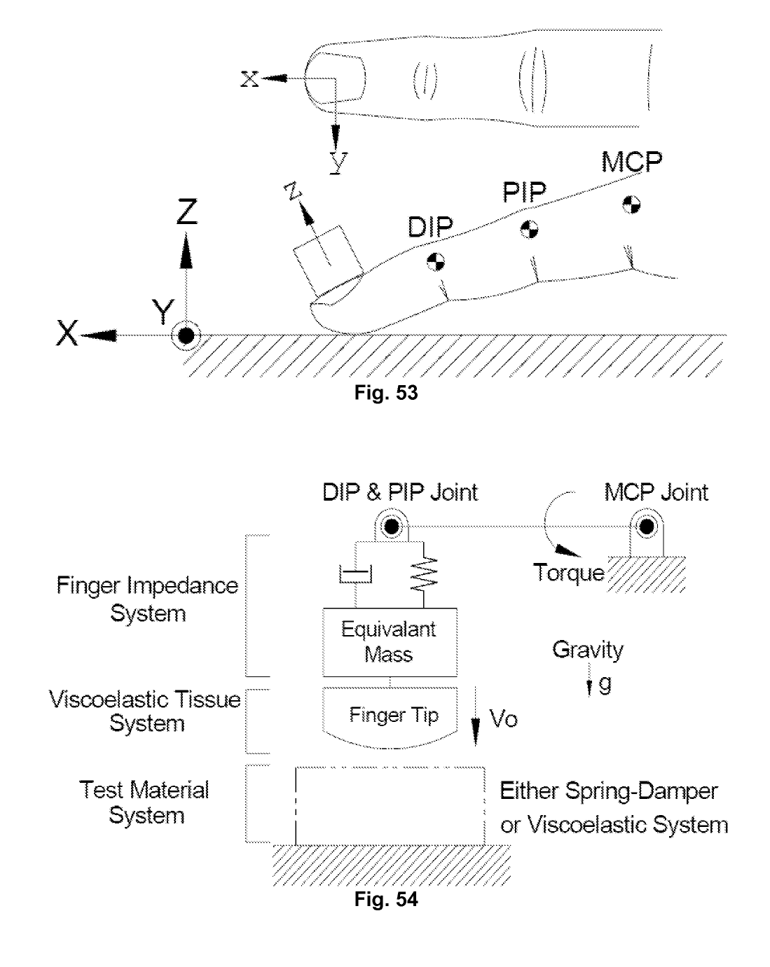

To describe each participant's active tapping behavior, finger posture was defined by a local and global coordinate systems (Griffin, 1990) as shown in FIG. 53. Because the main analysis only concerned the measurement of vertical (z) direction, acceleration values of local fingertip coordinate were transformed to the position tracker's global coordinate system to get the vertical component. Since there was a considerable difference in the data acquisition rates between the motion tracker and the force transducer-accelerometer (90 Hz and 10 kHz respectively), we developed software instrumentation in LabVIEW for multi-rate data acquisition. We calculated impact velocity and displacement by integrating acceleration since the motion tracker's temporal resolution could not cover the impact period (<5 ms).

A few assumptions were made for testing of the proposed methodology. This was done to avoid the variances in participant's active motor control, so that the measurement for analysis was reliable. First of all, participant's input was assumed to be two independent variables: initial impact velocity (v0) and pressing force (P). The input force was assumed to be a harmonic function. We also assumed that each participant's motor control was absent during the short contact period (<100 ms), therefore the responses were obtained only by the pre-determined input and the system characteristics.

To characterize the tapping mechanism, we modeled a compound dynamic system (FIG. 54). In this system, the index finger was modeled as a torque lever with the hinge at the metacarpophalangeal (MCP) joint. The model consisted of three subsystems: the finger joint impedance system, the fingertip tissue system, and the test object system. For the characteristics of fingertip impedance, we approximated Hajian and Howe's (1997) results of the lumped mass-spring-damper system. The fingertip impedance to response force follows the second-order dynamic equation:

mₑ\ddot{x}+bₑ\dot{x}+kₑx=F, (Eq. 10)

Each component-mass (mₑ), spring constant (kₑ), and damping coefficient (bₑ)—were assumed to have a quadratic behavior to response forces.

For the fingertip tissue characteristics, we modeled it as a Fung's quasi-linear viscoelastic model (1993) with a few modifications (Pawluk & Howe, 1999; Jindrich et al., 2003). The force response of the tissue was determined by:

$${F}_{0} ( t ) = {\int }_{- ∞}^{t} G ( t - τ ) \frac{\partial {T}^{e} [ x ( τ ) ]}{\partial τ} d τ , \qquad ( Eq . 11 )$$

Here, T^{e}(x) is the instantaneous force response:

$${T}^{e} ( x ) = \frac{b}{m} [ {e}^{m \cdot x} - 1 ] , \qquad ( Eq . 12 )$$

where, m is the non-linear stiffness coefficient, and b is the non-linear scaling coefficient. G(t) is the relaxation response of the tissue:

G(t)=c₀+c₁e^{-vt} (Eq. 13)

where, v is the relaxation time constant and c₀ and c₁ are the relaxation coefficients. For the test object system, we modeled a simple mechanical system using a combination of springs and dampers.

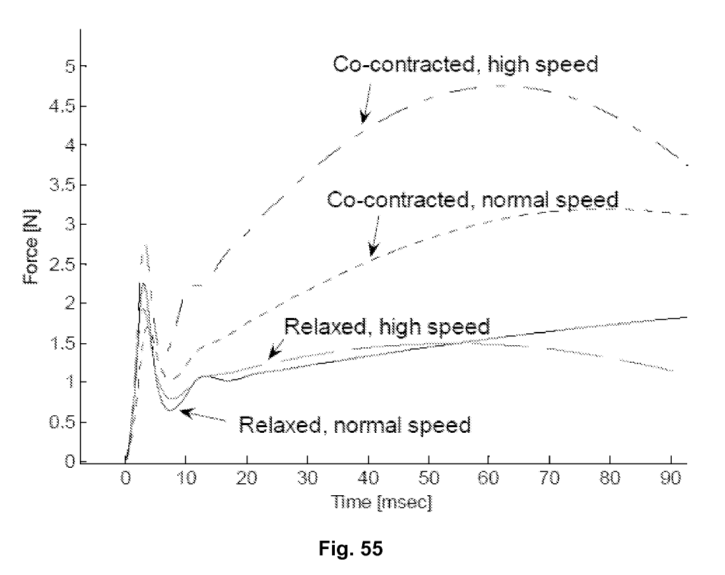

The simulation and optimization of our model was implemented using the programming interface of Simulink and MATLAB. For the verification of our model, we simulated the previous tapping experiment conducted by Jindrich et al. (2003). The non-linear viscoelastic parameters of their result were applied for four tapping conditions: relaxed-normal speed, relaxed-high speed, co-contract-normal speed, co-contract-high speed. Each participant's input pressure was approximated to a harmonic curve. The test material was assumed to be a stiff surface, which was the same tapping condition of their experiment. The simulated result is shown in FIG. 55. It showed a similarity to Jindrich's study for results in both shape and force measurement.

Because the model describes the participant's finger and tissue characteristics, it can be used for property recognition, comparing the input and the corresponding response. Therefore, a user's fingertip characteristics should be completed in a calibration task before each participant's tapping trial. For model fit of the participant's finger system, we developed an optimization program using a multidimensional unconstrained non-linear minimization (fminsearch in MATLAB). For the objective function to be minimized, we defined the percentage error:

$$Error = \frac{\sqrt{{\sum }_{t = 0}^{t = τ} {[ F ( t ) - {F}_{p} ( t ) ]}^{2}}}{\sqrt{{\sum }_{t = 0}^{t = τ} {F ( t )}^{2}}} \times 100 ( \% ) . \qquad ( Eq . 14 )$$

The initial estimate for the optimization process can be determined by Jindrich et al.'s method (2003). In a series of preliminary tests, their results worked well as initial values. We also found that the fingertip damping values of Hajian and Howe's result (1997) were too small for impact tapping. That is, it caused a large fluctuation right after impact. To overcome this difficulty, we defined a set of separate scaling parameters (mass; mf, damping; bf, stiffness: kf,) which were then multiplied to the quadratic curves of the lumped model of fingertip impedance. Once participant's fingertip system was fully characterized, another optimization process was implemented for evaluating the material property. To describe each object's material property, we used simple types of mechanical systems: a Voigt body (spring-damper system), and Kelvin body (also called standard linear solid) (Fung, 1993). In the experiment, we used a Voigt system with fixed damping to compare the elastic properties of different materials.

We conducted a series of human participant tests for active tapping. The purpose of this experiment was (1) to obtain measurements and observe participant's active tapping behavior, and (2) to confirm appropriateness of our model and methodology for material property recognition.

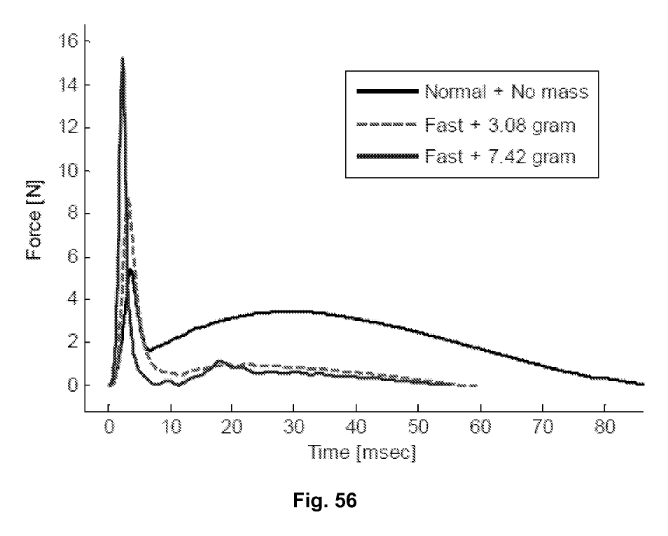

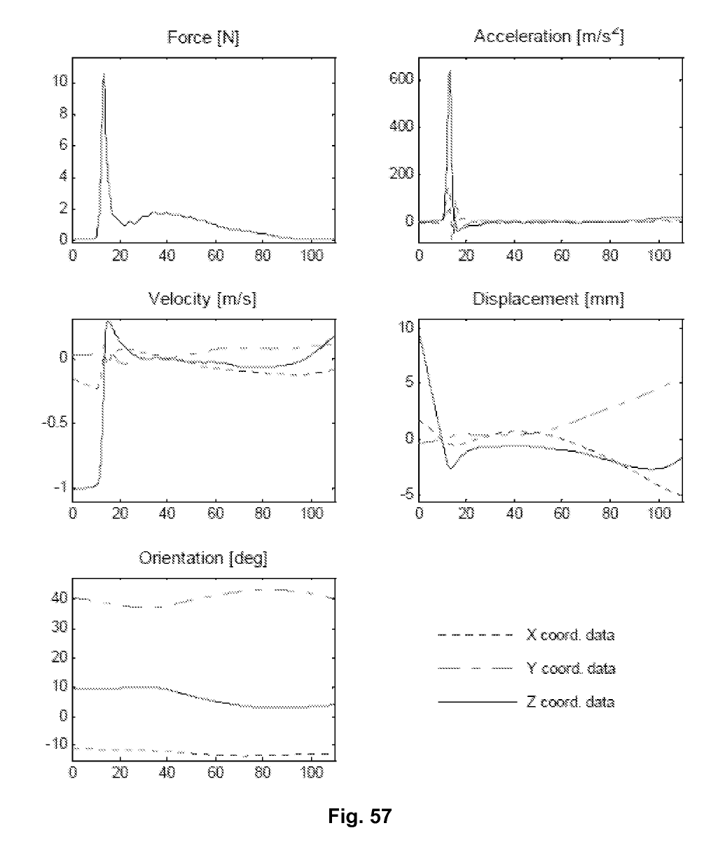

The task required each participant to tap the sensing plate (for fingertip parameters), and to then tap the materials attached to it (for property recognition). They were given two types of reference (visual and auditory) to minimize variances of tapping input; a scale of 65 mm height, and a 1 Hz beeping sound was provided. The participants were asked to tap 40 times. The data of the first 20 taps was neglected to accommodate the training process, and then the subsequent 20 taps were considered for data analysis. Despite the training, we observed considerable variances in stroke speed and finger pressure. This variance existed both in-between and within-subject data, therefore averaged data curves were not appropriate for analysis. For this reason, we consider one participant's results of near mean velocity (1.138 m/s, SD=0.087 m/s). The active tapping behavior with the Fingertip Digitizer was observed to be more extreme than the behavior with the bare-finger (compare FIG. 56 to FIG. 57). Unlike light tapping during keyboard typing, we observed a much higher range of impact force (up to 15 N for our case as opposed to 3 N for keyboard tapping). This is mainly due to the sensor attachment on the finger nail (a total equivalent mass of 23.5 g from an optimized result). Also, initial impact speed was regarded as another contributor (up to 1.2 m/s in our case, 0.7 m/s in keyboard typing). This is perhaps because the participant was directed to minimize the time the fingertip rested on the object surface to avoid finger motor control during the contact period. The measurements of a typical tapping trial on a hard surface are shown in FIG. 57. The participant's active tapping had a contact period of approximately 90 ms. There were drastic measurement changes during the impact period of 5 ms: maximum force of 10.6 N, maximum acceleration of 640 m/s2, a velocity change of 1.3 m/s, and displacement of 2.5 mm. In addition, we observed variations in orientation: 2˜8° of rolling range (about x-axis), 35˜45° of pitching (y) range, and 3˜10° of yawing (z) range.

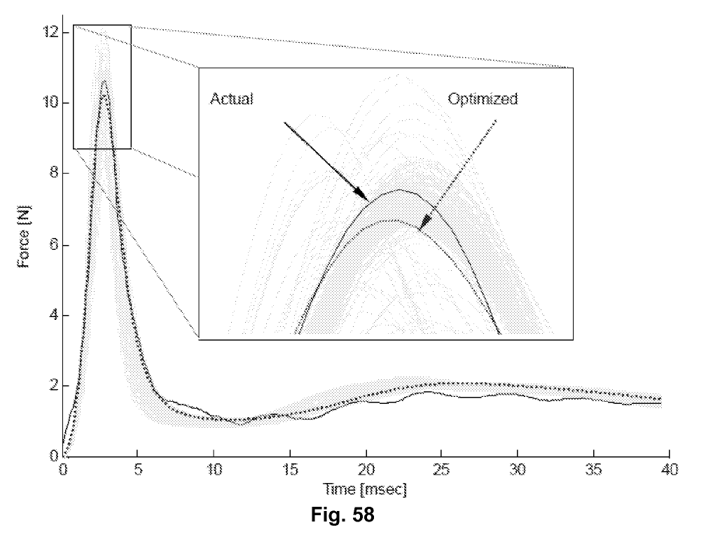

An optimized model fit was implemented with the acquired data. The first step was to estimate the parameters to describe the participant's fingertip characteristics. This was done by analyzing the force response. We used Jindrich et al.'s results as an initial estimate (2003). The optimized model fit result and the parameter values are shown in FIG. 58.

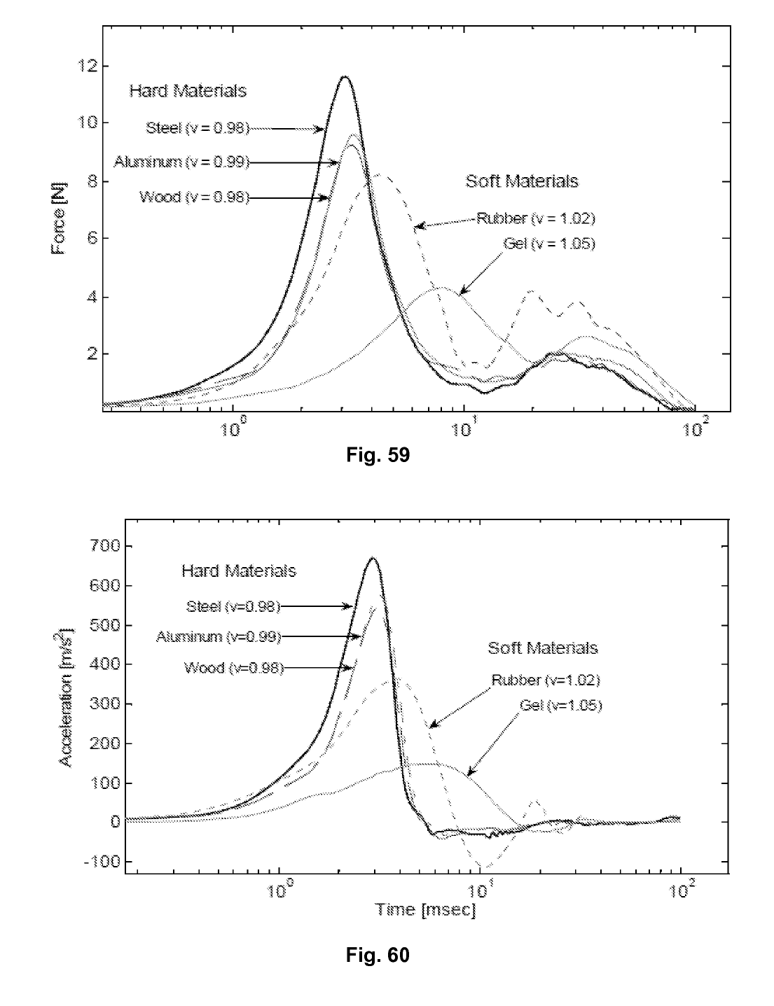

We also conducted a material recognition test. The goal of this experiment was to determine the material properties with common industrial materials: steel, aluminum, wood, and silicon rubber. In addition, a gel-type substance which is used for an arm-rest was tested (to simulate a biomaterial). The size of the specimens was 30 mm square with a thickness of 12 mm. The responses (force and acceleration) of the fingertip impact on these materials are shown in FIGS. 59-60 (note that it is shown in log scale for time). The hard materials show a steep and fast response, while the objects in the soft material group show a slow vibratory response. Acceleration responses can be observed during the impact period. However, they quickly disappear during the period of the finger pressure.

The optimization process for property determination was implemented with the acquired data. The objective function's minimization value during fitting error was defined in Eq. 14). The optimization's initial estimate was the approximated values with regard to the maximum forces and slopes at the beginning of impact. To avoid possible local maxima in the objective function, we implemented bottom-up search from a stiffness value of 100 N/m. For a better fitting accuracy, we avoided inclusion of minor information, such as noise in the later period of tapping. There-fore the data of 0˜50 ms was used for the analysis. The object was modeled as a Voigt body, with the damping coefficient fixed at 0.1 Ns/m. The results of the optimization are shown in Table 12 and FIGS. 61-62.

TABLE 12
Determined elasticity of test materials. In the parenthesis are the Young's
modulus' (E, in GPa) for reference.

| | Material (E: GPa) | | | | |
|---|---|---|---|---|---|
| | Steel | | | | |
| | (200) | AL (70) | Wood (20) | Rubber (0.1) | Gel (0.01) |
| k (N/m) | 1.8 × 10⁶ | 6.1 × 10⁴ | 5.6 × 10⁴ | 1.3 × 10⁴ | 2.4 × 10³ |
| Fitting | 12.1 | 15.1 | 13.6 | 19.1 | 22.4 |
| Error (%) | | | | | |

The active tapping model and analysis methodology was successful in differentiating the five materials. The determined stiffness showed a similar pattern to the material's elasticity (Young's modulus) in a relative scale. The proposed methodology may be useful for describing an object surface and interior characteristics, in conjunction with surface generation by conventional contact scanning. It can therefore be used for other modeling and haptic applications in industrial and medical applications, such as reverse engineering and organ palpation. For example, a teddy bear can be scanned to get 3D shape, as well as its tactile properties by a user's direct finger touch.

In our work, the recognition of material properties was possible with the user input and the response. One of the benefits of our tapping model is that the response need not be the response force. That is, unlike the conventional way of tactile sensing that ultimately depends on the contact force, our approach allows the system to determine the material property with acceleration, or even with displacement. Therefore, the user interface can avoid the cumbersome force sensor attachment on the finger pad, which usually blocks a user's own tactile sensation (Lederman & Klatzky, 2004; Asada & Mascaro, 2000).

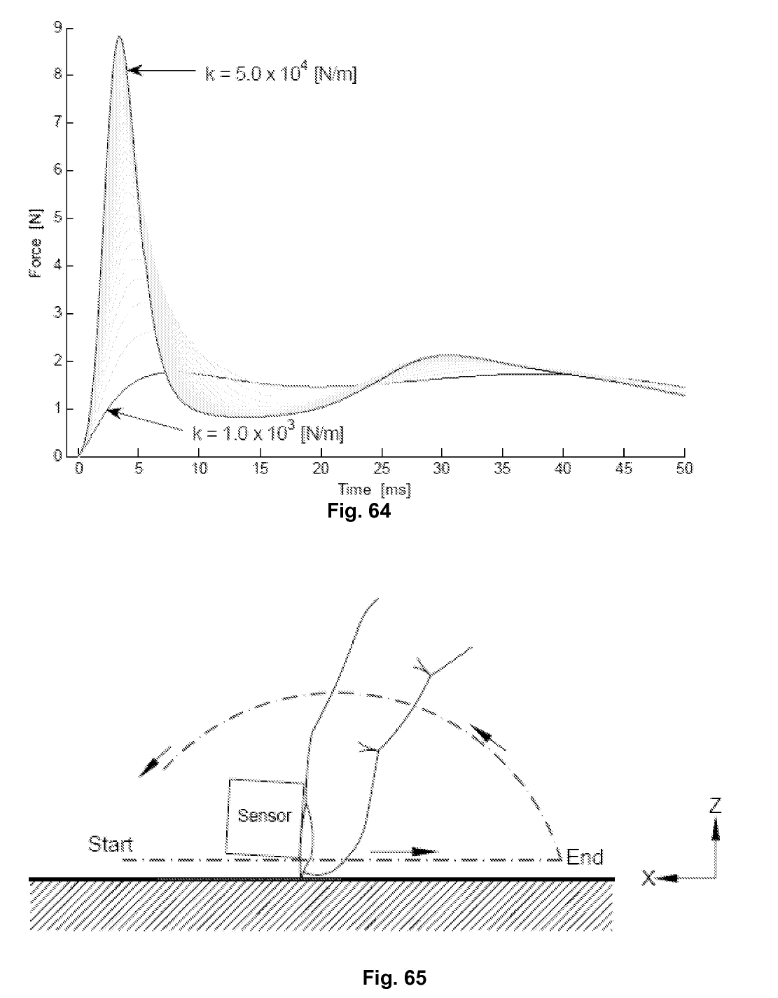

The resultant elastic stiffness values shown in Table 12 are not likely to be appropriate for direct industrial use. It should rather be interpreted in a relative scale (FIG. 61). This is because the optimization's objective function is sensitive to the participant's fingertip condition (m and b) and initial stroke speed (v0), especially in hard material tapping (also see FIG. 64). Therefore, accurate measurement of these parameters was considered the key to the quality of property determination by active tapping. For the verification of usability and reliability, further statistical study is needed with a larger number of participants and test materials.

Fung's non-linear viscoelastic model described the tissue behavior used in our tapping model. The modified versions in the previous studies were also observed to be appropriate to the impact situation. As an alternative to our lumped model, distributed force by Hertz contact can be considered (Johnson, 1985; Pawluk & Howe, 1999).

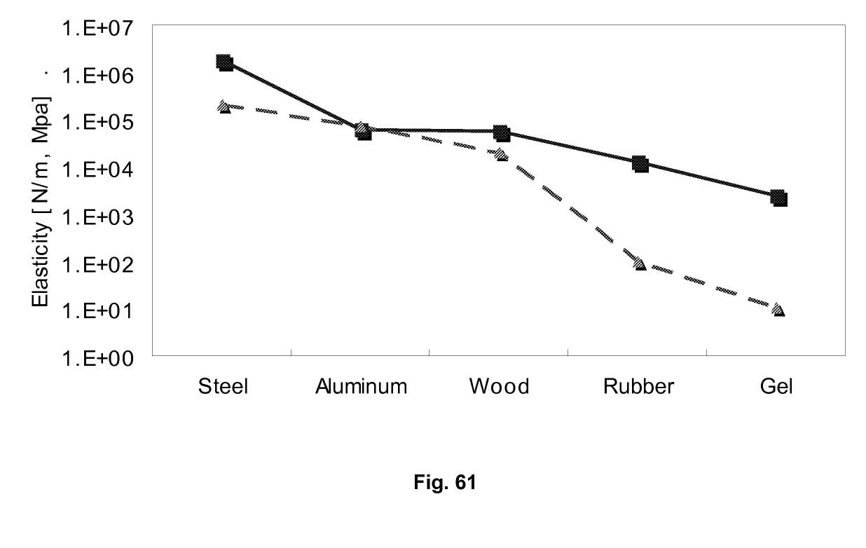

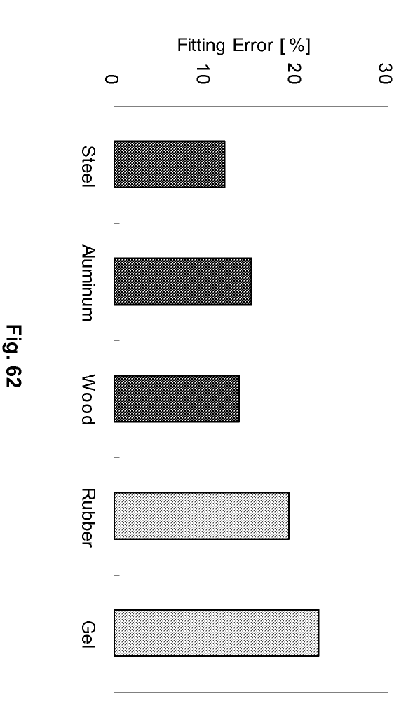

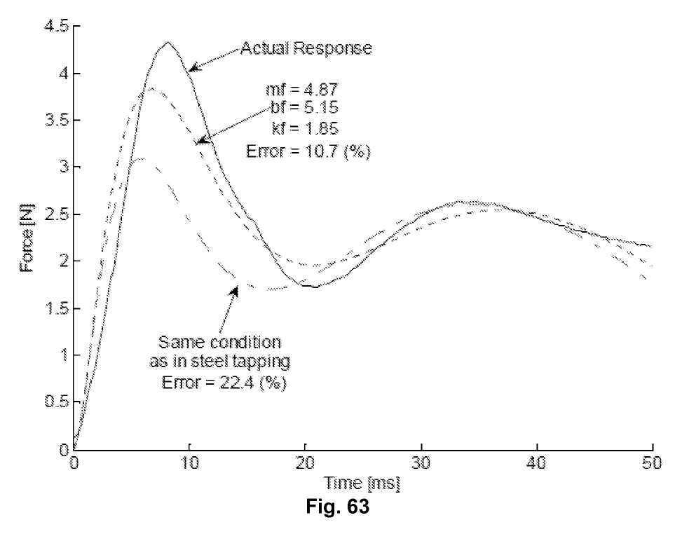

However, the assumption of lumped mass-spring-damper for finger joint impedance should be further investigated; it was considered more appropriate to lower frequency models of motor control, such as stylus grip. In our experiment, the damping scale factors (bf=3.85) of hard materials suggested that there should be more damping effective right after the impact, which bridges considerably large impact force and small finger pressure. In addition, the fingertip seemed to behave differently when tapping soft material; it had larger mass and stiffness values to fit the responses (FIG. 63). This may have occurred because of the participant's efforts to maintain the trained posture when larger deformation occurred while tapping the soft material.

In examining the materials by tapping, participants also use other sensations. In our experiment, it was difficult for them to tell the difference between the hard materials. This can be easily deduced by observing the close fingertip responses (FIGS. 59-60), and saturated response on hard materials (FIG. 64). In fact, participants' decision may have also depended on the impact sound. For the soft materials, they also benefited from tactile sensation, such as the feeling of a wider contact area. Therefore, our application may be especially useful in an inclement environment where those supportive sensations are not available, such as a noisy workspace.

From the participant tests, we observed that the high tapping force and acceleration ranges (up to 15 N, 700 m/s2, respectively) did not cause damage to the fingertip. This was confirmed by the participant's opinion after the experiment. In fact, we observed that the fingertip could accommodate an even higher impact tapping force (up to a force of 100 N, acceleration of 5,000 m/s2; Ghista, 1982; Griffin, 1990). It was appreciated that the fingertip had considerably wider dynamic range for active tapping, which suggests the human's capability of examining a wide variety of material properties.

However, difficulties were also encountered while conducting the active tapping tests. The participant's motor controlled inputs (initial velocity and force) were hard to stabilize despite the training sessions with the auditory cue (periodic beeps) that guided the correct moment for tapping. In addition, the relatively low sensing-rate of the motion tracker was not appropriate for direct use in analysis, which was in the sub-millimeter scale spatially, and in the sub-millisecond scale temporally. However, we also confirmed that the acquisition of the spatial information (position and orientation) by the motion tracker was essential and convenient for intuitive haptic sensing.

Material surface roughness related to nail scratching is now discussed. The human finger nail gives many advantages in recognizing object properties. First of all, the nail is relatively stiff compared to the finger skin which is mostly used for fingertip interaction. This added stiffness helps in recognizing object stiffness. Another important role of the finger nail is to get roughness information of an object's surface, which is of interest to the present research.

The surface roughness can be defined either as an absolute dimension (Okamura & Cutkosky, 1999), or acceleration value during the finger stroke (Okamura, Cutkosky, & Dennerlein, 1998; Okamura, Cutkosky, & Dennerlein, 2001; Pai & Rizun, 2003). The response is determined not only by stroke speed, but also by the force with which the stylus or sensor is applied (rubbed or stroked) on the object.

We carried out an experiment for the recognition of the surface roughness. The purpose of this test was to observe the fingertip response during nail-scratching, and to demonstrate the methodology of determination of the surface roughness. An selected an experienced user in this experiment.

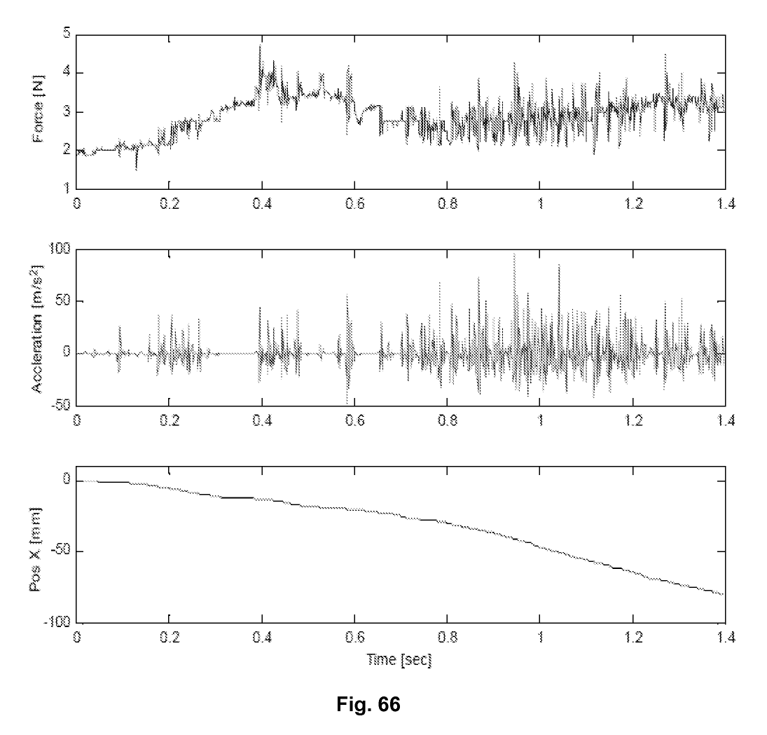

In our experiment, the participant stroked the artificial nail 17 on an object surface (FIG. 65), the vibration was transferred to the accelerometer, and then the roughness was determined by the developed algorithm. For this experiment, various sand papers were used to obtain different rough surfaces. A thin-film sheet (thickness of 0.05 mm) was placed on the sand paper surface to protect the artificial nail-tip from abrasion. The measurement of force, acceleration, and position during the nail-scratching is shown in FIG. 66.

The amplitude of the acceleration waveforms depended on both the applied force and the stroke velocity (Okamura, Cutkosky, & Dennerlein, 1998). This can be described with a three-dimensional planar equation as:

A(F,V)=P₁F+P₂V+P₃ (Eq. 15)

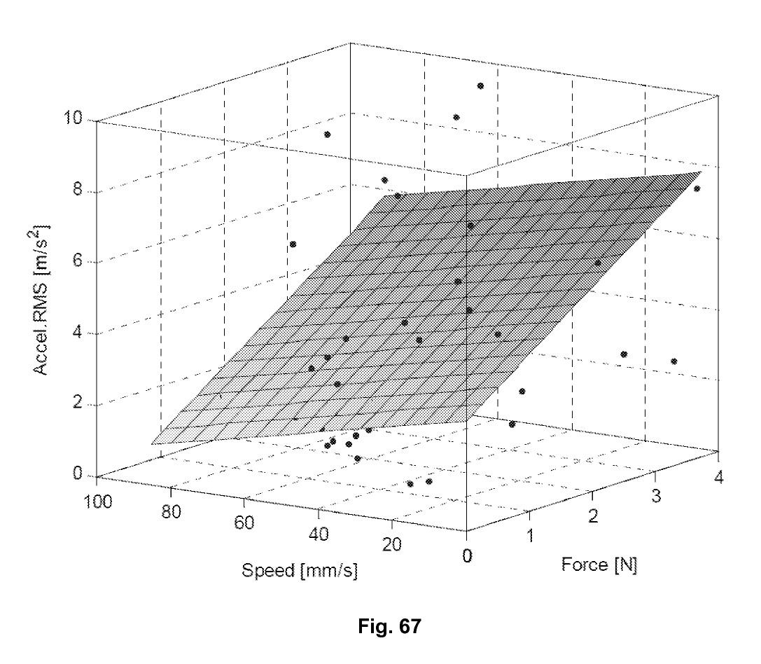

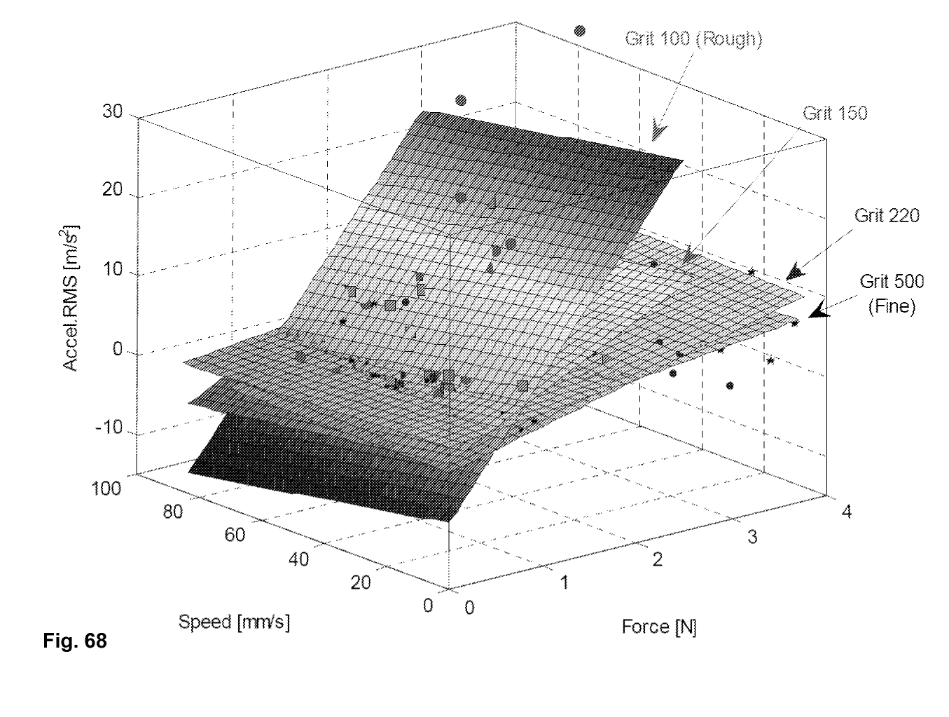

In our experiment, the RMS value was obtained in a designated time period of 200 ms. With the measurement data, plane fitting was implemented by least square methods. The acceleration amplitude was proportional to the applied force, but inversely proportional to the stroke speed (FIG. 67). The response planes of different roughness are shown in FIG. 84 and Table 13. It was observed that surface roughness affected the slope of the response plane. It should be noted that for rough surfaces (Grit 100 and 150), the fitted plane does not start with zero. This is perhaps due to the contact noise and unstable loading condition. To avoid this, it is recommended that a force of more than 0.8 N be applied for future surfaces scratching experiments. In practice, this can be achieved by delaying the sensing time to exclude the unstable initial contact or loading condition.

TABLE 13
Plane-fit parameters for nail-scratching.

| Equation | A(F, V) = P₁*F + P₂*V + P₃ | | | |
|---|---|---|---|---|
| Grit No. | 500 (Fine) | 220 | 150 | 100 (Rough) |
| Coefficients | P₁ = 1.3317 | P₁ = 2.9409 | P₁ = 6.1126 | P₁ = 15.5752 |
| | P₂ = −0.0232 | P₂ = 0.0045 | P₂ = −0.0566 | P₂ = −0.0720 |
| | P₃ = 3.0930 | P₃ = −0.1447 | P₃ = 1.0328 | P₃ = −6.4555 |

### EXAMPLE APPLICATIONS

The Fingertip Digitizer can be used for applications where the fingertip's behavior plays an important role during touch. This section of the specification demonstrates the fingertip digitizer's usability and validity with three applications: a Touch Painter, a Tactile Tracer, and a Touch Model Verifier.

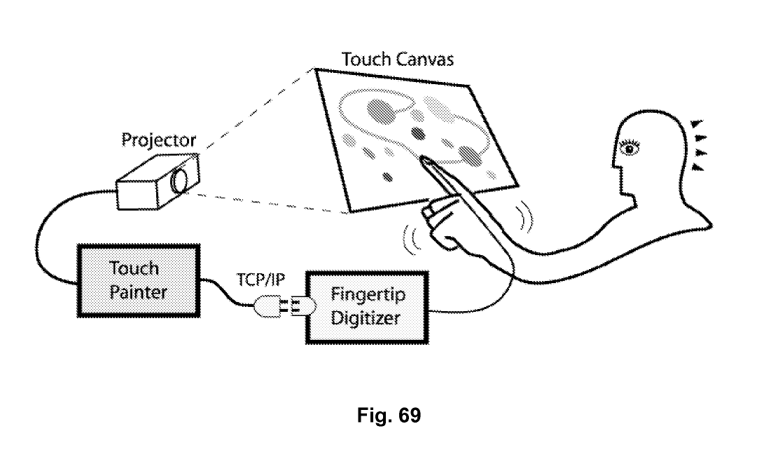

The first application we developed is called Touch Painter, which is a two-dimensional touch interface for intuitive drawing by finger touch (FIG. 69). To provide a user's touch interface, we also developed Touch Canvas.

There have been similar interfaces for fingertip touch. However, this application is unique for the following reasons. First, the system does not use smart screens, such as touch-screen or touch-pad. Instead, all sensing components are installed at the user's fingertip; the drawing does not need an electrically equipped surface. A wood panel, or any natural surface, can be used as the touch surface. Second, modeling can be carried out even without surface contact; the pattern of fingertip acceleration or posture can be a means of input. For example, jerking or sudden motion of the fingertip can be a drawing command for splashing or sprinkling of water using the high acceleration value at the fingertip.

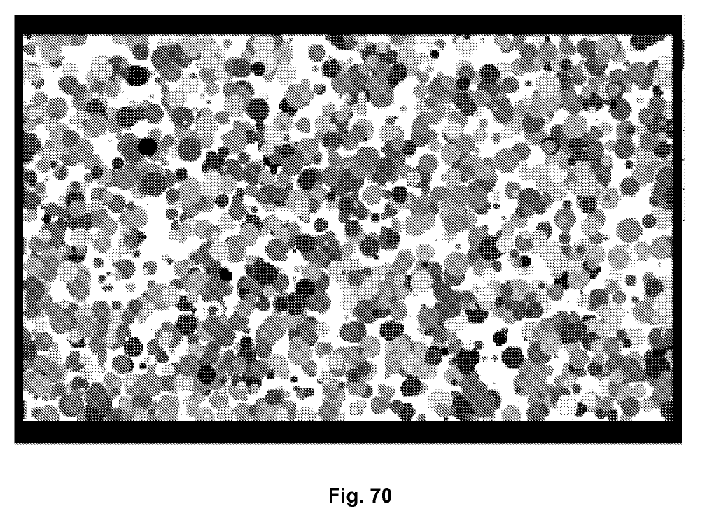

The Touch Painter receives the fingertip data from the Fingertip Digitizer's TCP/IP data socket (See FIG. 28 for the network interface). The finger's contact point was mapped into a two-dimensional (2D) space, and dynamic attributes of the fingertip—such as applied force and stroke acceleration—were transformed into color and the round patches (FIG. 70).

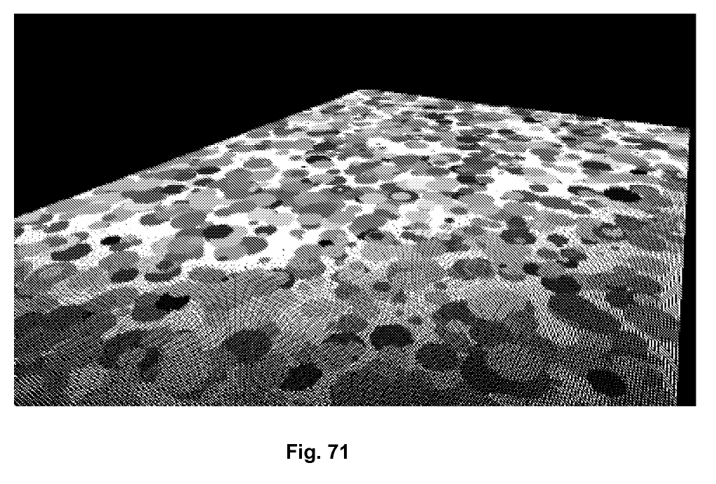

In fact, the Touch Painter's 2D visual presentation was built in a three-dimensional (3D) space (FIG. 71). For 2D simulation, there are two ways to dynamically create 3D elements. One convenient way is the per-element method; when a command occurs, a small primitive 3D object such as a box, sphere, or polygon is generated as a drawing unit (pixel). Alternative to this method is per-vertex mapping (Woo, Neider, Davis, & Shreiner, 1999); the pixel grid here was created with a 3D point set, and per-vertex property nodes were mapped for dynamic change of the vertex property.

From a performance aspect, the per-vertex approach worked much better than the per-primitive method. This is because it did not need the computationally intensive matrix computation for spatial transformation. Also, because the pixel grid is a per-vertex property, this 2D pixel image has an advantage of mapping on the surface of a 3D object. For instance, this per-vertex drawn pixel can be mapped to the vertices of a virtual object which is being built by a user's fingertip touch. For the development of this visual interface, we used OpenInventor™ and Coin3D™ Application Programming Interface (API) in Microsoft Visual C++™ Integrated Development Environment (IDE).

The Touch Canvas was developed for a drawing task. The role of this device was to make the force responsive for fingertip tactile sensing, and to give an immersive effect with the large screen. Touch Canvas consisted of a projector and a transparent acrylic panel. The projector was placed in the back of the panel, so that the user could see-thru the back-projected image. For this, the position sensor was properly calibrated to match the projected mirrored image. To diffuse the projected light, semi-transparent adhesive tape was used to cover the front side of the panel, where fingertip contact was made. This was devised for the effect that the pixel property (color and shape) dynamically was changing right at the fingertip contact.

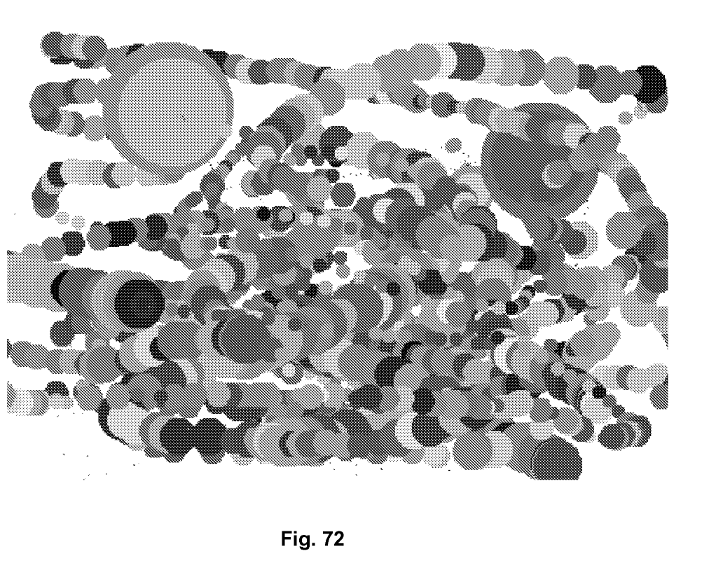

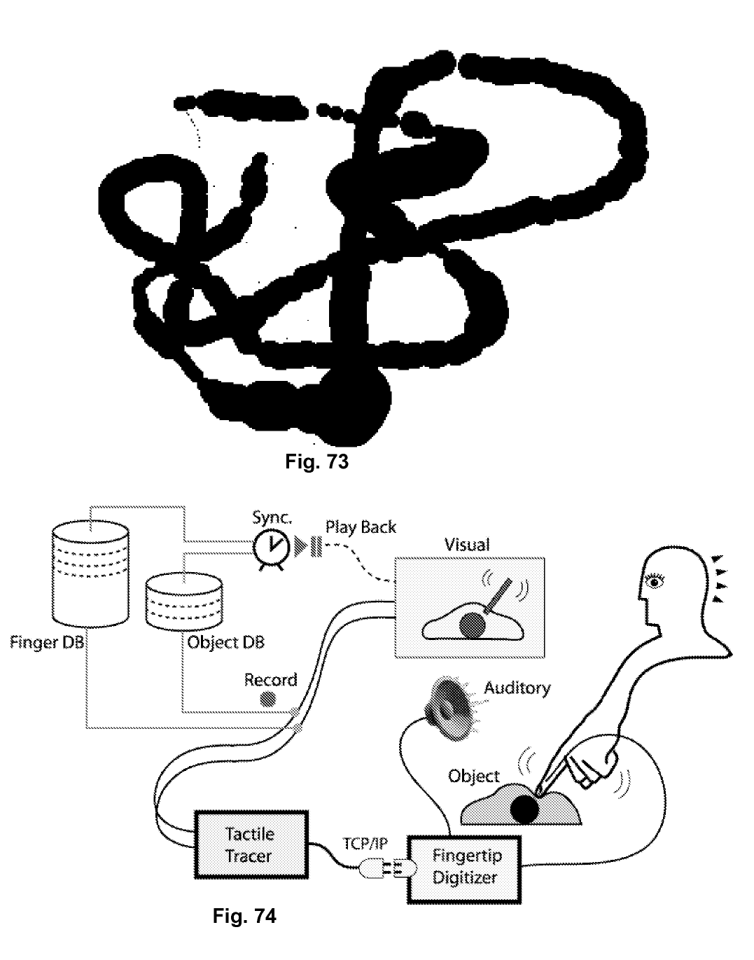

The actual user's touch task and drawings are shown in FIGS. 72-73. In these figures a user freely moves his finger to draw a painting on the Touch Canvas. The attributes of the fingertip, such as applied force and acceleration, were processed to produce a look of natural ink-painting (FIG. 72) and oriental calligraphy (FIG. 73).

The second application we developed is called the Tactile Tracer, a three-dimensional touch interface for object digitizing. There have previously been a few fingertip digitizing systems for 3D surface scanning and reverse engineering with similar sensor attachment (Smalley, 2004; Mehta, 2005). However, the Tactile Tracer is unique in that (1) it adopts the active touch paradigm to digitize dynamic tactual tasks, and (2) the tactile stimuli at the fingertip is shared with the machine in parallel, so that the user can be presented with a virtual environment (VE) of the task he or she is performing (FIG. 74). The VE consists of a multimodal interface which includes a visual and auditory presentation.

The Tactile Tracer faithfully adopts the Fingertip Digitizer's tactile sensing data. The four types of touch tasks—rubbing, palpating, tapping, nail-scratching—and corresponding digitizing techniques were used for collecting and interpreting the haptic sensations at the fingertip. For stable network transmission and fast visualization (Akenine-Moller & Haines, 2002), the algorithmically intensive processes were simplified with empirical data and interpolation techniques.

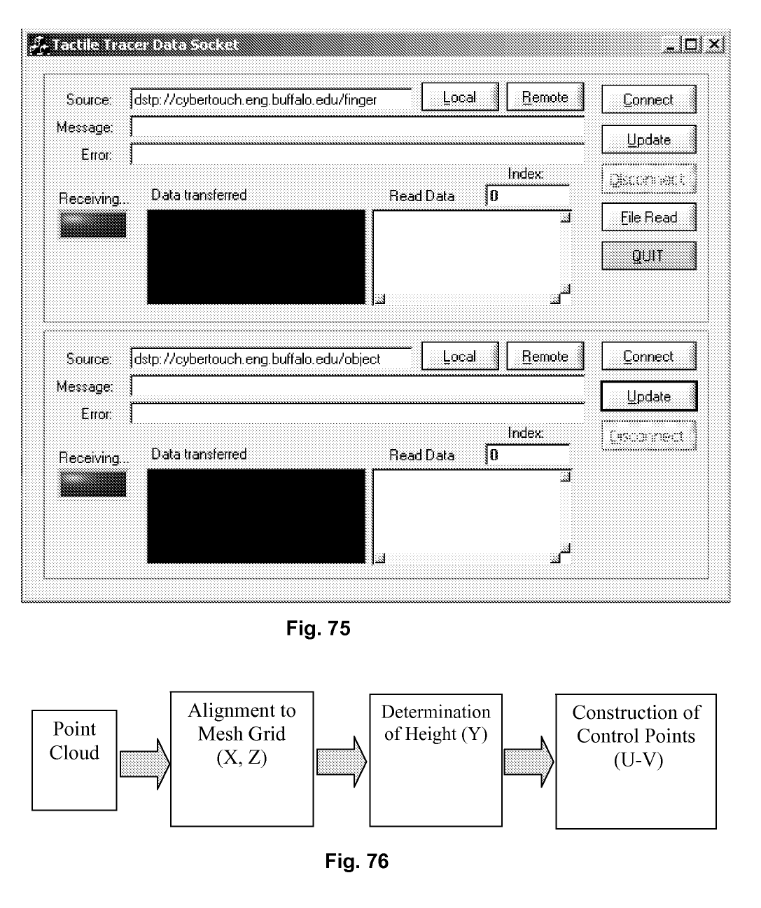

Processed data was transferred to a separate machine via TCP/IP Internet connections using LabVIEW's DataSocket interface. In fact, the Fingertip Digitzer system was designed for multi-user and multi-device network applications, such as live broadcast over the Internet (see FIG. 28 for its network interface). The tactile sensing was transmitted via two separate data streams: fingertip motion data and data from the object being examined. This is because the object data requires a high update rate that produces a large amount of data and a longer processing time, resulting in network congestion or considerable transmission delay. For handing of these two data streams, we developed a TCP/IP DataSocket receiver (FIG. 75). This network receiver was created in LabWindows/CVI™ IDE, and linked to the main processing program using a Dynamic Link Library (DLL) interface.

For visual presentation, we adopted surface and subsurface determination methods (Smalley, 2004). In this experiment, we attempted to determine the object properties. In particular, we provided visualization of geometry of a subsurface object (e.g. a tumor or a hidden ball under a surface). A force threshold approach was used to achieve this. This force threshold-based approach is convenient and effective especially for the palpation on soft material; the acquired force data was sorted for the distinction of the object's outer surfaces and the surface of inside object. In our application, we set thresholds for the two types of tactual tasks: rubbing (low applied force <1.5 N), and palpation (high applied force >10 N).

We used Non-Uniform Rational B-Spline (NURBS) for the surface representation (Kirk, 1992; Foley, van Dam, Feiner, & Hughes, 1996; Farin, 2005). The determination of the control points, however, is not an easy process. This is because acquired force data forms ‘point clouds’ due to the sensing error, which is often caused by the unstable contact condition at the fingertip. Consequently, control point determination for a NURBS surface requires an elaborate geometric algorithm. Feature extraction from point cloud data is an important step in the digitizing industry, such as laser scanning, remote sensing, and photogrammetry. However, in our research, we developed a filtering method aimed at fast surface presentation for the data stream (FIG. 76). This is because the intensive mathematical algorithm is not suitable for real-time visualization.

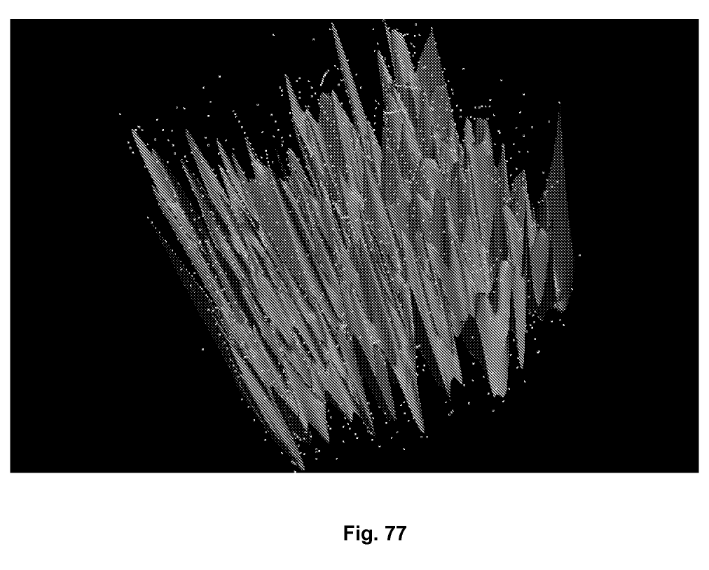

In this method, we first limited the digitization region to the top surface of the examining object. Next, a large number of 3D contact points were aligned to a horizontal grid (X-Z plane) of a 5 mm resolution (mapping space can be varied depending on the size of the examining object). The control points were placed at every intersection of this grid. This transformed the point clouds into vertical point strips in the 3D space. Height (Y) values were determined by a simple rule with the streaming data, for example, maximum (Yᵢ=max(Yᵢ₋₁,Yᵢ)), or averaged values (Yᵢ=(Yᵢ₋₁+Yᵢ)/2). Finally, U-V vectors were constructed for the definition of the NURBS surface. An example of this method is shown in FIG. 77.

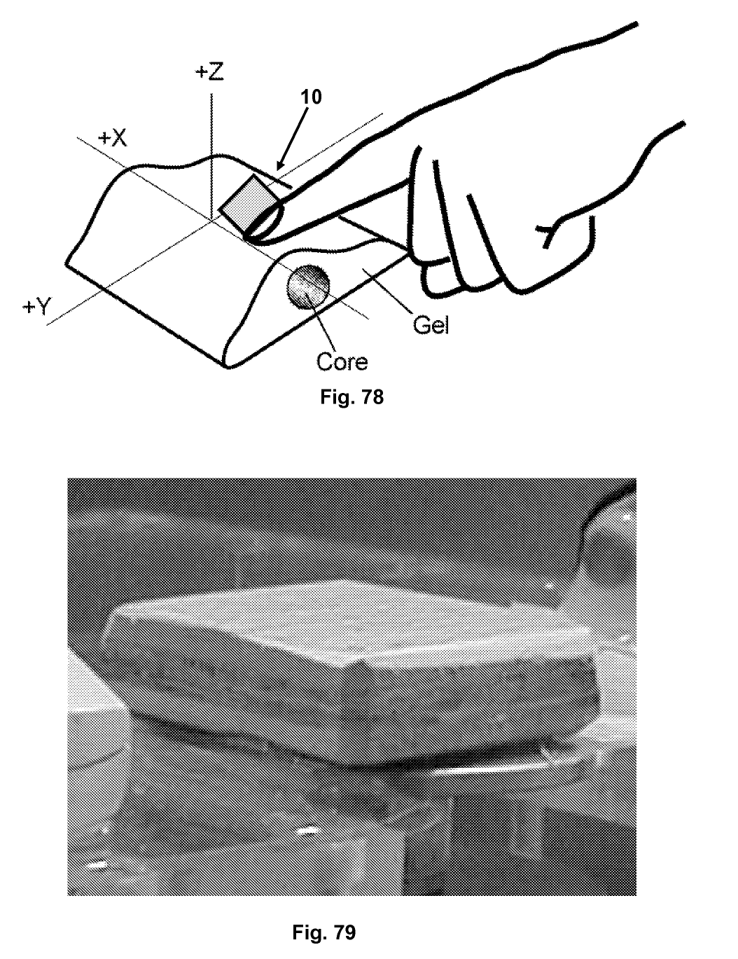

For the development of the 3D visualization, we used OpenInventor™ (Wernecke, 1994) and Coin3D™ API in Microsoft Visual C++™ IDE platform. For auditory presentation, we devised two types of beeping sounds: single beep at the moment of tapping, and continuous beeps during nail-scratching. The role of the beeping sound was to confirm the user's intention when he or she changed the task mode. The experimental setup for the human participant test is shown in FIG. 78.

The computers used for this system were 651 MHz dual Pentium III CPUs, and 2.5 GHz Pentium IV CPU for the Fingertip Digitizer and the Tactile Tracer, respectively. The real-time performance was a sampling rate of 10 kHz, with a motion tracker sampling rate of 100 Hz, and visual update rate of 30 Hz.

We then carried out a digitizing experiment with human participants (UB SBSIRB Study No. 1975). Seven graduate students from our institution participated in this experiment. The participants' task was to digitize three objects: a wooden block, a soft gel, and a computer mouse.

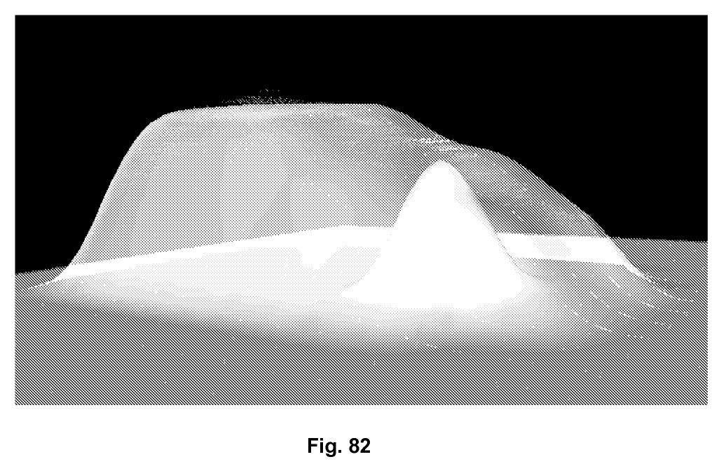

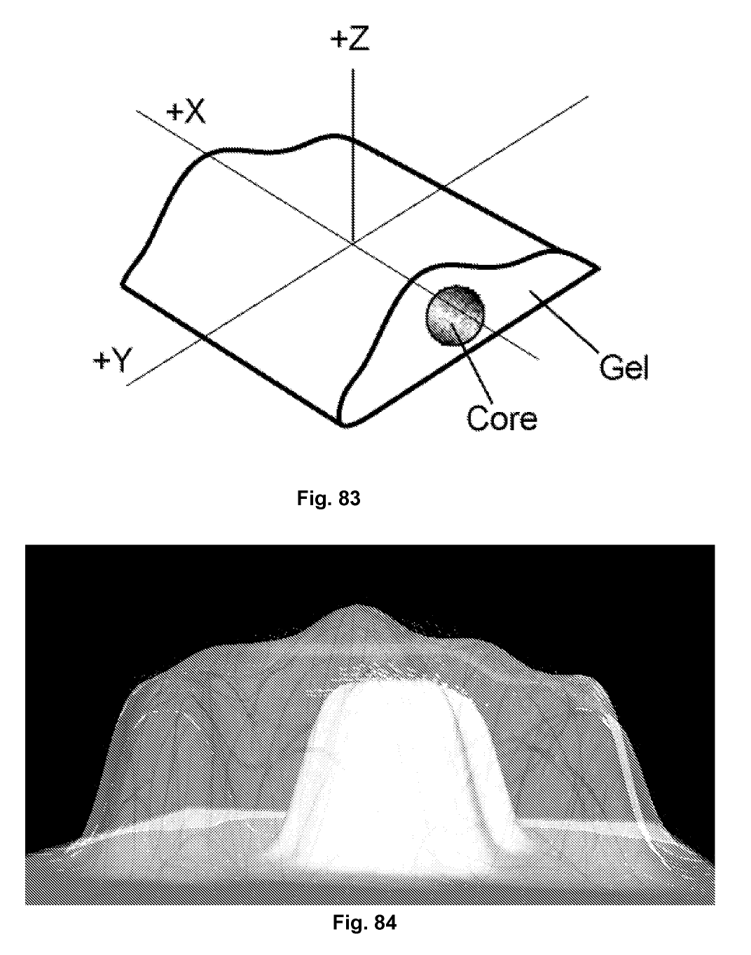

The visual presentation adopted the proposed real-time NURBS surface generation. The surface was textured and shown with transparency. To simulate the outer surface and subsurface during the palpation, we devised two surfaces in the 3D space: low applied force (<1.5 N, gray surface), and high applied force (>5 N, green surface). Participants were allowed to implement the four types of tactual tasks, described earlier, for object digitization. The results of a typical digitizing trial are shown in FIGS. 79-84.

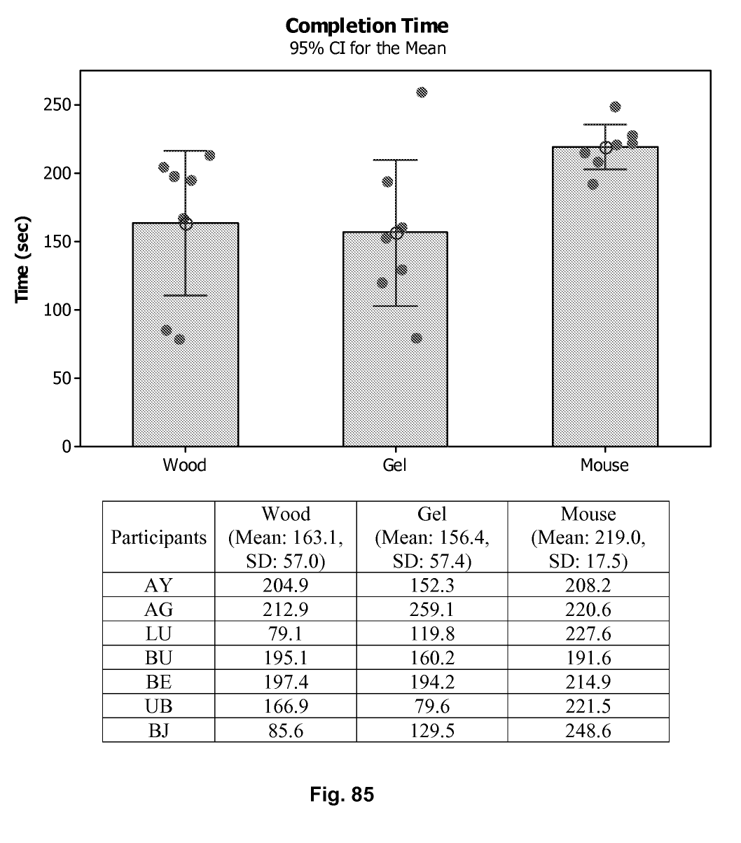

The participant's completion time ranged from 79-260 seconds. The result for each object is shown in FIG. 85. Participants took more time for digitizing the computer mouse (Mean: 219 sec, SD: 17.5). This was perhaps due to the geometrical complexity and due to the fact that it was larger than the other two objects.

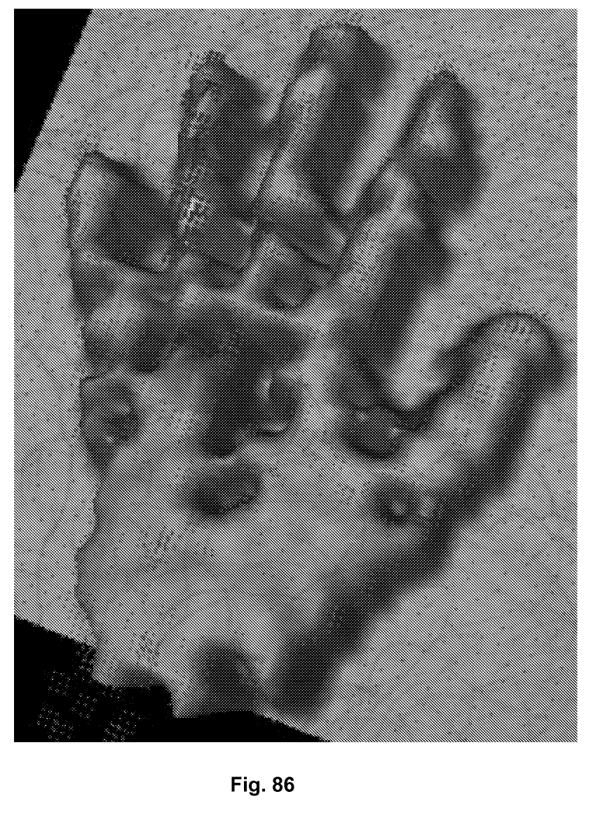

Digitizing of the Hand: We also implemented a digitizing trial for the hand, as an example of human organ digitization (FIG. 86). Here a user implemented the same digitizing method as before with his hand placed on the examining table. The machine's real-time performance was relatively low (5˜10 frames per second) due to the intensive handling of coverage volume and larger number of control points. It took 257.4 sec. for an experienced user to complete this task. Also, higher positional errors were observed due to the considerable skin deformation and unstable contact condition, especially at the finger bones.

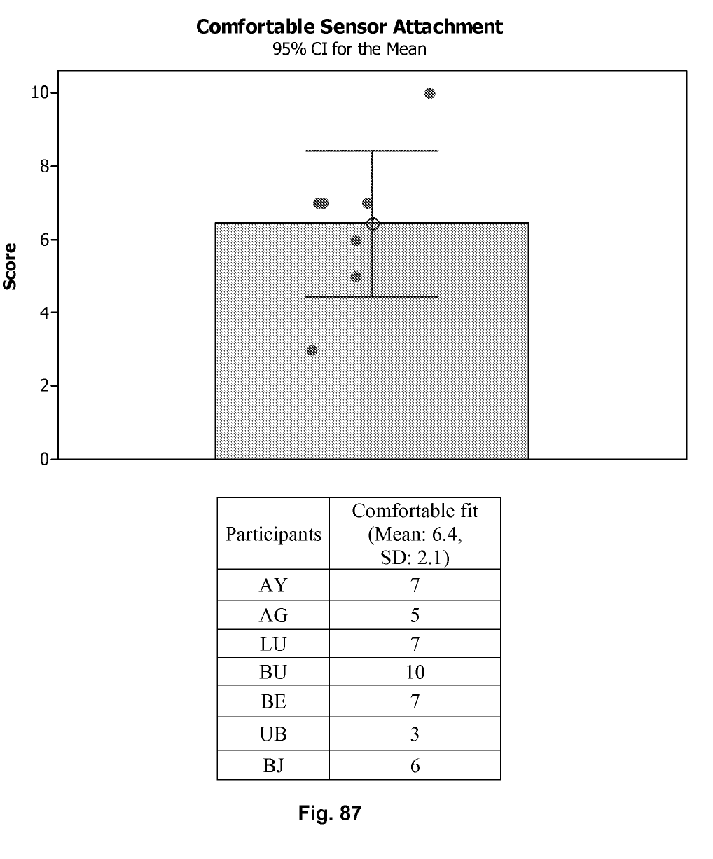

A subjective study was carried out based on the participants' opinions on the digitizing performance. First, participants were asked about how comfortable the sensor attachment was, as a wearable device. They responded that the device was comfortable to wear (FIG. 87).

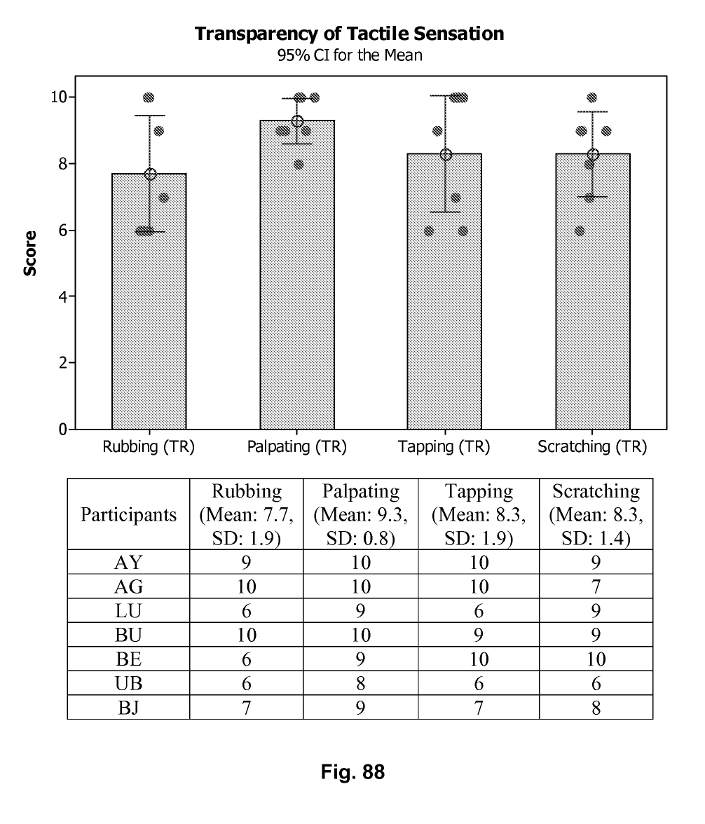

One of the important roles of the fingertip digitizer was the transparency, which meant how well the sensor attachment preserved the user's own tactile sensation. Our device generally showed good quality of transparency (FIG. 88). In particular, it showed best transparency for palpation (Mean: 9.3, SD: 0.8). This suggested that the participants found the digitizer (miniature Force Sensing Resistor; FSR; diameter of 7.6 mm, thickness of 0.3 mm) was as comfortable to use as their bare finger.

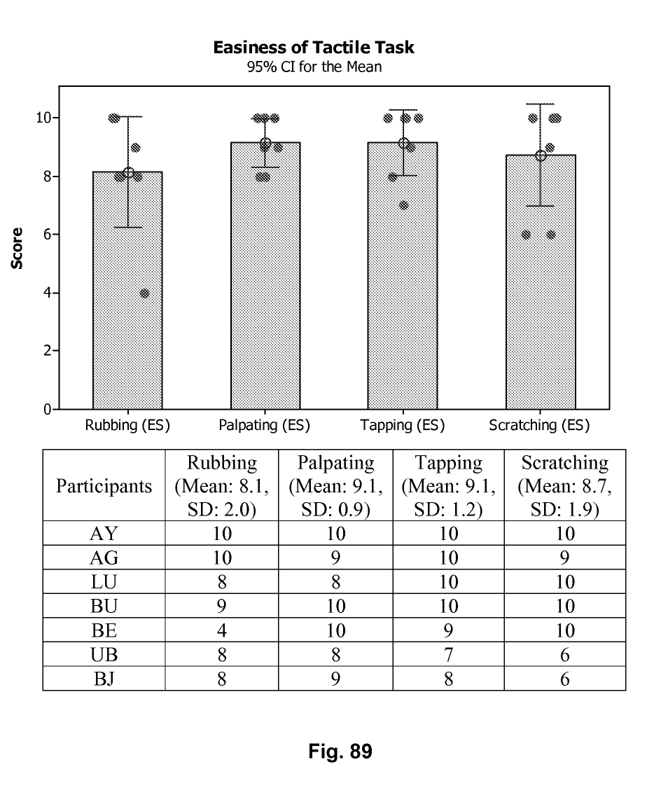

The next questionnaire was how easy the tactile tasks were. In general, participants felt the tasks were easy (FIG. 89). Again, the palpation task scored high in this test (Mean: 9.1, SD: 0.9). The active tapping interface ranked second but had a larger standard deviation (Mean: 9.1, SD: 1.2). This suggested that the tapping interface is a promising candidate for the determination of material property.

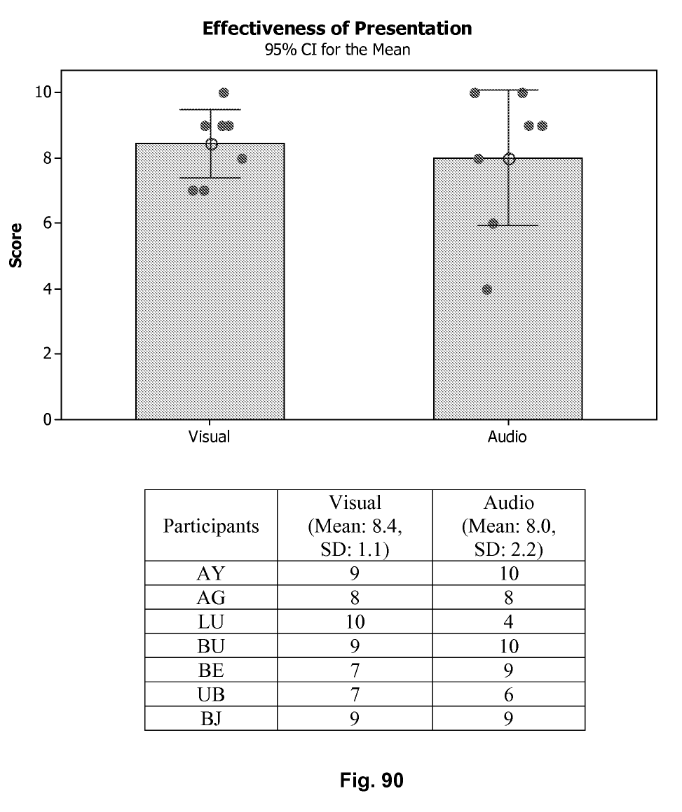

Multimodal Presentation We also asked each participant about the effectiveness of the multimodal presentation. This included the real-time 3D NURBS surface display and the beeping sounds in the application. Participants felt the visual presentation was very effective since high mean value and small variance was found (Mean: 8.4, SD: 1.1; FIG. 90). The auditory stimuli were considered less effective (Mean: 8.0, SD: 2.2). This is perhaps because the simple beeping sound failed to enhance the subtle feeling in the tactile tasks.

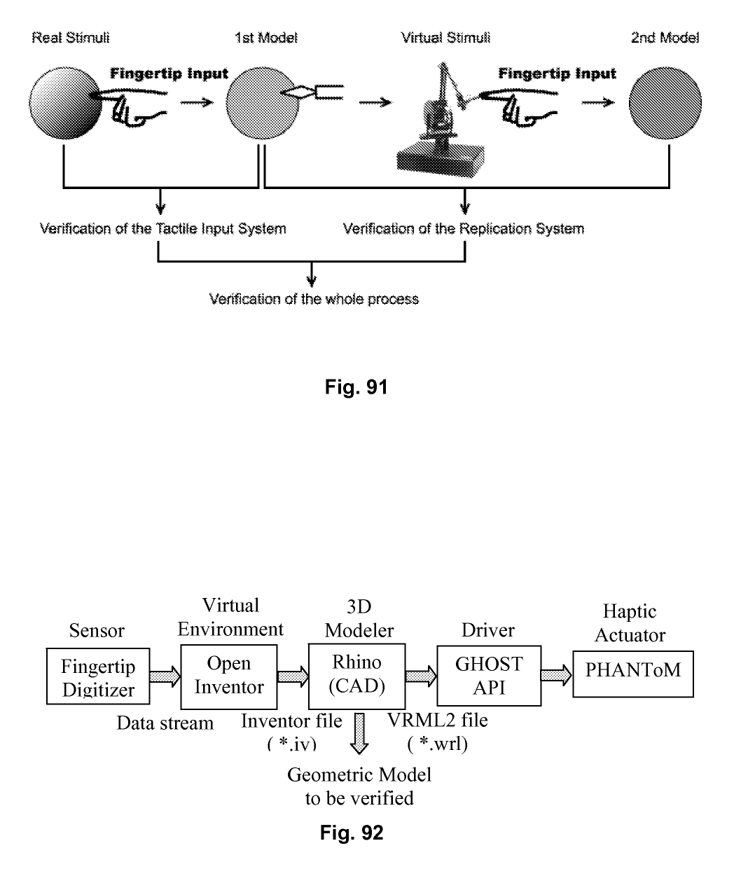

The last application is the Touch Model Verifier, which provided a verification method for comparing the haptic stimuli between the real and virtual object. This could lead to, in the future, a Fingertip Digitizer based system for automatic construction of virtual objects for haptic replication. The verification process consists of two steps using the fingertip digitizing system (FIG. 91). Each step produces a geometric model created with the acquired data from the Fingertip Digitizer. For obtaining a physically realistic object, the model should include not only the geometric data, but also the physical properties of the object being touched, such as stiffness and hardness.

For a demonstration of the proposed method, we set up an automated experiment process for virtual model construction. The goal of this experiment was (1) to show how the Fingertip Digitizer can be used for geometric modeling, and (2) to demonstrate how haptic replication created by the PHANToM™ is different from the active touch in the real world. This was verified using input geometry, and force-acceleration response, during the haptic task.

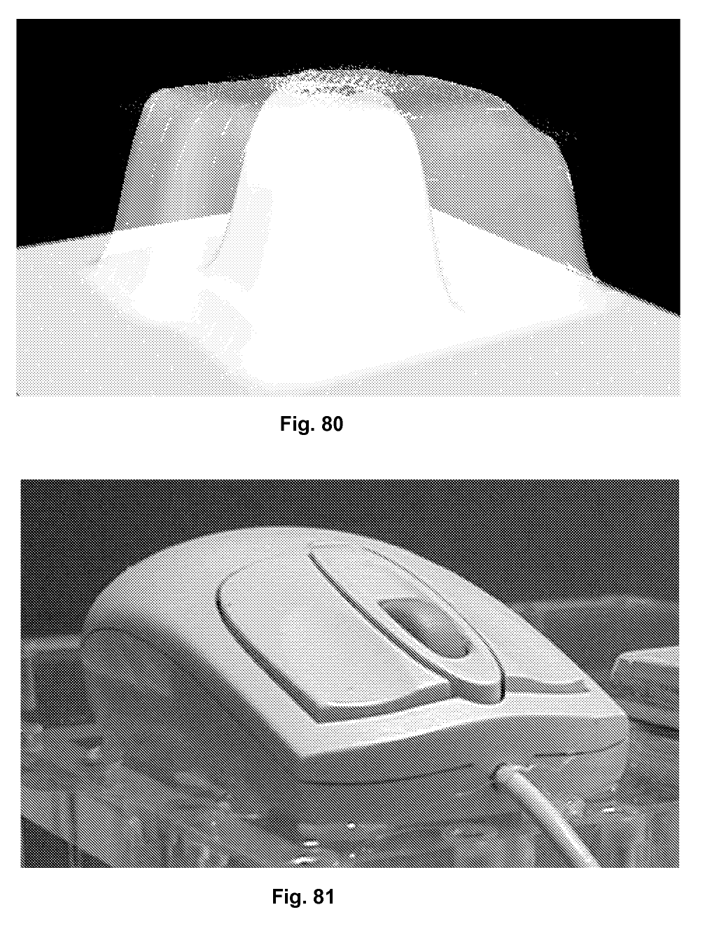

In this experiment, the actual object to be digitized was the wooden block that was used with the Tactile Tracer (See FIGS. 79-80). The procedure of geometric model construction is shown in FIG. 92.

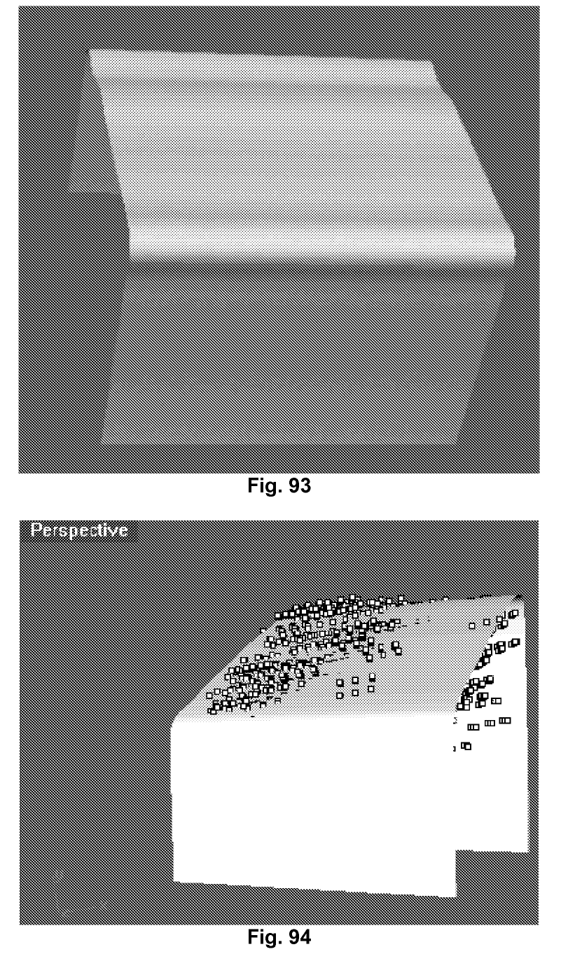

The streaming data from the Fingertip Digitizer was handled in Open Inventor scenegraph to build geometric primitives, such as a polygon or NURBS surface. Because the NURBS surfaces are highly software-specific and not compatible with other software, we exported raw point cloud data. For this, we utilized Open Inventor's scenegraph export capability to create Open Inventor ASCII file or Virtual Reality Markup Language (VRML1.0) ASCII file. Again, with the exported point cloud, the surface generation is an issue. For this, one can adopt the commercially available software. For example, Floating Point Solution's Point Cloud™ plug-in software can be used (FPS, 2005). For demonstrative purpose, we built a NURBS surface by connecting maximum Y points using Rhino™ 3D modeler (FIG. 93).

The model in the 3D modeler was exported as a VRML2 (or VRML97) file. VRML is one of the popular 3D formats for virtual reality applications. This ASCII-based model file can then be parsed in a user's C/C++ program that includes GHOST API as the driver for the PHANToM haptic actuator. Using this haptic interface, an experiment was setup for fingertip digitization on the virtual object.

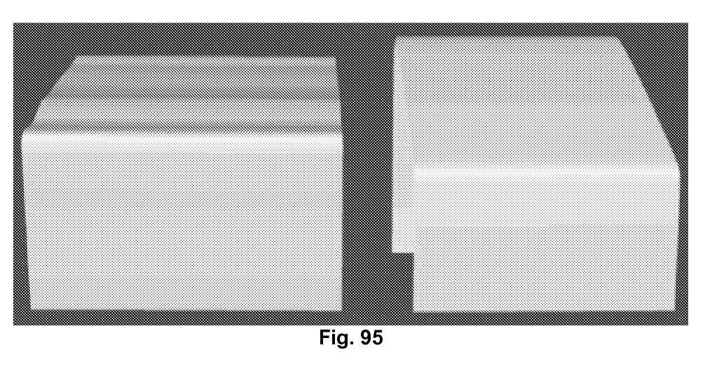

The second trial with the Fingertip Digitizer produced another point data set. With the same method previously implemented, we created a second geometric model (FIG. 94). FIG. 95 compares_the three objects: the real object, the first virtual object created by touch on the real object, and the second geometric model created by touch on the virtual object using the PHANToM. It was observed that the second model had more slant on the top surface. This suggested that the virtual object had to be rotated to orient correctly in the 3D space.

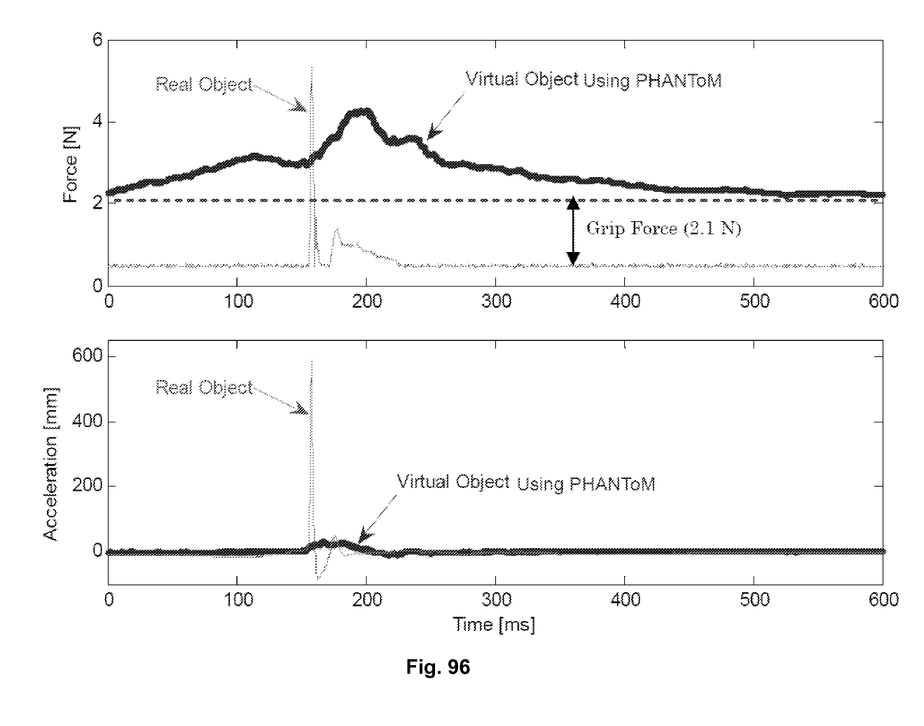

Another important aspect of active touch is its dynamic characteristics. Thus, a true haptic replication must provide this type of stimulation. During the digitizing task on the virtual object that was discussed previously, we also measured the force and acceleration response of active tapping. The comparison of force and acceleration response on the real and virtual object is shown in FIG. 96.

For force, we can clearly see that the virtual stimuli by the PHANToM failed to replicate the real impact tapping. Moreover, it includes the grip force of 2.1 N at the fingertip. For acceleration, the virtual stimuli using the PHANToM also failed to present the real object's high frequency acceleration. Its response was similar to that of a soft material. This is perhaps due to the linkage compliance of the PHANToM device. Thus we can see that the haptic response from the PHANToM is very poor for tapping and other similar dynamic tasks.

We have introduced the active touch paradigm to the conventional, passive way of fingertip digitizing. The human finger's active touch involves many issues in tactile and haptic sensing. We confirmed that the heart of the fingertip digitizing was a solid understanding of the biomechanical properties of the finger. Also, that the active tactile sensing technology played an important role for the actual implementation of the active, dynamic, and viscoelastic touch.

The fingertip digitizer developed according to the present invention was able to capture the high frequency responses of up to 10 kHz. The development of a multi-rate data acquisition (DAQ) system was very useful in integrating the sensors of different update frequencies. The use of Force Sensing Resistors (FSR) provided many advantages such as high frequency sensing, light weight and flexibility in attachment at a very cost-effective price. Since the network interface of the fingertip digitizer was intended for a multi-device and multi-user system, this enabled us to modulate the functionalities, and to efficiently develop the three digitizing applications.

The development of the fingertip digitizer allowed us to explore many interesting issues in fingertip digitizing, such as a tissue's viscoelastic behavior and the unique response patterns during tactual tasks. It also enabled us to investigate the fingertip interaction with the object being touched, and to further achieve the unique approach to the determination of material properties by active tapping. To implement the simulation, we integrated many engineering techniques, such as fingertip biomechanics, systems design, and optimization techniques. Finally, these fundamental studies led to three VR applications, which demonstrated the possibility of intuitive fingertip digitizing.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A finger-mounted implement, comprising:
a kinesthetic sensor;
at least one tactile sensor; and
means for securing the kinesthetic sensor and the at least one tactile sensor to a fingertip.

2. The implement according to claim 1, wherein the at least one tactile sensor includes a thin-film force transducer.

3. The implement according to claim 1, wherein the at least one tactile sensor includes a piezoelectric accelerometer.

4. The implement according to claim 3, further comprising an artificial fingernail connected to the accelerometer.

5. The implement according to claim 1, wherein the at least one tactile sensor includes a thin-film force transducer and a piezoelectric accelerometer.

6. The implement according to claim 1, wherein the kinesthetic sensor includes a magnetic transducer.

7. The implement according to claim 1, wherein the kinesthetic sensor senses an X-Y-Z position and an angular orientation of a fingertip to which the kinesthetic sensor is secured.

8. The implement according to claim 1, wherein the securing means includes at least one means selected from the group consisting of adhesive tape, an elastically deformable cover, and detachable adhesive.

9. A haptic sensing system, comprising:
a human fingertip;
a kinesthetic sensor mounted on the fingertip for providing kinesthetic signal information indicating a position of the fingertip in space;
at least one tactile sensor mounted on the fingertip for providing tactile signal information indicating at least one of acceleration at the fingertip and contact force applied at the fingertip; and
signal processing circuitry receiving the kinesthetic signal information and the tactile signal information and generating a digital data set describing active movement of the fingertip over time;
whereby the fingertip may be used as a digitizing probe or digital input device.

10. The haptic sensing system according to claim 9, wherein the signal processing circuitry generates the digital data set in real time.

11. The haptic sensing system according to claim 10, wherein the signal processing circuitry is embodied in a plurality of electronics units and a computer connected to the plurality of electronics units.

12. The haptic sensing system according to claim 11, further comprising a display connected to the computer, wherein the computer is programmed to provide a virtual reality representation on the display based on the digital data set.

13. A method of haptic sensing comprising the steps of:
mounting a plurality of sensors on a fingertip of a human, the plurality of sensors providing tactile signal information associated with the fingertip and kinesthetic signal information associated with the fingertip;
actively moving the fingertip to touch an object; and
processing the tactile signal information and the kinesthetic signal information provided during the active movement of the fingertip.

14. The method according to claim 13, wherein the tactile signal information indicates at least one of acceleration at the fingertip and contact force applied at the fingertip.

15. The method according to claim 13, wherein the kinesthetic signal information indicates at least one of position of the fingertip in space and angular orientation of the fingertip in space.

16. The method according to claim 13, wherein the step of actively moving the fingertip includes moving the fingertip while the fingertip is in contact with the object and moving the fingertip while the fingertip is out of contact with the object.

17. The method according to claim 16, wherein the step of actively moving the fingertip includes a transient stage as the fingertip makes contact with the object, during which transient stage viscoelastic behavior of fingertip tissue is reflected in the tactile signal information.

18. The method according to claim 13, wherein the step of actively moving the fingertip includes performing a tactual task selected from the group of tactual tasks consisting of rubbing the object, palpating the object, tapping the object, and scratching the object.

19. The method according to claim 13, wherein the tactile signal information and the kinesthetic signal information is processed to determine properties of the object, and the method further comprises the step of digitally modeling the object based on the determined properties of the object.

20. The method according to claim 13, wherein the tactile signal information and the kinesthetic signal information is processed to determine characteristics of the active movement of the fingertip.
